(19) United States
(12) Patent Application Publication
(10) Pub. No.: US 2026/0104340 A1
(43) Pub. Date: Apr. 16, 2026

(54) NEURAL NETWORK-ENABLED MULTIPARAMETRIC IMPEDANCE SIGNAL TEMPLATING FOR HIGH THROUGHPUT SINGLE-CELL DEFORMABILITY CYTOMETRY UNDER VISCOELASTIC EXTENSIONAL FLOWS

(71) Applicant: University of Virginia Licensing & Ventures Group, Charlottesville, VA (US)

(72) Inventors: Nathan Swami, Charlottesville, VA (US); Abdullah-Bin Siddique, Charlottesville, VA (US); Mohammad Javad Azizi Jarmoshti, Charlottesville, VA (US)

(21) Appl. No.: 19/296,473

(22) Filed: Aug. 11, 2025

Related U.S. Application Data
(60) Provisional application No. 63/706,328, filed on Oct. 11, 2024.

(51) Int. Cl. G01N 15/12; G01N 15/10; G06T 7/00; G06V 10/764; G06V 10/774; G06V 10/82; G06V 20/69

(52) U.S. Cl. CPC G01N 15/12; G06T 7/0016; G06V 10/764; G06V 10/774; G06V 10/82; G06V 20/698; G01N 2015/1006; G01N 2015/1028; G06T 2207/20081; G06T 2207/20084; G06T 2207/30024

(57) ABSTRACT

An exemplary microfluidic high-throughput cytometry system and method that employ AI/ML-based analysis and impedance-based measurements of heterogeneous population of cells and biological particles in viscoelastic flow within hyperbolic extensional channels of a microfluidic device to provide estimation of progressive modulation of cell deformation under shear and compression forces through varying the channel geometry, flow rate and/or media viscosity to assess subpopulations of cells and biological particles.

### CROSS-REFERENCE TO RELATED APPLICATION

This application claims priority to and benefit under 35 U.S.C. § 119 (c) of U.S. Provisional Patent Application Ser. No. 63/706,328, entitled “NEURAL NETWORK-ENABLED MULTIPARAMETRIC IMPEDANCE SIGNAL TEMPLATING FOR HIGH THROUGHPUT SINGLE-CELL DEFORMABILITY CYTOMETRY UNDER VISCOELASTIC EXTENSIONAL FLOWS,” filed Oct. 11, 2024, which is hereby incorporated by reference herein in its entirety.

### STATEMENT OF GOVERNMENT INTEREST

This invention was made with government support under FA9550-24-1-0057, FA2386-21-1-4070, and FA2386-18-1-4100 awarded by the Air Force Office of Scientific Research, 2222933 awarded by the National Science Foundation, and P30 CA44579 and U54 CA27499 awarded by the National Cancer Institute. The government has certain rights in the invention.

### BACKGROUND

The measurement of cellular mechanical properties has conventionally been performed through micropipette aspiration, atomic force microscopy, parallel plate rheometry, and optical or electrical stretching methods.

Microfluidic deformability cytometry based on shear flow and extensional crossflow enables high throughput (˜500 cells/s), non-destructive, and clog-free measurement at single-cell sensitivity for quantifying biomechanical heterogeneity to assist in the classification and sorting of cell subpopulations. Current microfluidic deformability cytometry are performed on constant shear flow conditions or at a single point in the channel under extensional crossflow.

There is a benefit to improving the quantification of biomechanical heterogeneity of cells or biological particles in high-throughput cytometry.

### SUMMARY

An exemplary microfluidic high-throughput cytometry system and method are disclosed that employ AI/ML-based analysis and impedance-based measurements of heterogeneous population of cells and biological particles in viscoelastic flow within hyperbolic extensional channels of a microfluidic device to provide estimation of progressive modulation of cell deformation under shear and compression forces through varying the channel geometry, flow rate and/or media viscosity to assess subpopulations of cells and biological particles. The viscoelastic flow serves as a soft wall that can deform cell and then allow for them to recover without causing damage. The exemplary system and method can measure cell responses to different mechanical stimuli over time using the dynamics of single-cell deformation in high-throughput applications. The exemplary system and method can distinguish cell types based on the relative size of their nucleus, using deformability and impedance cytometry, including those with diverse nuclear shapes and compositional variations. The exemplary system and method can perform cell deformability measurements under alterations of nuclear structure using fluorescence methods without the need for (i) staining to identify nuclear envelope breakdown or (ii) radio frequency tagged emission under microfluidic shear flow.

In some embodiments, the microfluidic device can measure cell deformation and/or recovery dynamics that can distinguish cells/biological particles based on differences in their nuclear phenotypes. In some embodiments, the microfluidic device can measure cell deformation and/or recovery dynamics that can distinguish cells/biological particles based on differences in their nuclear phenotypes in combination with electrical physiology of the cell (membrane capacitance, cytoplasmic conductivity and nucleus to cell size). In some embodiments, by using a pneumatically actuated diaphragm to modulate their channel geometry for creating critical levels of deformation on a wider size range of cells by shear and compression under hyperbolic viscoelastic extensional flow, the coupling of cellular metrics from impedance, deformability and confined recovery measurements can be used to distinguish lymphoma cells that differ in their nuclear phenotypes. In some embodiments, particle deformation by the pneumatically actuated diaphragm can be used to provide data for training a neural network for optimizing the proportion of heterogeneously sized bioparticles that undergo critical levels of deformation to enable their classification. Metrics from an impedance frequency response can be used together with cell deformation metrics from imaging flow cytometry to classify cell subpopulations, since they can provide complementary metrics.

In some embodiments, the microfluidic channel comprises a compliant material operatively coupled to an external actuator to induce certain deformation and/or recovery dynamics.

Contactless single-cell deformability cytometry is often conducted under microfluidic viscoelastic flows that cause shear, extensional, or compressive forces, using high-speed imaging to measure alterations in cell anisotropy. While high-speed imaging provides accurate spatial information on cells, it is not well-associated with their functional attributes, such as cell viability. Furthermore, due to the size, interior shape, and compositional diversity of cellular subpopulations, it is challenging to acquire focused single-cell images at high throughput for quantification of cell deformability. Hence, extensive image reconstruction is required, which is often conducted offline, thereby limiting its utilization in near real-time to activate sorting. Impedance cytometry for single-cell biophysical analysis has been associated with cell function within many contexts, such as immune cell activation, red blood cell infection, cell health, classification of apoptotic states of cancer cells, altered nucleus to cell size to monitor stem cell cycle characteristics, and cancer cell subpopulations after co-culture with associated fibroblasts. However, deformability-based classification by impedance analysis uses constrictions to cause cell deformation, which is limited by the broad cell size distributions in typical samples and the associated clogging that limits throughput. Viscoelastic crossflows address this limitation, but the cell deformation is instantaneous, and the dynamic range for anisotropy modulation is limited.

An exemplary method and system are disclosed that operate under hyperbolic extensional flows for contactless and progressive single-cell deformation to high shape anisotropies. In some aspects, disclosed herein is a system. The system can include: a microfluidic device comprising: a microfluidic channel defining a flow path and configured to receive a sample comprising a heterogeneous population of biological particles, wherein the microfluidic channel includes a contoured constriction region larger than particle size that is configured to induce viscoelastic extensional flow for deformation and relaxation of the biological particles flowing therethrough, and an impedance sensing unit comprising one or more sets of electrodes disposed along the flow path of the microfluidic channel, wherein the one or more sets of electrodes is configured to interrogate single-particle impedance characteristics corresponding to a biophysical features of the biological particle, including their size, velocity, shape anisotropy and dielectric properties along the flow path of the microfluidic channel to provide impedance signal data.

The system can further include a processor, and memory operatively coupled to the processor and having instructions stored thereon, wherein execution of the instructions by the processor causes the processor (e.g., in real-time) to: obtain the impedance signal data acquired from the impedance sensing unit; and classify the biological particles into cell or particle subpopulations via a trained machine learning (ML) model, wherein the trained ML model is trained using a training data set comprising a sequence of images, or associated data, of a set of biological particles flowing in viscoelastic extensional flow along a flow path of a microfluidic channel (e.g., another device used for training) through a contoured constriction region and corresponding impedance signal data (e.g., impedance signal training set).

In some aspects, the microfluidic channel comprises a compliant material operatively coupled to an external actuator, wherein the microfluidic channel is configured to deform (e.g., from a first cross-sectional area to a second cross-sectional area) in response to a force generated by the external actuator (e.g., for enhancing and/or optimizing deformation of a wider size range of the biological particles in the constriction region to further distinguish between subpopulations). In some aspects, the external actuator comprises a diaphragm (e.g., a pneumatic diaphragm). The diaphragm may be employed for mechanical property assessment to vary contoured constriction regions. In some embodiments, the diaphragm may be used for cell sorting in providing mechanical mechanisms to deflect cell/particle through different channels.

In some aspects, the contoured constriction region of the microfluidic channel defines a substantially hyperbolic curve.

In some aspects, the flow path of the microfluidic channel further includes a pre-constriction region and a recovery region proximal to and in fluid communication with the contoured constriction region.

In some aspects, the impedance sensing unit comprises a first set of electrodes disposed about the pre-constriction region, a second set of electrodes disposed about the contoured region, and a third set of electrodes disposed about the recovery region.

In some aspects, the microfluidic channel further comprises a sorting region, wherein the processor is configured to determine, based on a classification of the biological particles (e.g., nuclear phenotype), a control signal to selectively direct the biological particles towards a respective bin (e.g., using surface acoustic waves).

In some aspects, the biological particles comprise cells (e.g., circulating tumor cells (CTCs)).

In some aspects, the processor, via the trained ML model, is configured to classify the cells into cell or marker subpopulations based on epithelial and mesenchymal states. In some aspects, the processor, via the trained ML model, is configured to classify the cells into cell or marker subpopulations based on fixed and untreated states.

In some aspects, the trained ML model comprises a multilayer perceptron neural network (MLPNN) configured for real-time operation.

In some aspects, the MLPNN is configured to determine an estimated value for an electrical anisotropy index of the biological particle based on normalization against co-flowing microgel beads of known stiffness.

In some aspects, the trained ML model further comprises a Support Vector Machine (SVM) configured to classify the biological particles into cell or particle subpopulations based on the estimated value of the electrical anisotropy index from the MLPNN.

In some aspects, the sequence of images, or associated data, comprises one or more morphological parameters derived from segmented optical images is used as training data for the deformation and relaxation of biological particles within the microfluidic channel.

In some aspects, the one or more morphological parameters comprise one or more of cell size, centroid eccentricity, circularity, and/or anisotropic index.

In some aspects, the impedance signal data comprises one or more of electrical size, transit time, amplitude values for impedance magnitude and phase at specific frequencies, or a composite metric.

In some aspects, the impedance sensing unit is coupled to a local controller that provides the impedance signal data to a cloud infrastructure comprising the processor and memory. In some aspects, the impedance sensing unit is coupled to a local controller that comprises the processor and memory.

In another aspect, disclosed herein is a method of characterizing and/or manipulating biological particles, In some aspects, the method includes: receiving a sample comprising a heterogeneous population of biological particles in a microfluidic device, flowing the biological particles through a microfluidic channel of the microfluidic device having a contoured constriction region larger than particle size to cause viscoelastic extensional flow for deformation and relaxation of the biological particle, measuring impedance signal data of the biological particle at one or more locations along the microfluidic channel; and classifying the biological particles into cell or particle subpopulations via a trained machine learning (ML) model, wherein the trained ML model is trained using a training data set comprising a sequence of images, or associated data, of a set of biological particles flowing in viscoelastic extensional flow along a flow path of the microfluidic channel (e.g., another device used for training) through the contoured constriction region and corresponding impedance signal data (e.g., impedance signal training set).

In some aspects, the method further includes: selectively directing the biological particles towards a respective bin (e.g., using surface acoustic waves) based on a classification of the biological particles.

In some aspects, the method further includes modulating an external actuator to deform the microfluidic channel (e.g., from a first cross-sectional area to a second cross-sectional area) to enhance and/or optimize deformation of the biological particles in the constriction region to further distinguish between subpopulations.

In some aspects, the biological particles comprise cells (e.g., circulating tumor cells (CTCs)).

In some aspects, cells are classified into subpopulations based on epithelial and mesenchymal states. In some aspects, the cells are classified into subpopulations based on fixed and untreated states.

In some aspects, the trained ML model comprises a multilayer perceptron neural network (MLPNN). In some aspects, the MLPNN is configured based on image data on particle shape anisotropy to determine an estimated electrical anisotropy index of the biological particle. In some aspects, the trained ML model further comprises a Support Vector Machine (SVM) configured to classify the biological particles into subpopulations based on the estimated electrical anisotropy index from the MLPNN.

In some aspects, the sequence of images, or associated derived data, comprises one or more morphological parameters derived from segmented optical images of training biological particles within the microfluidic channel. In some aspects, the one or more morphological parameters comprise one or more of cell size, centroid eccentricity, circularity, and/or anisotropic index.

In some aspects, the impedance signal data comprises one or more of electrical size, transit time, amplitude values for impedance magnitude and phase at specific frequencies, or a composite metric.

In another aspect described herein is a microfluidic device including: a microfluidic channel defining a flow path and configured to receive a sample comprising a heterogeneous population of biological particles, wherein the microfluidic channel includes a contoured constriction region larger than particle size that is configured to induce viscoelastic extensional flow for deformation and relaxation of the biological particles flowing therethrough, and an impedance sensing unit comprising one or more sets of electrodes disposed along the flow path of the microfluidic channel, wherein the one or more sets of electrodes is configured to interrogate impedance characteristics corresponding to a biophysical features of the biological particle along the flow path of the microfluidic channel to provide impedance signal data on particle size, velocity, shape and dielectric properties; wherein the microfluidic channel comprises a compliant material operatively coupled to an external actuator, wherein the microfluidic channel is configured to deform (e.g., from a first cross-sectional area to a second cross-sectional area) in response to a force generated by the external actuator (e.g., for enhancing and/or optimizing deformation of a greater proportion the heterogeneous biological particles in the constriction region to further distinguish between subpopulations).

In another aspect, a system is disclosed comprising a processor or logic circuit; and a memory having instructions stored thereon, wherein execution of the instructions by the processor or logic circuit, cause the processor or logic circuit to control polarization or manipulation of biologic or particle components of interest when flowing through a microfluidic channel of a fluidic chip device according to any of the above method.

In another aspect, a system is disclosed comprising a processor or logic circuit; and a memory having instructions stored thereon, wherein execution of the instructions by the processor or logic circuit, cause the processor or logic circuit to perform geometric or functional quantification of an internal capacitive structure of an electric-field-generating structure located in the microfluidic chip and used for polarization or manipulation of biologic or particle components of interest according to any of the above method.

Other aspects and features according to the example embodiments of the disclosed technology will become apparent to those of ordinary skill in the art, upon reviewing the following detailed description in conjunction with the accompanying figures.

### BRIEF DESCRIPTION OF THE DRAWINGS

The skilled person in the art will understand that the drawings, described below, are for illustration purposes only.

FIGS. 1A, 1B, and 1C each show an exemplary microfluidic chip system for classifying a heterogeneous population of biological particles or cells in a sample using AI/ML analysis based on the mechanical properties of the biological particles or cells in accordance with an illustrative embodiment.

FIGS. 2A-2C each show embodiments of a method for classifying a heterogeneous population of biological particles in a sample in accordance with an illustrative embodiment.

FIGS. 3A-3D each show an overview of a training operation for training a machine learning model according to an illustrative embodiment.

FIG. 4 shows an overview of device simulations to compute impedance signal metrics. A. Progressive deformation of cells under viscoelastic hyperbolic extensional flow causes alterations to their anisotropy index (AI), as defined by ratio of its length (A) to width (B) in the flow direction, which is measured in the region prior to deformation (zone 1), during deformation (zone 2) and post-recovery (zone 3) using co-planar electrodes at channel floor, as well as by imaging (dashed box). B. Impedance signals of particles over the respective zones show that the non-deformable particle (blue) exhibits invariant signals, while elongation of the deformable particle (red) along its length and width causes systematic alterations in impedance signal amplitude and width. C. Simulated electric potential distribution inside the channel (25×30 μm) with coplanar electrodes (25 μm width and 15 μm spacing) for: (i) non-deformable, and (ii) deformable particles; (iii) using 3D simulations. D. Impedance signal metrics for particles with anisotropies of 1 to 3 as a function of electrical size: (i) Signal amplitude; and (ii) Signal width.

FIG. 5. Using impedance signal magnitude and width to compute a composite metric to predict anisotropy: A. (i) initial and (ii) deformed particle dimensions; B. Fitting method applied to: (i) Pre-deformation zone to compute initial length of spherical particle; (ii) Deformation zone to compute elongated length of ellipsoidal particle; (iii) Comparing predicted vs. real particle anisotropy over a range of particle sizes. C.(i) Multilayer perceptron (MLP) neural network with an input of signal amplitudes and widths and an output of predicted anisotropics that is optimized for fitting such functions (ii).

FIG. 6. Device operation and signal analysis. A. Fluidics for sample and sheath flows showing the impedance and image analysis region. B. Analysis region with hyperbolic extensional flow and the electrical wiring for signal acquisition. C. Time-lapse high-speed images of deformation of: (i) 12 μm beads (green); (ii) small cells (˜12 μm—red); and (iii) large cells (˜20 μm—blue). D. Impedance signal trains indicating the respective amplitudes (M), widths (2σ) and transit times (δ) of the particle in the pre-deformation, deformation, and recovery zones to measure anisotropy based on input metrics of amplitude (M₁, M₂, M₃) and shape parameter (σ₂/δ₂). E. A Multilayer perceptron (MLP) neural network trained with impedance and image cytometry data is used to derive a net electrical anisotropy index (EAI) for signal templating to extract cell shape anisotropy in the deformation zone. The EAI can be combined with electrical physiology metrics of the corresponding cells to classify live cancer cells vs. CAFs, using the SVM model.

FIG. 7. Validation of impedance vs. image metrics for cell shape anisotropy under hyperbolic extensional flow using untreated and fixed cancer-associated fibroblasts (CAFs), with beads as black symbols. A. Plateauing of impedance amplitude ratio at high image anisotropics; B. Linear rise in impedance shape parameter with image anisotropy over measured range; C. The neural network derived impedance signal templating to extract electrical anisotropy index (EAI) after training with image cytometry data shows near-equivalent cell anisotropy levels based on comparison of shape anisotropy from image cytometry (D) to EAI from impedance cytometry (E), with comparison of their significance (F): *** p<0.001 (˜2000 events per sample type for image data and ˜8000 events per sample type for impedance data).

FIG. 8. Impedance metrics for measurement of deformed cell shape anisotropy based on impedance signal amplitude ratio (M/M₂) in column (i); shape parameter (σ/δ) in column (ii); and the neural network-derived electrical anisotropy index (EAI) in column (iii) for A. Cancer associated fibroblasts (CAFs), and B. Cancer cells. The ellipses around the respective data clusters illustrate the Gaussian distribution for polystyrene beads (black-50% density plots), untreated (blue-90% density plots), and fixed cells (red-90% density plots), with ˜7000-8000 events per sample type.

FIG. 9. Impedance phase (φZ) at 18 MHz vs. 0.5 MHz is used to classify live vs. apoptotic cells based on: A.(i) untreated, and B.(i) gemcitabine-treated (1 μg/mL) cultures that include the apoptotic cells released from the adherent culture in C.(i). Cell deformability measured through the EAI metric exhibits broader distributions upon inclusion of apoptotic cells with live cells, as apparent after gating the live vs. apoptotic events (A(ii), B(ii) & C(ii)) using their respective φZ data (Panels A(i), B(i) & C(i)), with ˜7000 events per sample type.

FIG. 10. Distinction of pancreatic cancer cells vs. cancer-associated fibroblasts (CAFs) derived from the same metastatic patient using: A. image-based deformability metrics (˜2000 events per sample type); B. neural network-derived electrical anisotropy index (EAI) (˜7000-8000 events per sample type), C. SVM classifier based on: (i) electrical physiology (electrical size or

$$\sqrt[3]{{\vert Z \vert}_{0.5 MHz}} ;$$

impedance phase or φZ_{0.5 MHz} & φZ_{18 MHz}; and magnitude opacity or |Z|_{18 MHz}/|Z|_{0.5 MHz}); (ii) EAI from deformability; (iii) Combined electrical metrics from (i) and (ii).

FIG. 11A shows an exemplary neural network that is trained with image cytometry data using cells of known deformability that can be used for rapid signal templating of impedance cytometry data using heterogeneous samples for near real-time extraction of cell metrics (Panel A) to: Panel B: activate sorting by surface acoustic wave (SAW) deflection.

FIG. 11B shows an exemplary biophysical cytometry & sorting system in accordance with an illustrative embodiment.

FIG. 11C shows an exemplary biophysical cytometry & sorting system in accordance with an illustrative embodiment. The impedance and image metrics are used to activate the diaphragm to deflect desired particles for sorting at actuation frequency=20 Hz, duty cycle—50%, pressure to diaphragm=44 psi, cell sizes in the 20-50 μm range, Flow rates of 2-20 μL/min, Scale bar—100 μm

FIG. 12. Synchronization of the impedance and image signal trains for each cell event by cross-correlation; B-C. Alignment and normalization of single-cell impedance signal trains.

FIG. 13. Electrical size (A) and velocity (B) vs. image size. C. Sensitivity of impedance metrics to shape anisotropy. D-E. Simulated shear rate and velocity profiles under hyperbolic extensional flow in each region of interest.

FIG. 14. Nuclear size heterogeneity of Mac cells from blood (Mac-1) vs. from skin (Mac-2A & Mac-2B) after DAPI (i) and CD30 staining (ii). Scale bar=100 μm. D. Nuclear size comparison for: Mac-1: 10±0.06 μm, n=866; Mac-2A: 10.6±0.06, n=791; Mac-2B: 9.9±0.11, n=294 **** P<0.0001, one-way ANOVA Tukey.

FIG. 15. Comparison of nuclear shapes, telomere organization, and lamin A/C expression of lymphoma cells: A. mononucleated lymphocyte-sized cells (99% of the shapes for Mac-1 and 90% of the shapes for Mac-2A and Mac-2B); B. lymphocyte-sized multi-nuclear; C. protruding nuclei; D. giant mono-nuclear; and E. giant multi-nuclear shapes. B-E shapes were observed within only 1% Mac-1 cells versus within 10% of Mac-2A and 2B cells based on 100 cell observations using CD30 staining in red to show cell surface and DAPI DNA stain in blue to distinguish nucleus shape. F. 3D Telomere organization shows: (i) a flat and less distributed state for Mac-2A cells versus (ii) a spherical distribution for Mac-2B cells, as quantified in the plot by aspect ratio of the ellipsoid for comparison of 100 cells (iii). Mac-1 vs. Mac-2B (**** for p≤0.0001; *** for p≤0.001). G. Nuclear lamin A/C based on representative images with DAPI DNA stain in blue and lamin A/C immunostaining in green (i), compared to the same image without the DAPI channel (ii) shows varying levels of nuclear lamin A/C protein (iii) based on 100 cells analyzed per cell line. Mac-2A cells have the highest lamin A/C expression; (**** for p≤0.0001; *** for p≤0.001). Mac-2B cells show lower nuclear lamin A/C expression than Mac-2A cells and Mac-1 cells (p<106).

FIG. 16. A. (i) Microfluidic device for impedance and image-based cytometry under tunable viscoelastic extensional flows in a symmetric hyperbolic channel using: (ii) a pressurized diaphragm to optimize the channel geometry to enhance cell-type distinction on metrics from cell deformation, confined recovery (inside the hyperbolic flow region) and full recovery (in the open channel region). B. Pressurization of the diaphragm alters channel geometry, as apparent from images at inlet air pressures of: (i) 0 psi; (ii) 20 psi; (iii) 30 psi. C. Simulations of shear rate across the channel under diaphragm pressurization (0-30 psi), with the respective velocity alterations (i) and its spatial non-uniformity across the channel depth (ii at 30 psi). D. Cell anisotropy (index in A(ii)) measured by high-speed imaging at the diaphragm center point shows (i) enhanced cell deformation with pressurization due to a greater proportion of the heterogeneous cell sample (mixed Mac-1, Mac-2A & Mac-2B cells) being deformed to higher levels, thereby enabling improved CTCL cell-type distinction at: (iii) 30 psi vs. (ii) 20 psi.

FIG. 17. A. Simulations of single-cell impedance spectra with multi-shell dielectric model for increasing nucleus to cell size shows: (i) increasing impedance magnitude |Z| at high frequencies (18 MHz) causes lowering of impedance magnitude opacity or |Z_{18 MHz}|/|Z_{0.5 MHz}|; (ii) increasing impedance phase (φZ) at high frequencies (18 MHz). B. Histograms of measured impedance magnitude (>1000 events for Mac-1, Mac-2A and Mac-2B cell types) for metrics of: (i) electrical size or

$$\sqrt[3]{{\vert Z \vert}_{0.5 MHz}} ;$$

(ii) opacity at 2 MHz or |Z_{2 MHz}|/|Z_{0.5 MHz}|; (iii) opacity at 18 MHz or |Z_{18 MHz}|/|Z_{0.5 MHz}|. C. Scatter plots of impedance phase at high frequency of 18 MHz (φZ_{18 MHz}) vs. at low frequency of 0.5 MHz (φZ_{0.5 MHz}) for: (i) Mac-1, (ii) Mac-2A, and (iii) Mac-2B cells. Note: All measured |Z| data are normalized to electrical size

$$( = \sqrt[3]{{\vert Z \vert}_{0.5 MHz}} )$$

of co-flowing polystyrene beads of known size (12 μm) and φZ data are normalized to φZ=0 for co-flowing polystyrene beads. All data is based on ˜1000 events for each cell type.

FIG. 18. A. Hyperbolic microfluidic device for cytometry based on single-cell impedance, deformation and recovery metrics under viscoelastic extensional flow, showing the location of each measurement region (R1-R8). B. Representative images of the respective cells in their undeformed (R1), highly deformed (R4), confined recovery (R6), and near-complete recovery states (R8) for: (i) Mac-1; (ii) Mac-2A; and (iii) Mac-2B cells. C. The circularity metric

$$( 1 - \frac{2 \sqrt{π ( Area )}}{Perimeter} )$$

for Mac-1, Mac-2A, and Mac-2B cells (averaged over ˜1000 events) under confined recovery in the R6 region. D. The anisotropy index averaged over ˜1000 events for Mac-1, Mac-2A, and Mac-2B cells in the indicated R1-R8 regions (complete recovery occurs further down the channel from R8).

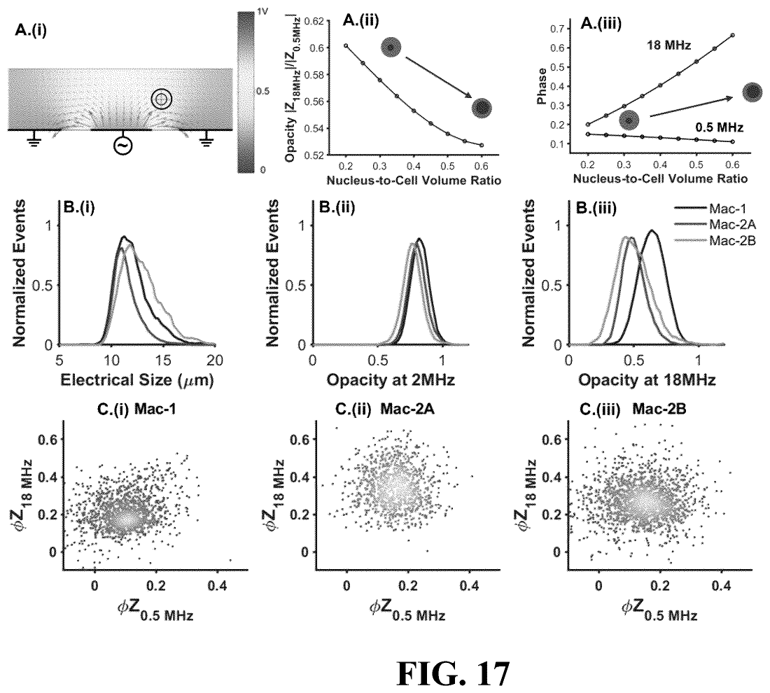

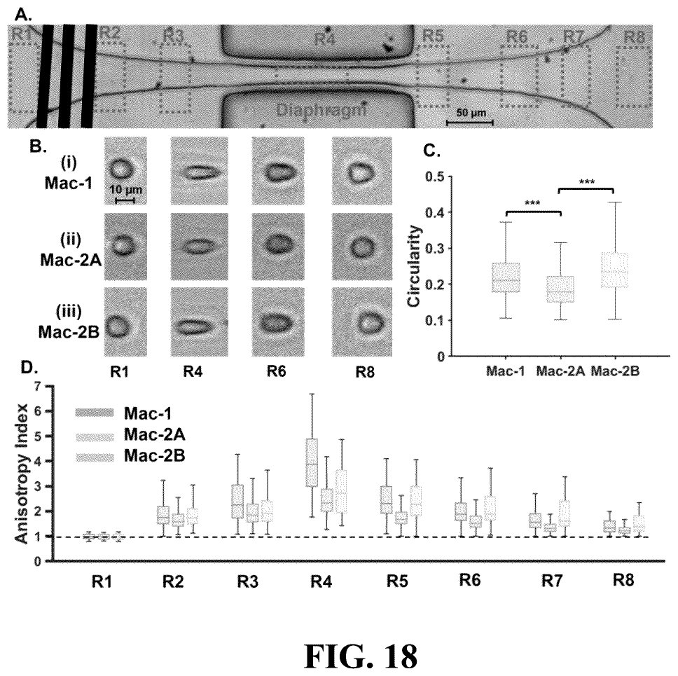

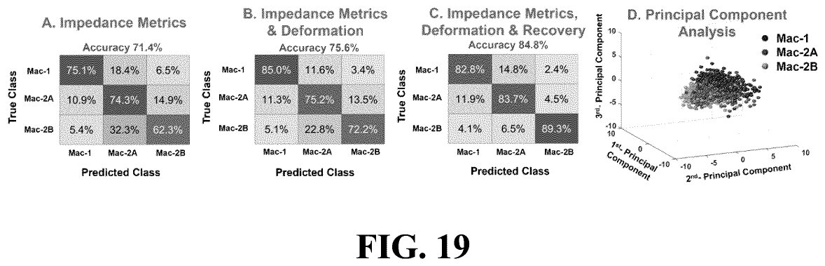

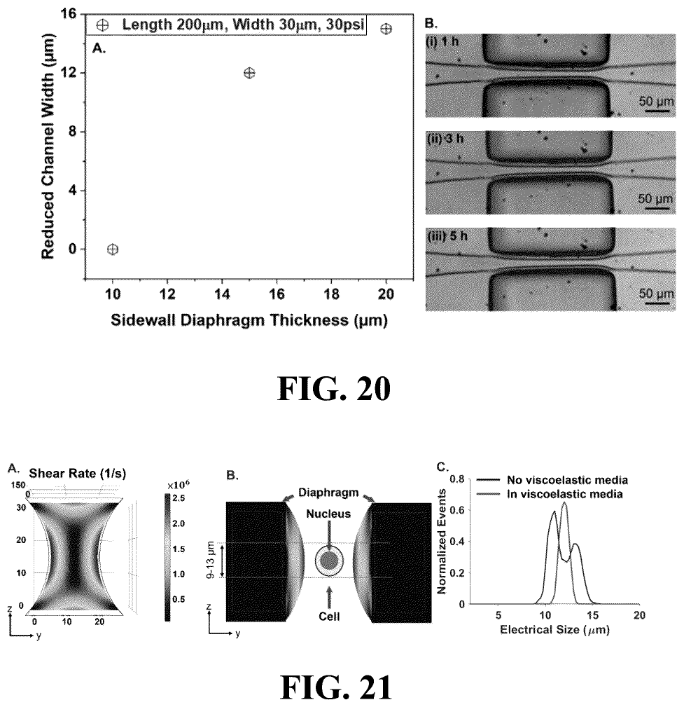

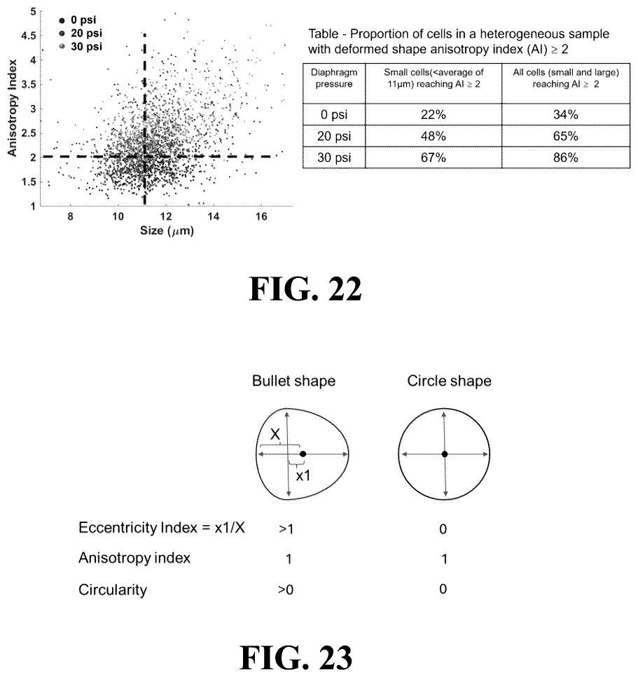

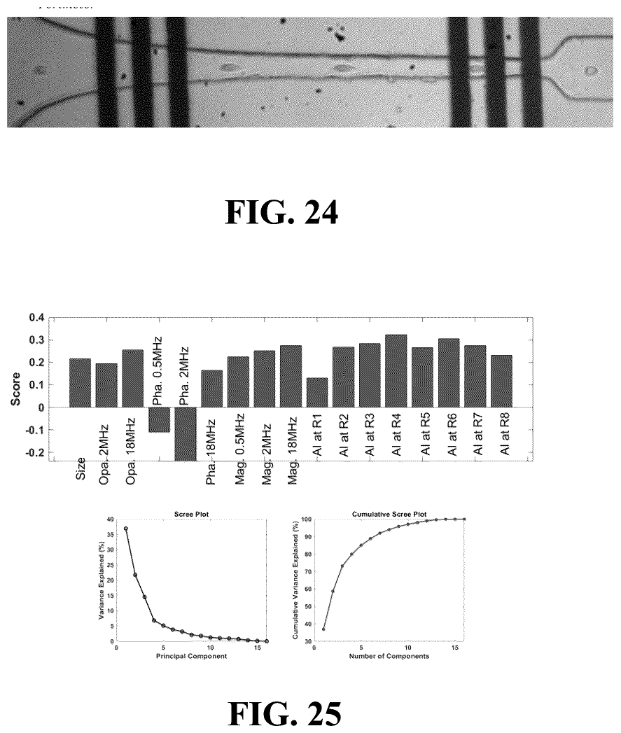

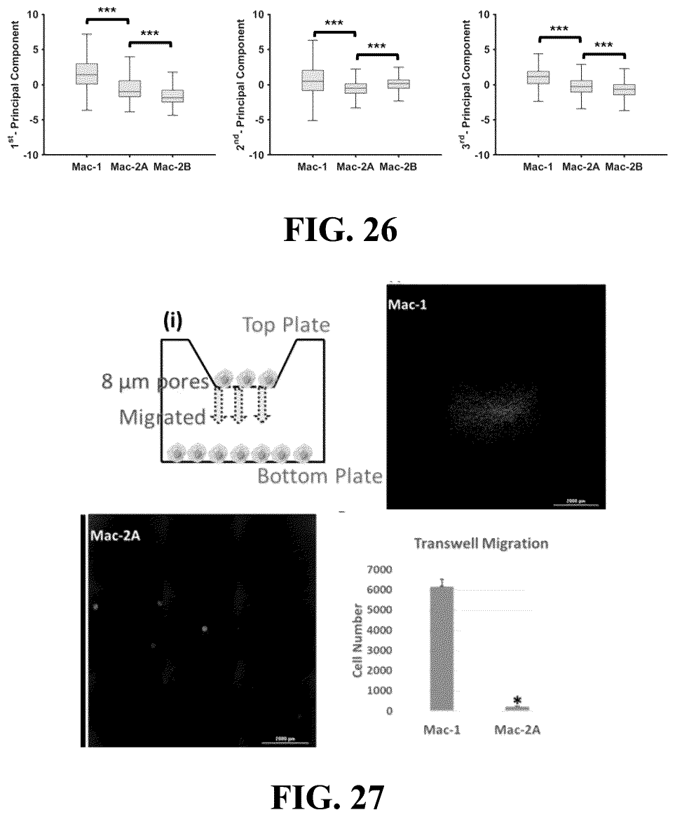

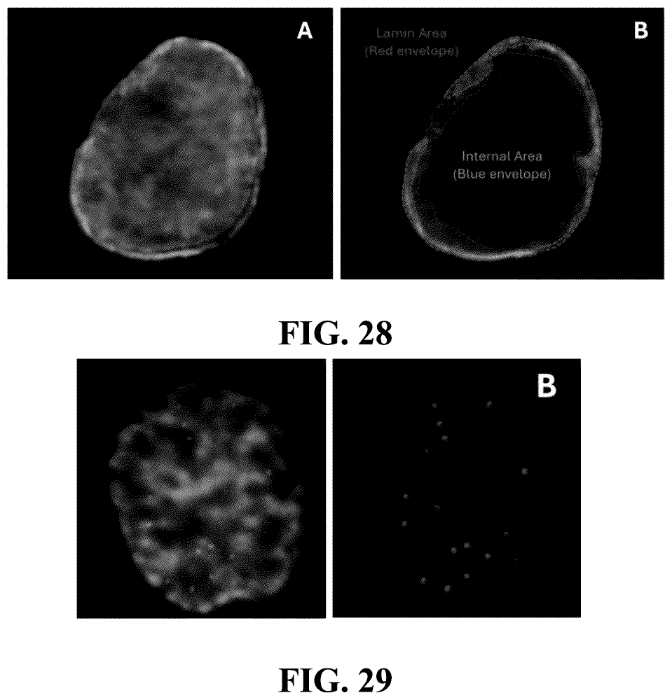

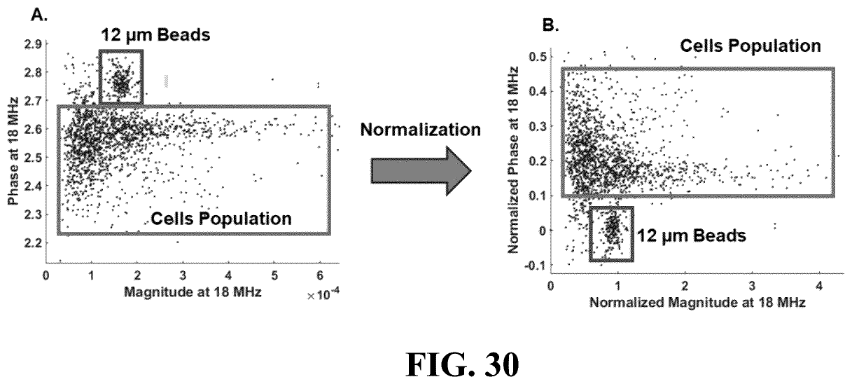

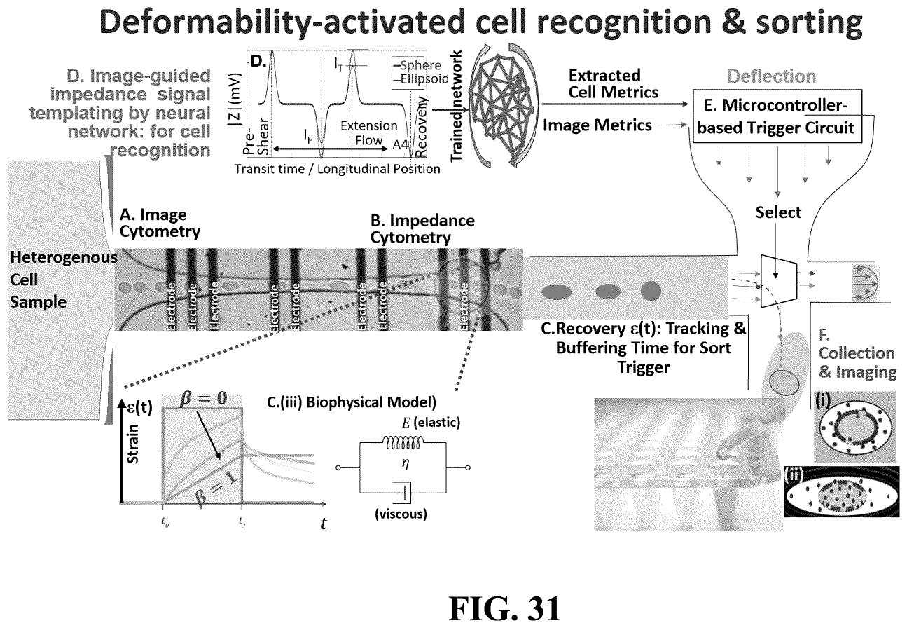

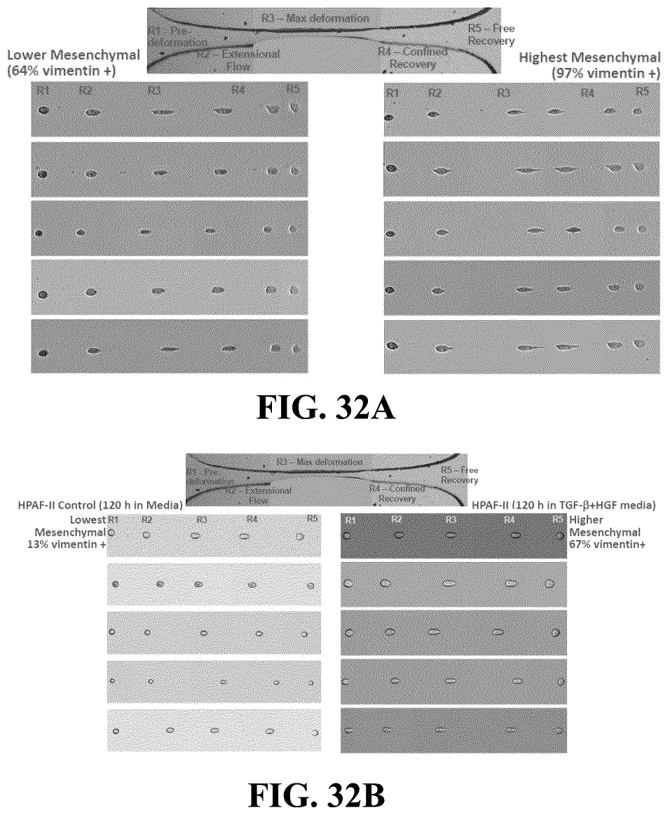

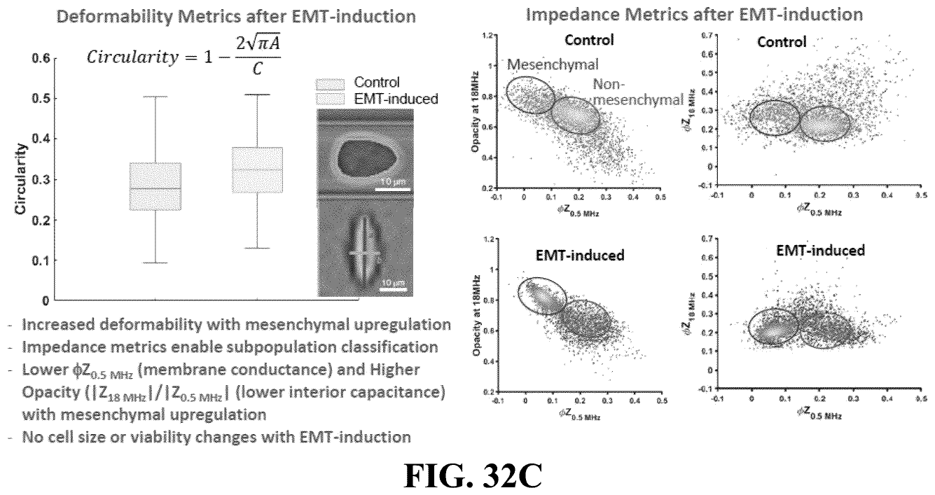

FIG. 19. Comparison of classification accuracies for Mac-1, Mac-2A and Mac-2B cells using: A. Impedance metrics (FIG. 17):

$$\sqrt[3]{{\vert Z \vert}_{0.5 MHz}} ;$$

|Z_{18 MHz}|, Opacity: |Z_{2 MHz}/Z_{0.5 MHz}|, |Z_{18 MHz}/Z_{0.5 MHz}|; and Phase: φZ_{0.5 MHz}, φZ_{2 MHz} & φZ_{18 MHz}. B. Impedance metrics from A and cell anisotropy at maximum deformation (R4 in FIG. 18). C. Impedance metrics and cell anisotropy under deformation (R2-R4 in FIG. 18) and under recovery (R5-R8) (based on ˜1000 events for each cell type). D. A 3D scatter plot of the three principal components from PCA, illustrating the separation between the cell types in the reduced feature space by using impedance, deformation and recovery metrics.

FIG. 20. A. Simulated reduced channel width as a function of sidewall diaphragm thickness under 30 psi actuation for a 200 μm×30 μm diaphragm. B. Images of diaphragm actuation under 30 psi for: (i) 1 hour; (ii) 3 hours; (iii) 5 hours.

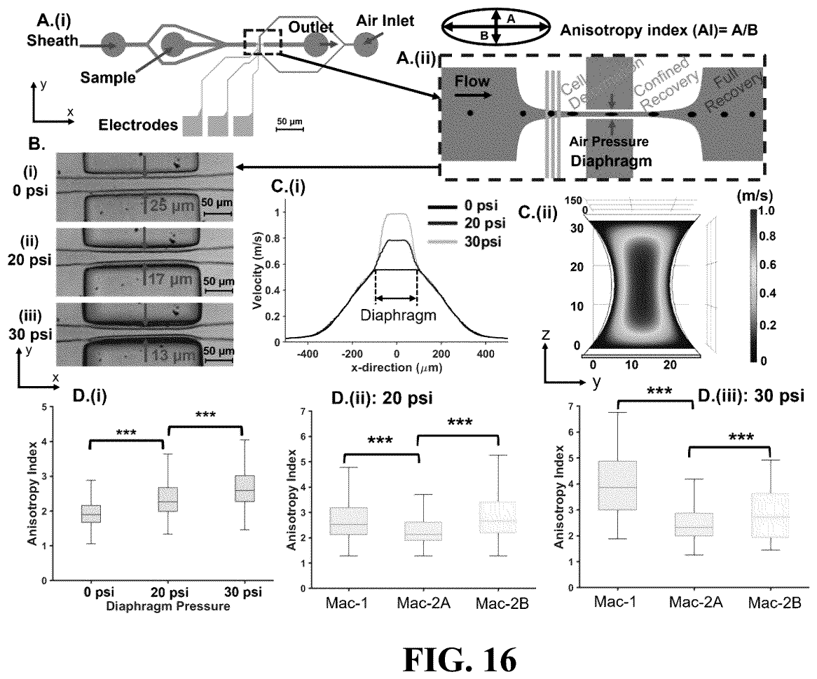

FIG. 21. Simulations (A-B) of the flow field due to diaphragm actuation and measurements (C) of particle focusing in channel depth. A. Despite the non-uniformity at the edges from channel narrowing across its depth due to diaphragm actuation, the axial flow velocity field (FIG. 16, Panel C(ii)) and shear stress distribution maintain spatial uniformity across the vertical (2) axis in the central region (˜15 μm of the 30 μm channel depth), confirming that the dominant shear and extensional forces are concentrated in the lateral (x-y) plane, with only minor vertical shear components near the top and bottom walls at the narrowest constriction region. B. Elasto-inertial focused cells of broad size distribution (e.g., 9-13 μm for Mac cells) do not experience much non-uniformity in stress distribution across the channel depth. C. Histograms (˜1000 events) of particle electrical size measurements from impedance cytometry

$$( \sqrt[3]{{\vert Z \vert}_{0.5 MHz}} )$$

confirm that while cells are focused at two positions across the channel depth in absence of viscoelastic flow (in PBS), they are elasto-inertially focused towards the center position in channel depth under viscoelastic flow (2% w/w of 0.6 MDa PEO).

FIG. 22. Scatter plot of anisotropy index (AI) vs. cell size in a heterogeneous Mac cell sample of 9-13 μm size (Mac-1, Mac-2A & Mac-2B) with data summarized in the adjoining table. With increasing diaphragm pressure (psi), a greater proportion of small cells (<average size of 11 μm) and total cells (small and large) reach AI levels≥2, thereby enabling deformability-based distinction to a better resolution and lower measurement error.

FIG. 23. Axis eccentricity metric to distinguish bullet shape from circular shape. The circularity metric

$$( ( \frac{2 \sqrt{π ( Area )}}{Perimeter} )$$

was used in FIG. 18 to quantify the bullet shape.

FIG. 24. Rapid and full recovery of Mac-1 cells in the open channel design versus the confined recovery in the inverse hyperbolic channel design used for results in FIG. 18.

FIG. 25. A. PCA score plot illustrating feature contributions to the principal components. Among impedance metrics, opacity and magnitude at 18 MHz show the highest contributions, while the maximum deformation at region R4 and recovery at region R6 are the most significant among mechanical features. B. Scree plot and C. cumulative scree plot show that the first three principal components together explain approximately 75% of the total variance.

FIG. 26. Box plots show the distribution of each principal component across the three classified cell types. The plots highlight how the first few components contribute to class separation, as also visualized in the PCA scatter plot (FIG. 19, Panel D).

FIG. 27. Transwell migration assay per schematic in (i) to compare Mac-1 vs. Mac-2A cells. 2×10⁴ cells of each cell type were loaded in the transwell inserts. After a 1-hour culture and lymphoma cell staining to delineate cell adhesion, there were about 6168 Mac-1 cells migrating to the bottom layer, while only about 227 Mac-2A cells migrated within one hour. (Mac-1 6168±352 vs Mac-2A 227±2, n=3, t-test, p<0.001). Scale bar=2 mm.

FIG. 28. Lamin A/C quantification methodology. A. Image of a Mac-2A cell. Lamin A/C staining in green, DAPI DNA stain in blue. B. The external total Lamin A/C intensity (Iₑ) was the total signal sum from the area enclosed with red. The internal total Lamin A/C intensity (Iᵢ) signal was the sum of the area enclosed in blue. The final number representing Lamin A/C expression of a cell was Iₑ/Iᵢ.

FIG. 29. Representative 2D image with nuclear DNA in blue and telomeres in red (A) followed by an image of the same cell, only telomeres (B).

FIG. 30. Gating for impedance data Analysis. A. Scatter plot of impedance magnitude versus impedance phase at 18 MHz is used to normalize the data against the 7 μm polystyrene beads. B. after normalizing the data, a gate is then generated to include the cells. This gate is used for all the measurements at each prob frequency.

FIG. 31. An exemplary neural network is trained with image cytometry data using cells of known deformability that can be used for rapid signal templating of impedance cytometry data using heterogeneous samples for near real-time extraction of cell metrics to activate sorting by surface acoustic wave (SAW) deflection.

FIGS. 32A-32C show deformability analysis for mesenchymal cells.

### DETAILED DESCRIPTION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” and [n′] correspond to the n^{th} reference in the respective reference list. All references cited and discussed in this specification are incorporated herein by reference in their entireties and to the same extent as if each reference were individually incorporated by reference.

### Example System

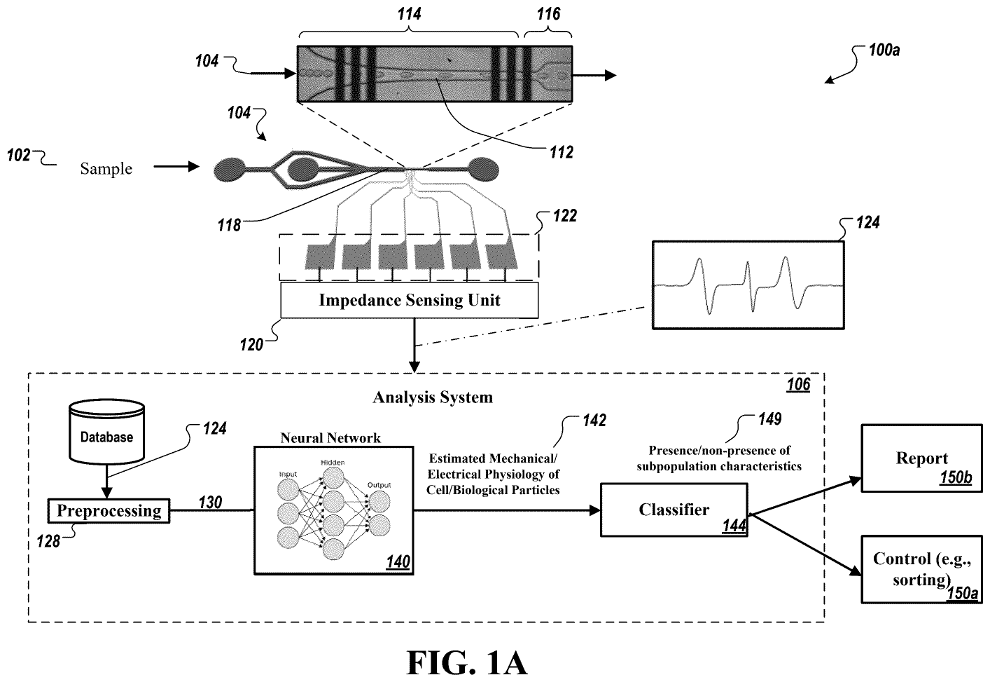

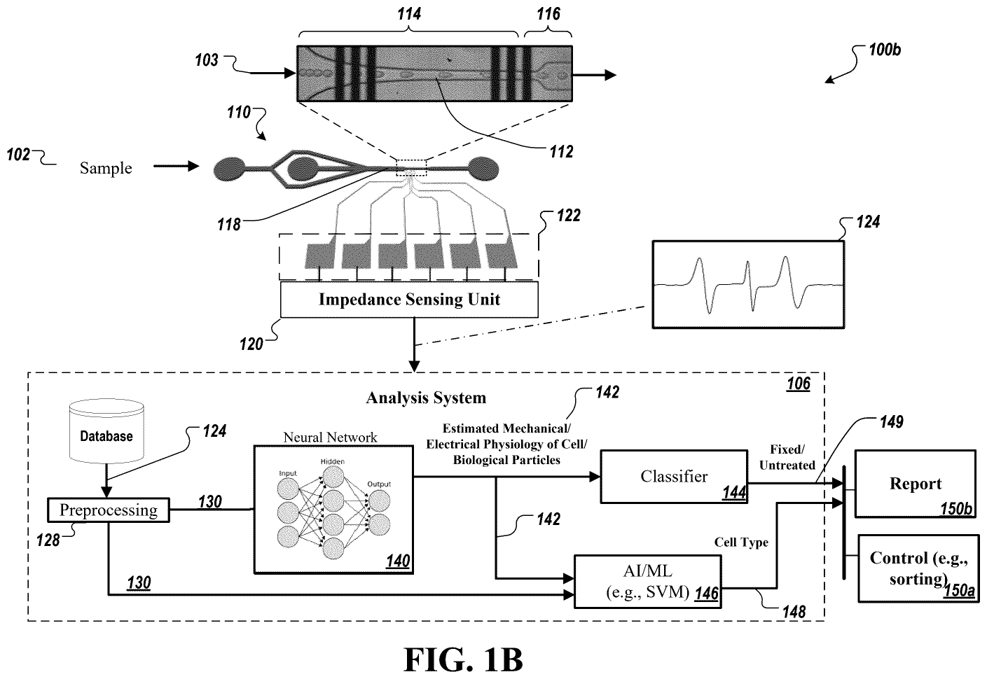

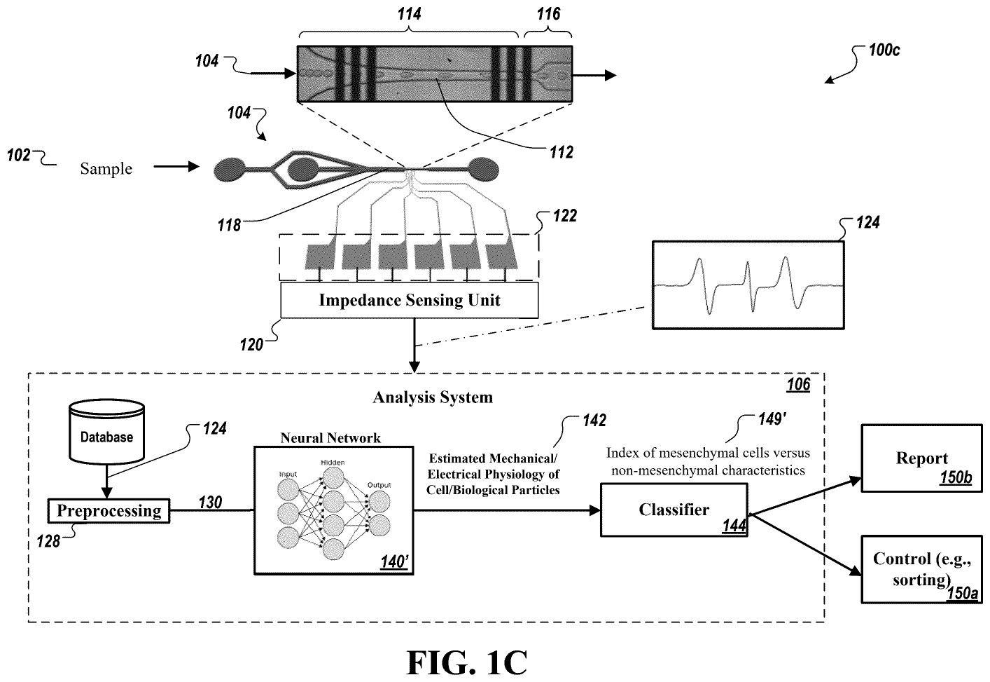

FIGS. 1A, 1B, and 1C each show an exemplary microfluidic chip system 100 (shown as 100a, 100b, 100c, respectively) for classifying a heterogeneous population of biological particles or cells in a sample 102 based on an AI/ML analysis, of impedance measurements, to perform the classifying of mechanical properties of the biological particles or cells in accordance with an illustrative embodiment.

In the example shown in FIG. 1A, the microfluidic chip system 100 includes a microfluidic chip device 104 configured to operate with an AI/ML analysis system 106. The microfluidic chip device 104 includes an impedance sensing unit 108 comprising on-chip patterned electrodes configured to measurement the electric field of cells or biological particles passing over patterned electrodes.

The microfluidic device 104 includes a microfluidic channel 112 comprising a hyperbolic extensional channel having a contoured constriction region 114 configured to induce viscoelastic flow of the biological particles or cells as the sample flows through the hyperbolic extensional channel. In FIG. 1A, the contoured constriction region 114 is shown to be larger than a particle size and is configured to induce viscoelastic extensional flow for deformation and relaxation of the biological particles flowing therethrough. The contoured constriction region of the microfluidic channel defines a substantially hyperbolic curve. The term “hyperbolic” is intended to also encompass substantially hyperbolic profiles (i.e., not precisely hyperbolic shapes).

In some aspects, the microfluidic channel comprises a compliant material operatively coupled to an external actuator, wherein the microfluidic channel is configured to deform (e.g., from a first cross-sectional area to a second cross-sectional area) in response to a force generated by the external actuator (e.g., for enhancing and/or optimizing deformation of a wider size range of the biological particles in the constriction region to further distinguish between subpopulations).

The flow path 103 of the microfluidic channel 112 may further includes a pre-constriction region 118 and a recovery region 116 proximal to and in fluid communication with the contoured constriction region 114 such that a biological particle moves from the pre-constriction region 118 (e.g., immediately before) (in its baseline form) to the constriction region 114 (in a constricted form) and then from the constriction region 114 to the recovery region 116 (in a relaxed form). In some aspects, the microfluidic channel further includes a sorting region in fluid communication with the pre-constriction region, contoured constriction region, and/or the recovery region. The sorting region may be positioned before or after the hyperbolic extensional channel.

The impedance sensing unit 108 includes one or more sets of electrodes 122 disposed along the flow path of the microfluidic channel 112 to provide impedance signal measurements 124. The one or more sets of electrodes 122 are configured to interrogate, via an electric field, single-particle impedance characteristics that can be used to distinguish, via the analysis system 102, biophysical features of the biological particles/cells, such as their size, velocity, shape anisotropy and dielectric properties along the flow path of the microfluidic channel 112 to provide impedance signal data 124. In some aspects, the impedance sensing unit 108 includes a first set of electrodes disposed about the pre-constriction region, a second set of electrodes disposed about the contoured region, and a third set of electrodes disposed about the recovery region. In other configurations, the impedance sensing unit 108 includes a first set of electrodes disposed in the contoured region. In other configurations, the impedance sensing unit 108 includes a first set of electrodes disposed in the contoured region and a second set of electrodes disposed about the recovery region. In other configurations, the impedance sensing unit 108 includes a first set of electrodes disposed in the pre-constriction region and a second set of electrodes disposed about the constriction region.

The impedance sensing unit 108 can be configured preferably as an on-chip electronic circuit though can be alternatively implemented using off-chip circuitries. As used herein, the term “on-chip” refers to a microfluidic circuit structure (e.g., microfluidic device 104) that is mechanically and electronically integrated with electronic circuit components (e.g., impedance sensing unit 108) to form a fully integrated unit that includes all components necessary to measure and/or assess impedance spectra for the geometric or functional quantification of internal structures of the microfluidic chip and/or to measure and/or assess the impedance characteristics of the biological particles to control polarization or manipulation of the biological particles.

System 100 further includes a computing device configured with the analysis system 102, the computing device having a processor (e.g., CPU or GPU) and memory operatively coupled to the processor and having instructions stored thereon. Execution of the instructions by the processor causes the processor (e.g., in real-time) to obtain the impedance signal data 124 acquired from the impedance sensing unit 108 and classify the biological particles into cell or particle subpopulations via a trained machine learning (ML) model.

The analysis system 104 preferably includes a preprocessing module 128 configured to preprocess the impedance signal data 124, e.g., to condition the measurement signal and analyze the signal, e.g., to extract one or more impedance metrics 130 (e.g., opacity and magnitude). As shown in FIGS. 1A, 1B, and 1C, the trained ML model can include a trained neural network 140 (e.g., Multilayer Perceptron (MLP) neural network, etc.) that has been trained using a data set comprising a sequence of images, or mechanical properties of the cells/biological particles derived therefrom, of a set of cells or biological particles flowing in viscoelastic extensional flow along a flow path of the microfluidic channel (e.g., another device used for training) through the contoured constriction region and corresponding impedance signal data (e.g., impedance signal training set). The neural network 140 is configured to determine an estimated mechanical property/electrical physiology of the cell or biological particles 142 based on the impedance metrics 130. The estimated mechanical property/electrical physiology of the cell or biological particles 142 can be used for the classification 144 of the cell. An example classification would be the presence/non-presence of subpopulation characteristics 149 (e.g., fixed/untreated state) of the cell/biological particle.

The estimated mechanical property/electrical physiology 142 can also be further employed for use in a second AI/ML model (see FIG. 1B) as input to a second classification model (e.g., a support vector machine 146), e.g., for determining a second subpopulation metric 148 (e.g., a cell classification). In some embodiments, the AI/ML 146 (FIG. 1B) may be a support vector machine configured to construct hyperplanes in multidimensional space to analyze data, recognize patterns, classify and sort such data with similar attributes into one set of defined groups, categorize and sort such data with similar and/or differing attributes into other sets of defined groups, and develop the ability to predict such classification and/or categorization after training.

The AI/ML 146 (FIG. 1B) may be configured to determine, based on the estimated mechanical property/electrical physiology of the cell 142 and the one or more impedance metrics, a classification (e.g., cell type) of the cell flowing through the microfluidic channel 112. In some aspects, the trained neural network 140 is configured to determine an estimated value for an electrical anisotropy index of the biological particle based on normalization against co-flowing microgel beads of known stiffness.

The AI/ML (FIG. 1C) may be configured to determine, based on the estimated mechanical property/electrical physiology of the cell 142 and the one or more impedance metrics, a classification of an index of mesenchymal cells versus non-mesenchymal cells. Were cancer cells are to gradually induce mesenchymal characteristic in cells, the system can provide an output of the expression of the mesenchymal characteristics. FIG. 32A-32C show experimental results from a deformability cytometry study for low versus high mesenchymal characteristics/expressions. In FIG. 32A, the imaging cytometry measurements are shown for deformation of MiaPaca cells with low (left) vs. high (right) mesenchymal characteristics. In FIG. 32B, the imaging cytometry measurements are shown for deformation of HPAF-II cells with low (left) vs. high (right) mesenchymal characteristics/expressions. FIG. 32C shows the results of the measurement. It can be observed that mesenchymal upregulation appears to increase deformability.

The exemplary system is configured to classify the biological particles into subpopulations. As used herein, the term subpopulation refers to a grouping of biological particles (e.g., cells) that share a common characteristic. In some aspects, the biological particles comprise cells (e.g., circulating tumor cells (CTCs)). In some aspects, the processor, via the trained ML model, is configured to classify the biological particles into cell or marker subpopulations based on epithelial and mesenchymal states. In some aspects, the processor, via the trained ML model, is configured to classify the cells into cell or marker subpopulations based on fixed and untreated states.

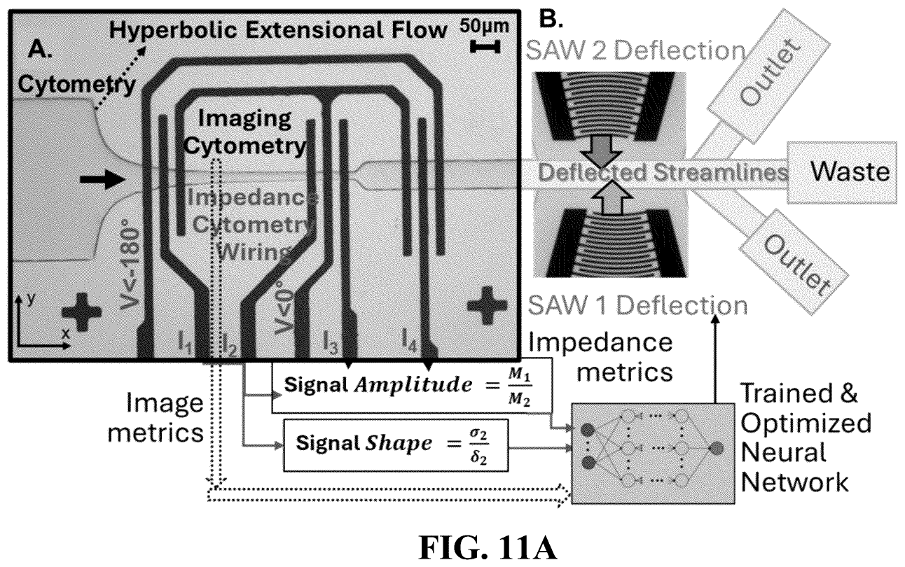

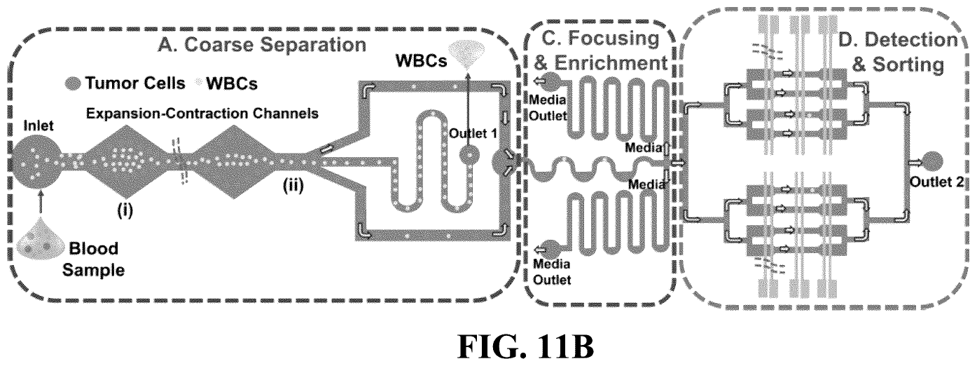

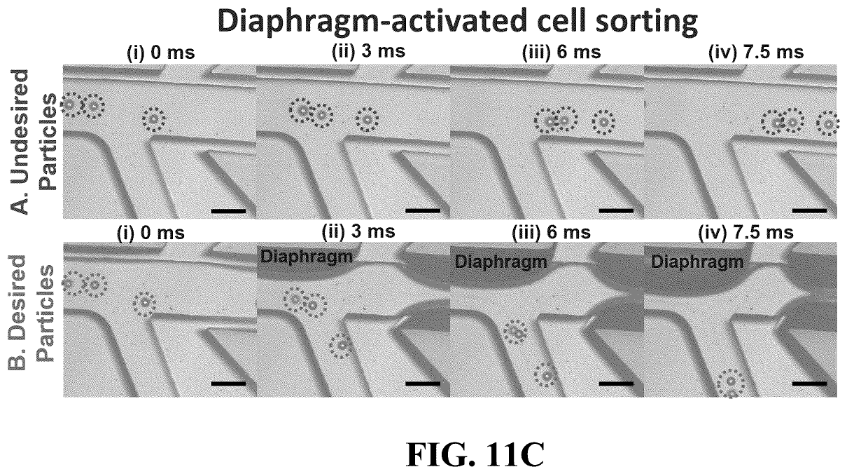

As illustrated in FIG. 1A, the computing device further provides information of the cell state 149 and cell type 148 to an output 150a, 105b, e.g., for report or control. An example of control is cell sorting. In cell sorting, a cell sorting unit may be configured to determine or receive a control signal to selectively direct the cells towards a respective bin (e.g., using surface acoustic waves) based on the cell state 149 and/or cell type 148 (e.g., for separation or for analysis). A surface acoustic wave (SAW) may be generated using an inter-digitated transducer (IDT) supported by a piezoelectric substrate. The transducer may be formed of two comb-shaped electrodes having interlocking teeth or fingers. An IDT can convert periodically varying electrical signals into mechanical vibrations or acoustic waves able to travel along the surface of a material to thereby direct the biological particles in a specific direction. Example of impedance metrics to actively sort cells are shown in FIG. 11A, 11B, 11C, and FIG. 31.

The exemplary system can provide high throughput cell analysis (e.g., 100-500 cells/s) that can provide statistically significant event numbers to classify fractional subpopulations (1 in 100 or 1000). FIG. 22 provide a scenario where the optimal pressure to cause a critical level of cell deformation on a wide range of cell size is used with the neural network to identify cell subpopulation classification. For the activated sorting, an alternate scenario to what is shown in FIG. 11, but where a diaphragm for deflection of streamline instead of SAW. In this scenario, the cell phenotype and velocity from impedance measurement may be used to trigger the diaphragm to deflect streamline.

In FIG. 11A, the signal amplitude and shape from impedance measurements are shown used as training data in combination with image metric, as ground truth, for the training. A trained AI model can be subsequently used for sorting or characterization of later unknown population of cells. The sorting can be used to isolate cells for later analysis (automated or manual). In some embodiments, sorted cells are subjected to fluoroscopy, biopsy, etc. As noted, in some embodiments, a diaphragm may be employed to deflect streamline instead of SAW, e.g., where the diaphragm is trigged using assessment of cell phenotype and velocity from impedance measurement. The diaphragm may be actuated by a pneumatic piston or device. FIG. 31 similarly shows impedance measurements being used by a trained AI model to trigger a sorting operation via SAW deflection.

In FIG. 11B, a multi-stage sorting microfluidic device is shown having a first stage for coarse separation, a second stage for enrichment, and a third stage for detection and sorting. In the detection and sorting stage, impedance electrodes may be employed in combination with AI-based controller and mechanotransduction as described herein. In FIG. 11B, the system may be used for handling biopsies by enriching CTCs by coarse separation and removing excess sample prior to biophysical cytometry for detection and activated sorting.

Referring now to FIG. 1B, the computing device 130 may also provide a report 150b providing qualitative/quantitative information about the classification of the cell (e.g., cell state or cell type). As used herein, the term “report” refers to a record or summary of the information which may be provided in written, graphical, electronic, or audio form, or combinations of these forms, as described above. For example, the report can indicate the presence of, nature of, or risk for the pathological condition (e.g., based on a qualitative or quantitative metric of the biological particles). The report can also be used to indicate what treatment is most appropriate, e.g., no action, surgery, further tests, or administering a therapeutic agent.

In its most basic configuration, the computing device includes at least one processing unit and system memory. Depending on the exact configuration and type of computing device, system memory may be volatile (such as random-access memory (RAM)), non-volatile (such as read-only memory (ROM), flash memory, etc.), or some combination of the two.

The processing unit may be a programmable processor or a graphic processing unit that performs arithmetic and logic operations necessary for the operation of the computing device. While only one processing unit is shown, multiple processors (CPU, GPU, AI chip) may be present. As used herein, processing unit and processor refer to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

Computing devices may have additional features/functionality. For example, the computing device may include additional storage such as removable storage and non-removable storage including, but not limited to, magnetic or optical disks or tapes. Computing devices may also contain network connection(s) that allow the device to communicate with other devices, such as over the communication pathways described herein. The network connection(s) may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing devices may also have input device(s) such as keyboards, keypads, switches, dials, mice, trackballs, touch screens, voice recognizers, card readers, paper tape readers, or other well-known input devices. Output device(s) such as printers, video monitors, liquid crystal displays (LCDs), touch screen displays, displays, speakers, etc., may also be included. The additional devices may be connected to the bus in order to facilitate the communication of data among the components of the computing device. All these devices are well-known in the art and need not be discussed at length here.

The computing device may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example tangible, computer-readable media may include but is not limited to volatile media, non-volatile media, removable media, and non-removable media implemented in any method or technology for storage of information such as computer-readable instructions, data structures, program modules, or other data. System memory, removable storage, and non-removable storage are all examples of tangible computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture to store and execute the software components presented herein. It also should be appreciated that the computer architecture may include other types of computing devices, including hand-held computers, embedded computer systems, personal digital assistants, and other types of computing devices known to those skilled in the art.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

The exemplary system and method may be implemented (1) as a sequence of computer-implemented acts or program modules running on a computing system and/or (2) as interconnected machine logic circuits or circuit modules within the computing system. The logical operations described herein are referred to variously as state operations, acts, or modules. These operations, acts, and/or modules can be implemented in software, in firmware, in special-purpose digital logic, in hardware, and any combination thereof. It should also be appreciated that more or fewer operations can be performed than shown in the figures and described herein. These operations can also be performed in a different order than those described herein.

Although the system 100 shown in FIGS. 1A-1B contain a local computing device, other embodiments may utilize a network interface to transmit the impedance signal data obtained from the impedance sensing unit to another computing device. As used herein, the term “network interface” refers to any signal, data, and/or software interface with a component, network, and/or process. By way of non-limiting example, a network interface may include one or more of Fire Wire (e.g., FW400, FW110, and/or other variation.), USB (e.g., USB2), Ethernet (e.g., 10/100, 10/100/1000 (Gigabit Ethernet), 10-Gig-E, and/or other Ethernet implementations), MoCA, Coaxsys (e.g., TVnet™), radio frequency tuner (e.g., in-band or OOB, cable modem, and/or other protocol), Wi-Fi (802.11), WiMAX (802.16), PAN (e.g., 802.15), cellular (e.g., 3G, LTE/LTE-A/TD-LTE, GSM, and/or other cellular technology), IrDA families, and/or other network interfaces. As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards. As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other wireless technology), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

Cloud System. The computer system is capable of executing the software components described herein for the exemplary method or systems. In an embodiment, the computing device may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device to provide the functionality of a number of servers that are not directly bound to the number of computers in the computing device. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or can be hired on an as-needed basis from a third-party provider. Some cloud computing environments may comprise cloud computing resources owned and operated by the enterprise as well as cloud computing resources hired and/or leased from a third-party provider.

### Example Methods

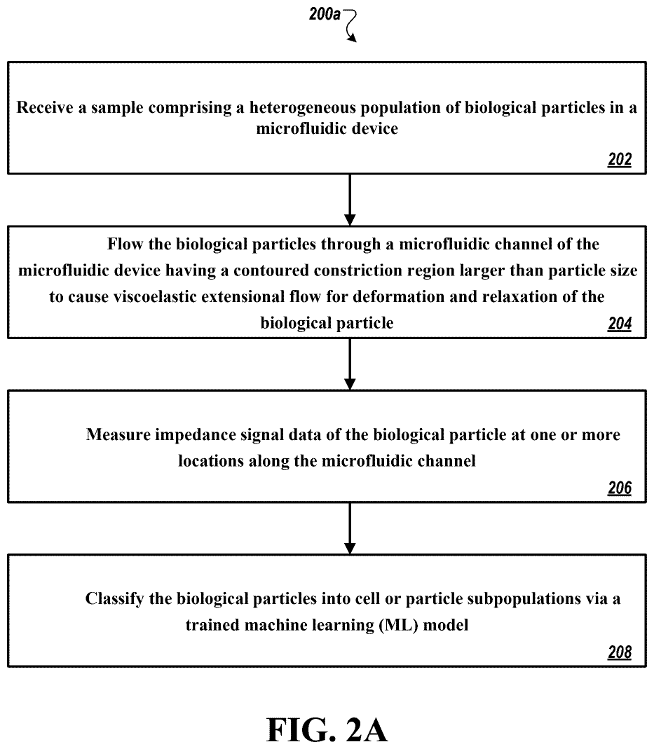

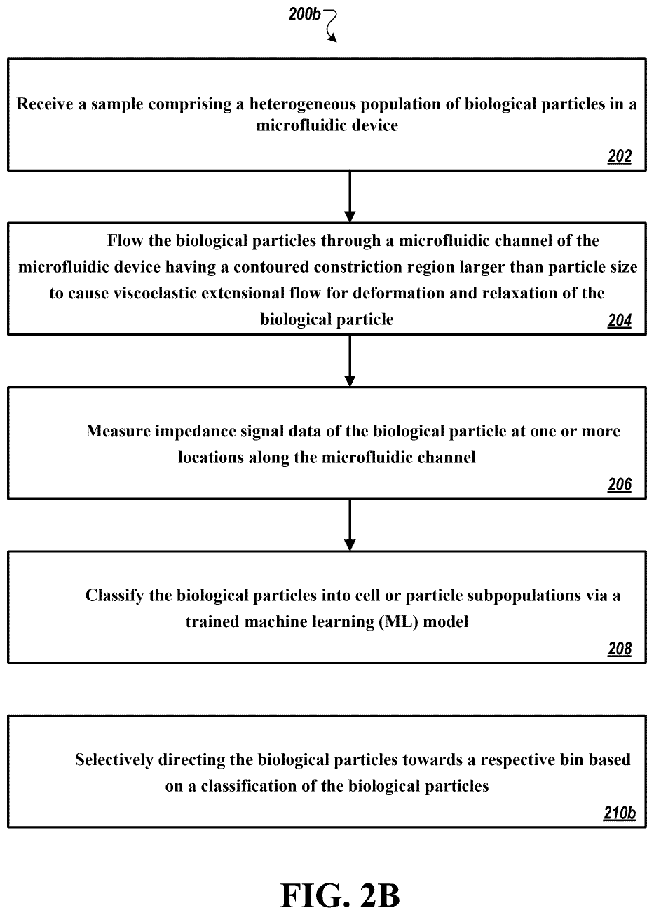

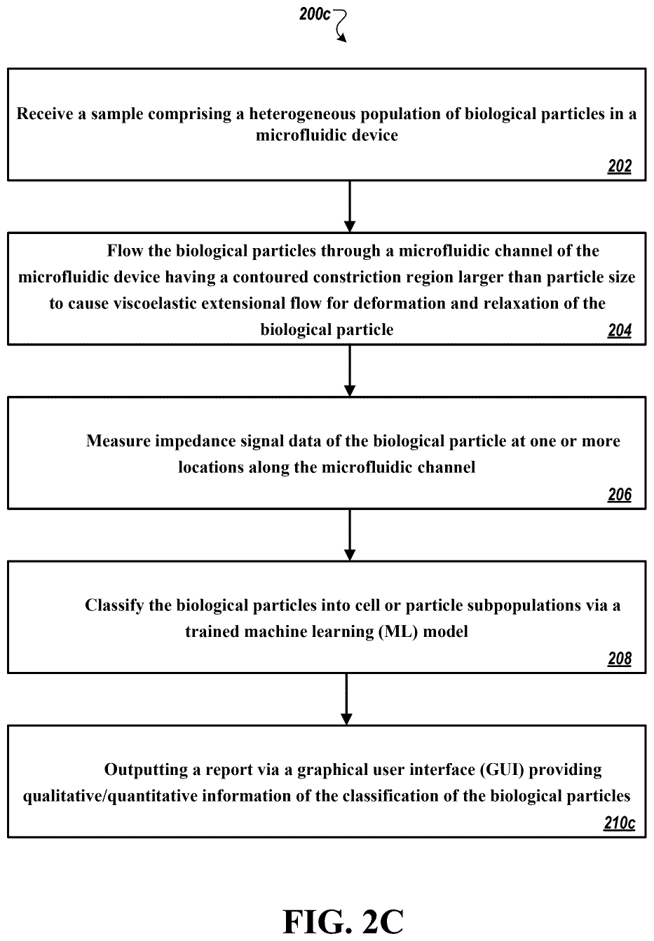

FIGS. 2A, 2B, and 2B each show example methods 200 (shown as 200a, 200b, 200c) that can be used to classify biological particles according to the present disclosure.

Method 200 includes: receiving (202) a sample comprising a heterogeneous population of biological particles in a microfluidic device. As used herein, the term “heterogeneous population of biological particles” refers to a population of biological particles (e.g., cells) comprising two or more different types or states that can be differentiated based on viscoelastic properties. The term “biological particle,” as used herein, generally refers to a discrete biological system derived from a biological sample. The biological particle may be a macromolecule, small molecule, virus, cell, cell derivative, cell nucleus, cell organelle, cell constituent, and the like. In some aspects, the biological particle includes a population of cells. For example, said population of cells may result from any biological sample obtained from a subject (e.g., a patient). Examples of biological samples include tissue, organs, or bodily fluids such as whole blood, plasma, serum, tissue, lavage or any other specimen.

Method 200 further includes flowing (204) the biological particles through a microfluidic channel of the microfluidic device having a contoured constriction region larger than particle size to cause viscoelastic extensional flow for deformation and relaxation of the biological particle. The contoured constriction region is typically configured for single-cell cytometric flow. Method 200 also includes measuring (206) impedance signal data of the biological particle at one or more locations along the microfluidic channel.

The biological particles are then classified (208) into cell or particle subpopulations via a trained machine learning (ML) model. The trained ML model is trained using a training data set comprising a sequence of images, or associated data, of a set of biological particles flowing in viscoelastic extensional flow along a flow path of the microfluidic channel (e.g., another device used for training) through the contoured constriction region and corresponding impedance signal data (e.g., impedance signal training set). The term “image” refers to a two-dimensional (2D) or three-dimensional (3D) microscopic image of a biological particle or a significant portion of the particle. The image may be captured with any imaging system, including a microscope. In some aspects, the sequence of images, or associated data, includes images of cells that have been fluorescently labeled.

In some aspects, the biological particles comprise cells (e.g., circulating tumor cells (CTCs)). In some aspects, cells are classified into subpopulations based on epithelial and mesenchymal states. In some aspects, cells are classified into subpopulations based on mesenchymal and non-mesenchymal expression. In some aspects, the cells are classified into subpopulations based on fixed and untreated states. In some aspects, the method further includes modulating an external actuator to deform the microfluidic channel (e.g., from a first cross-sectional area to a second cross-sectional area) to enhance and/or optimize deformation of the biological particles in the constriction region to further distinguish between subpopulations.

Referring now specifically to FIG. 2B, method 200b further includes: selectively directing (210c) the biological particles towards a respective bin (e.g., using surface acoustic waves) based on a classification of the biological particles. A surface acoustic wave (SAW) may be generated using an inter-digitated transducer (IDT) supported by a piezoelectric substrate. The transducer may be formed of two comb-shaped electrodes having interlocking teeth or fingers. An IDT can convert periodically-varying electrical signals into mechanical vibrations or acoustic waves able to travel along the surface of a material to thereby direct the biological particles in a specific direction.

Referring now specifically to FIG. 2C, method 200c further includes: outputting a report (e.g., via a graphical user interface (GUI)) providing qualitative/quantitative information about the classification of the biological particle. As noted above, the term “report” refers to a record or summary of the information which may be provided in written, graphical, electronic, or audio form, or combinations of these forms, as described above. For example, the report can indicate the presence of, nature of, or risk for the pathological condition (e.g., based on a qualitative or quantitative metric of the biological particles). The report can also be used to indicate what treatment is most appropriate e.g. no action, surgery, further tests, or administering a therapeutic agent.

In some aspects, the trained ML model comprises a multilayer perceptron neural network (MLPNN). In some aspects, the MLPNN is configured based on image data on particle shape anisotropy to determine an estimated electrical anisotropy index of the biological particle. In some aspects, the trained ML model further comprises a Support Vector Machine (SVM) configured to classify the biological particles into subpopulations based on the estimated electrical anisotropy index from the MLPNN.

In some aspects, the sequence of images, or associated data comprises one or more morphological parameters derived from segmented optical images of training biological particles within the microfluidic channel. In some aspects, the one or more morphological parameters comprise one or more of cell size, centroid eccentricity, circularity, and/or anisotropic index.

In some aspects, the impedance signal data comprises one or more of electrical size, transit time, amplitude values for impedance magnitude and phase at specific frequencies, or a composite metric.

### Example Machine Learning Training and Analysis

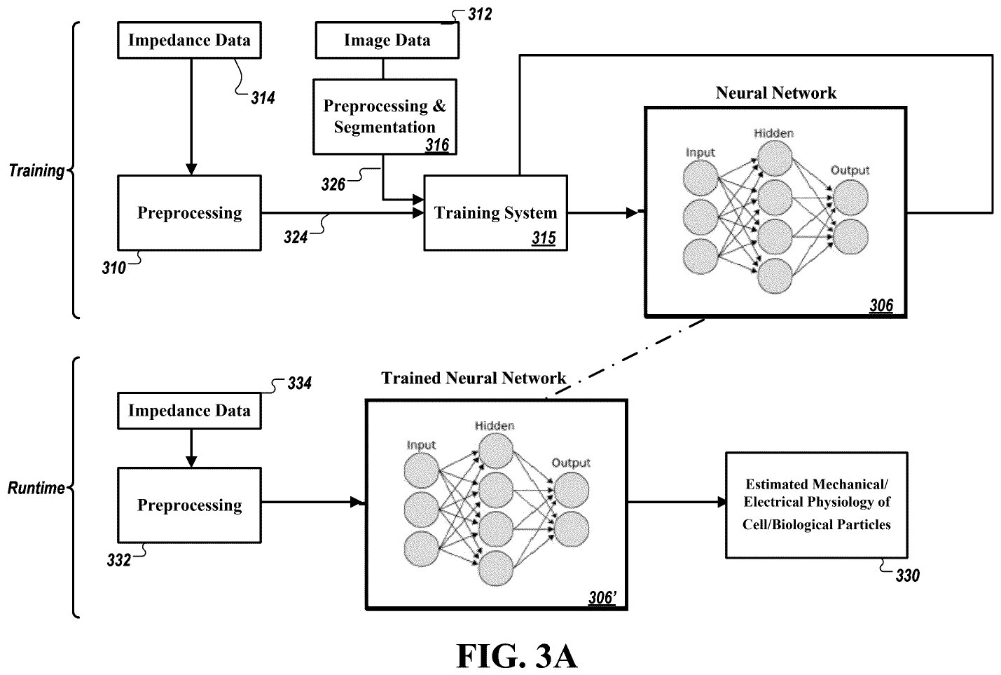

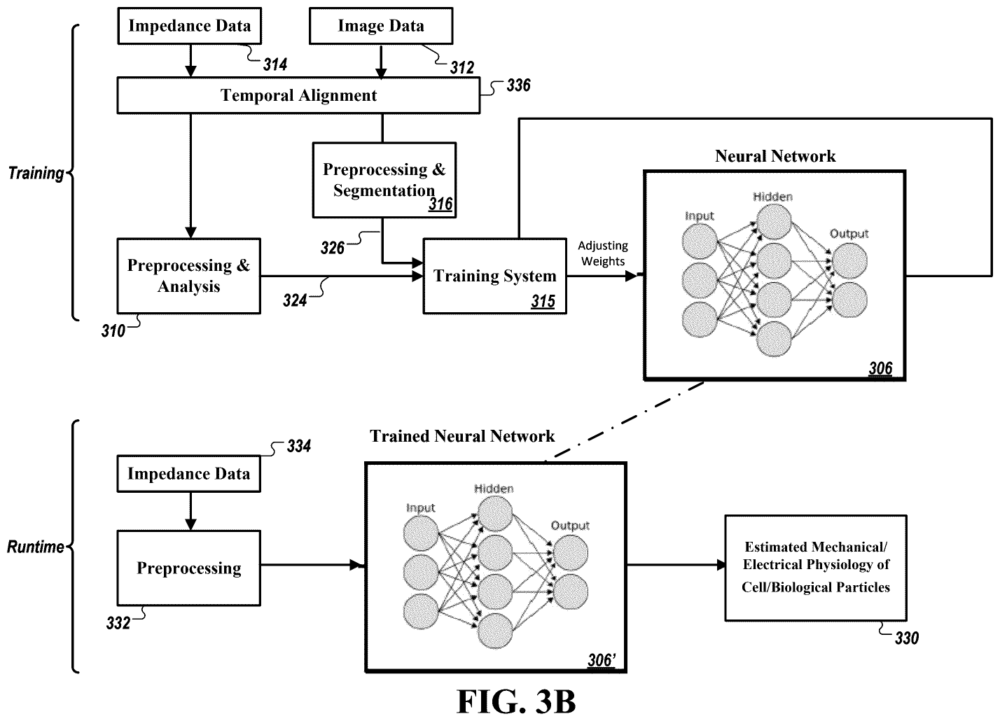

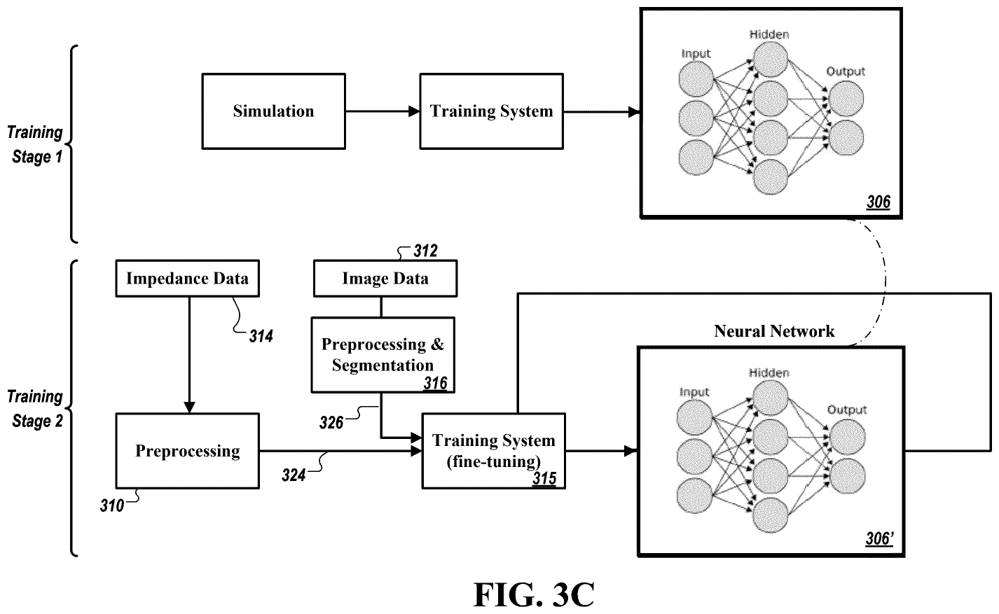

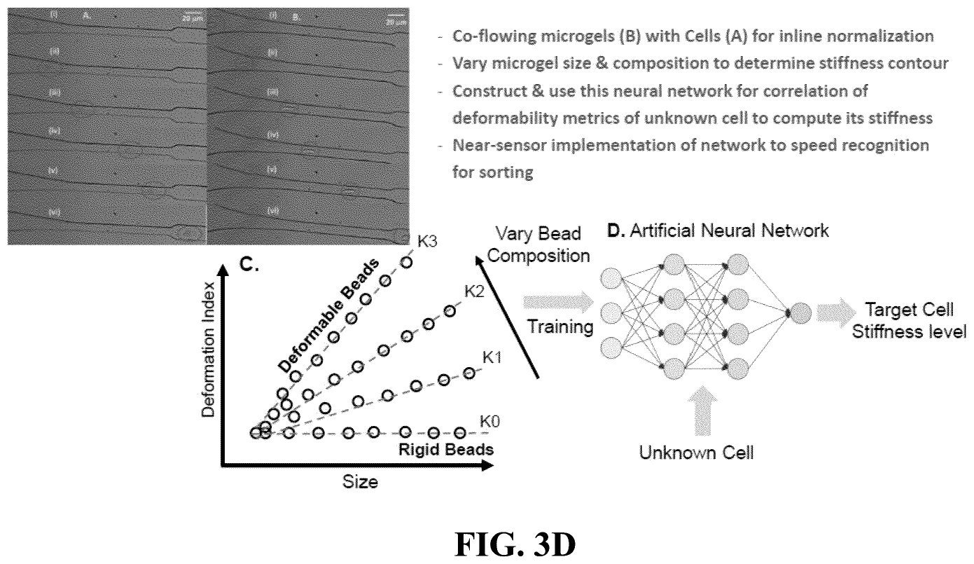

FIGS. 3A-3D each shows the training of a neural network 306 (e.g., 140, 146) for classifying cells based on impedance signal data. In FIG. 3A, the neural network 306 is trained using a training data set including a sequence of image cytometry data 312 corresponding to images, or associated data, of a set of cells flowing in viscoelastic extensional flow along a flow path of a microfluidic channel (e.g., another device used for training) through a contoured constriction region. The image data 312 is subjected to a preprocessing and segmentation operation 316 to extract one or more mechanical properties 326 (e.g., size and anisotropic index) of the cell. Corresponding impedance signal data 314 (e.g., impedance signal training set) is provided and subjected to a preprocessing and analysis operation 310 to extract one or more impedance metrics 324 (e.g., opacity and magnitude).

In some embodiments, the impedance measurement used to estimate the estimated mechanical property/electrical physiology of the cell is provided at low frequency (˜0.5 MHz). The system can, for example, apply up to 8 simultaneous frequencies (0.0-50 MHz), with higher frequencies allowing for greater field penetration to provide intracellular information. For instance, FIG. 17 shows how a frequency response that is used to discern nucleus to cell sizes of the respective lymphoma cell types and FIG. 19 shows each of the metrics (impedance frequency response, cell deformation and cell recovery or relaxation from deformation) being used to enhance the classification of the respective lymphoma cell types. In some embodiments, the impedance frequency response can provide information on cell deformation or mechanical property of the cell/particle as well as electrical physiology of the cell (membrane capacitance, cytoplasmic conductivity and nucleus to cell size).

In FIG. 3B, the image cytometry data 312 and the impedance signal data 314 can be temporally synchronized, via a temporal alignment module 336 (e.g., via a cross-correlation approach) to ensure accurate temporal alignment of the two data streams. By way of illustrative example, a cross-correlation function: C[k]=Σₙ Tᵢₘₚ [n]T_{img} [n−k] can be used to align the signal trains (i.e., the impedance (Tᵢₘₚ) and image (T_{img}) data streams) corresponding to trains of events obtained through event detection. Based on the position of the maximum value of the cross-correlation, a time-shift factor can be determined to synchronize impedance and image data. In some aspects, the image cytometry data 312 includes one or more morphological parameters derived from segmented optical images. In some aspects, the one or more morphological parameters comprise one or more of cell size, centroid eccentricity, circularity, and/or anisotropic index. In some aspects, the impedance signal data comprises one or more of electrical size, transit time, amplitude values for impedance magnitude and phase at specific frequencies, or a composite metric.

The neural network 306 is subject to a training operation 315 based on the one or more impedance metrics 324 and the corresponding one or more mechanical properties 326 of the cell to provide the trained neural network 306′. The training operation 315 in the provided example is configured to employ conventional operations, e.g., according to a multilayer perceptron based neural network (MLPNN), e.g., employing gradient descent and various normalization operations, and thus are not further described herein. Other training operations may also be employed.

During operation, impedance signal data 334 is subjected to preprocessing 332 to extract one or more impedance metrics 336, which are provided as inputs to the trained neural network 306′ to predict/determine an estimated mechanical property of the cell 330. In some aspects, the trained neural network 306′ is configured to determine an estimated mechanical property corresponding to an electrical anisotropy index of the cell based on normalization against co-flowing microgel beads of known stiffness.

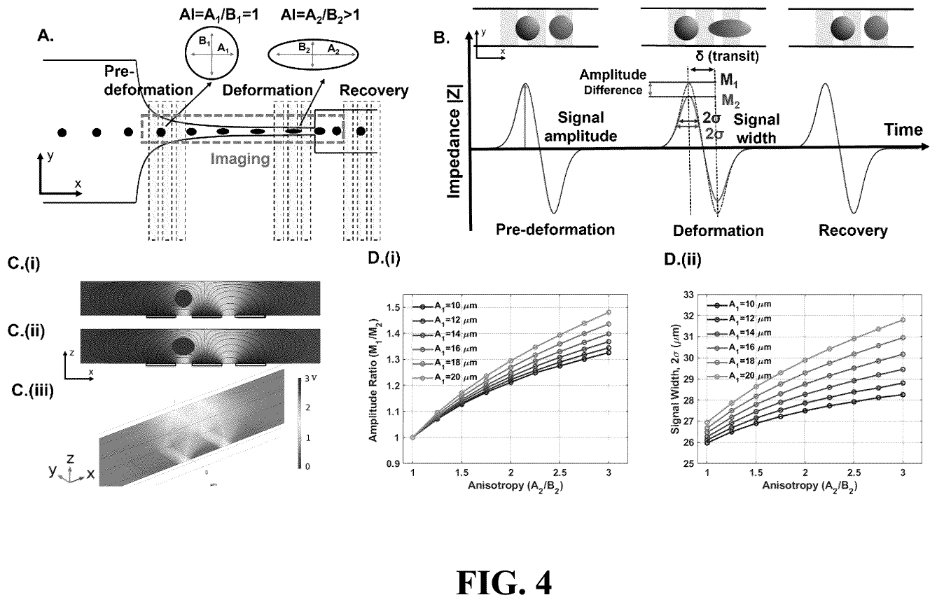

Simulation-based training. In FIG. 3C, the neural network 306 is first trained using simulation data of electric field (e.g., FIG. 4) and corresponding simulated impedance measurement. The system then uses a training data set including a sequence of image cytometry data 312 corresponding to images, or associated data, of a set of cells flowing in viscoelastic extensional flow along a flow path of a microfluidic channel (e.g., another device used for training) through a contoured constriction region to provide training data to fine tune the neural network 306 (shown as 306′). The image data 312 may be similarly subjected to a preprocessing and segmentation operation 316 to extract one or more mechanical properties 326 (e.g., size and anisotropic index) of the cell. Corresponding impedance signal data 314 (e.g., impedance signal training set) is provided and subjected to a preprocessing and analysis operation 310 to extract one or more impedance metrics 324 (e.g., opacity and magnitude).

Normalization of Mechanical Metrics. In FIG. 3D, the neural network 306 is first trained using phantom data of electric field measured from calibrated phantoms subjected to different viscoelastic flow and constriction to provide normalization of mechanical metrics. In FIG. 3D, co-flowing microgels with cells are measured where the microgels having varying but known microgel size and composition. The flow provide known stiffness contours in combination with electric field/impedance measurements. The trained AI model can learn the correlation of deformability metrics to estimate stiffness (during inference operation). Near-sensor implementation (e.g., via impedance electrodes) can provide measurements for high-speed recognition operation, e.g., for sorting. Examples of sorting configurations are shown in FIGS. 11A, 11B, 11C, and FIG. 31.

The trained AI model (e.g., 306 or 306′) of FIGS. 3A-3D, via the training, can distinguish the biomechanical differences between cells and using them to differentiate cell subpopulations and cell types, e.g., of minute differences such as epithelial versus mesenchymal cells, activated versus non activated immune cells, stem cells of lineage A versus B (which can be more difficult to differentiate using chemical markers). In some aspects, cells are classified into subpopulations based on mesenchymal and non-mesenchymal expression.

AI-based characterization of cells using impedance measurements facilitate high-throughput measurements that are beneficial for real-time analysis. Because cells or particles of interest may be present at one in 1000 or 10,000, the decision whether to activate the sorting of those cells may be in a very short time frame due to the speed to the flow to accommodate the population size. Camera-based sorting while effective would need to have high focus over a large region and powerful image analysis capability to provide comparable functionality. Electrical impedance measurements (e.g., based on magnitude and phase) in combination with mechanotransduction can provide for high throughput and effective sorting and characterization that avoid expensive high-end imaging systems.

Machine Learning. In addition to the machine learning features described above, the various analysis systems can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an ANN is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

Other classifiers may be used, e.g., Random Forest classifier, Genetic Algorithm classifier, among others.

### EXPERIMENTAL RESULTS AND ADDITIONAL EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

### Example 1

A study was conducted to develop and evaluate use of impedance measurements and AI/ML for rapid inline extraction of cellular biophysical metrics from single-cell signal trains to quantify cell deformability and electrical physiology, as well as utilize this information to activate sorting. Wide cell size distributions within typical samples can make it challenging to attribute the alterations in impedance metrics to deformed cell anisotropies vs. to cell size variations. The study employed simulated data obtained from electric field screening in the microfluidic device as well as a fitting method and a neural network model to learn the non-linear relationships between the single-cell impedance signal amplitudes and widths in the pre-deformed, deformed and recovery regions for cell deformation under viscoelastic extensional flow. The study derived a composite impedance metric for measuring deformed cell shape over a wide range of anisotropies (1-3-fold) and with minimal errors from their wide cell size distribution (10-25 μm). The composite metric was then implemented with impedance signal trained from experimental data of cells deformed under viscoelastic hyperbolic extensional flows and trained with image anisotropy data on corresponding cells using a multilayer perceptron neural network to enable computation of a net electrical anisotropy index or EAI that exhibits equivalent sensitivities to image cytometry data after gating in live cell events only, as validated with pancreatic cancer cells and cancer associated fibroblasts. The study employed the MLP network for training with image data to improve the accuracy for cell shape anisotropy quantification by impedance signal templating, since this network reduces computational time and enables near-sensor signal analysis for near real-time extraction of cell metrics to activate downstream sorting.

It was observed that coupling the impedance signal amplitudes, widths, and transit times of cells in pre-deformation, deformation and recovery regions of the extension flow, as obtained by the net electrical anisotropy index offered improved distinction ability between cell phenotypes of wide size distributions (10-25 μm), with cell shape recovery after deformation possibly offering information on the cytoskeleton viscosity [57]. The study also observed that electrical physiology based on impedance frequency response (|Z|, φZ at 0.5 and 18 MHz) can offer orthogonal metrics for identification of cell phenotype. For instance, the inclusion of apoptotic with live cancer cell events broadens their deformability distributions to limit their distinction, leading the study to gate in live cell events for improving phenotypic distinction. The study also observed that EAI metric can distinguish the higher deformability of CAFs vs. cancer cells, and its application in conjunction with electrical physiology information from impedance frequency response on the same cell can improve SVM-based classification, with performance parameters for the combined electrical metrics that are on par with the combined image metrics after gating in live cell events. The SVM model [58], which can be extended for multi-class classification by using approaches such as “one-vs-one” or “one-vs-all”, was employed as it worked well with smaller datasets to find the optimal separating hyperplane between classes, rather than classification methods that are better suited to larger datasets, which require more intensive computation. The study confirmed that neural network-based control can provide rapid impedance signal templating and the assessment of specificity of the impedance frequency response to cell viability and interior structure. The study observed that the image-based training method can improve accuracy of cell deformability quantification and combined with multiparametric electrical physiology information for near real-time extraction of biophysical metrics to activate sorting of rare cell subpopulations with unknown phenotypes.

Background. The phenotypic heterogeneity of cancer, immune and stem cell systems [1] that exhibit subpopulations to serve their multiple functions [2], highlights the need for tools capable of quantifying and separating such subpopulations [3]. Cell surface markers enable phenotypic quantification by flow cytometry after binding to fluorescently labeled antibodies. However, markers are not available for many cell phenotypes, while the sample preparation steps are time consuming, require costly chemicals, introduce a degree of selection bias, and can adversely affect maintenance of cell viability within longitudinal studies [4]. Cellular biophysical properties [5], such as their size distribution, deformability, membrane morphology, and nucleus to cell size are correlated in many contexts to cell function. Since they do not require labeling, they present a complementary set of metrics to identify and separate live cell subpopulations, with minimal sample preparation. Biomechanical properties of cancer cells are particularly of interest for identifying metastatic subpopulations [6], since the early-stage in the metastasis of solid tumors is associated with stiffening of the tumor microenvironment (TME) [7], which is detected by cell mechano-sensing pathways [8] to cause systematic alterations in cellular deformability [9]. Hence, these metrics can potentially be used to identify and sort metastatic cells for targeting the screening of drugs that inhibit metastasis [10]. This is especially relevant in pancreatic cancer (from pancreatic ductal adenocarcinoma or PDAC) that is the third leading cause of cancer deaths [11], due to its propensity for tumor metastasis [12]. Mechanical properties are essential to PDAC cell metastasis due to its highly fibrotic and poorly vascularized TME.

Contactless single-cell deformability cytometry is often conducted under microfluidic viscoelastic flows that cause shear [14], extensional or compressive forces [16], using high-speed imaging to measure alterations in cell anisotropy [17,18,19]. While high-speed imaging provides accurate spatial information on cells, it is not well-associated with their functional attributes, such as cell viability. Furthermore, due to the size, interior shape, and compositional diversity of cellular subpopulations, it is challenging to acquire focused single-cell images at high throughput for quantification of cell deformability. Hence, extensive image reconstruction is required [20,21], which is often conducted offline, thereby limiting its utilization in near real-time to activate sorting [22]. Impedance cytometry for single-cell biophysical analysis [23,24,25] has been associated with cell function within many contexts, such as immune cell activation [26,27], red blood cell infection [28,29], cell health [30], classification of apoptotic states of cancer cells [31], altered nucleus to cell size to monitor stem cell cycle characteristics [33], and cancer cell subpopulations after co-culture with associated fibroblasts [34]. Prior work on deformability-based classification by impedance analysis has used constrictions to cause cell deformation [35], [36], which is limited by the broad cell size distributions in typical samples and the associated clogging that limits throughput. Viscoelastic crossflows address this limitation [37], but the cell deformation is instantaneous and the dynamic range for anisotropy modulation is limited, which motivates this work on impedance cytometry under hyperbolic extensional flows for contactless and progressive single-cell deformation to high shape anisotropies (˜3-fold). Furthermore, unlike 2D image information that requires extensive signal processing, 1D temporal impedance signals exhibit characteristic shapes that can be rapidly templated using neural networks to extract single-cell metrics [39], [40], such as size, anisotropy, velocity, membrane capacitance and cytoplasmic conductivity for enabling high throughput biophysical measurement and selection.

In the study, using viscoelastic hyperbolic extensional flows [41], [42], that cause high throughput (˜100 cells/s at 1-2×10⁶ cells/mL), contactless and clog-free cell focusing, spacing and successively greater cell deformation over the extensional flow length [44], the shape anisotropy of pancreatic cancer cells and cancer associated fibroblasts (CAFs) are measured by impedance and image cytometry over their wide cell size distributions. While neural networks have been used on thresholded impedance signals to identify relationships between cellular biophysical metrics [45,46] one unique aspect is the utilization of a multilayer perceptron (MLP) neural network for processing raw impedance signals of diverse shapes after its training with image cytometry data from the same cell for accurate and rapid signal templating to quantify cell deformability. The interrelationship between impedance signal metrics for quantifying cell shape anisotropy under microfluidic deformation is first elucidated using simulations of electric field screening and then optimized using the MLP network to fit measured impedance data, alongside training of the network with image cytometry data from the same cell to extract a net electrical anisotropy index (EAI) that quantifies cell deformability over a wide range of anisotropies (1-3-fold) and with minimal errors from their wide size distributions (10-25 μm), as validated against image metrics using cancer cells and CAFs. Since cellular electrical physiology from the impedance frequency response of its magnitude (|Z|) and phase (φZ) offers orthogonal metrics for cell phenotypic recognition based on apoptosis, membrane folding and interior structure, the EAI metric is applied in a multiparametric manner with cell electrical physiology using the support vector machine (SVM) model to distinguish live cancer cells vs. CAFs derived from the same metastatic patient. This is significant for identifying drug resistant cancer cell subpopulations that arise due to interaction with CAFs under drug treatment [47], [48]. Given the potential of neural networks for rapid impedance signal templating and specificity of impedance spectra to cell phenotypes [40], the study advances its coupling with image data for the accurate extraction of cellular biophysical metrics in a multiparametric manner to activate sorting for isolation of rare cell subpopulations from dilute samples with unknown phenotypes [49].

### Results

Dependence of cell anisotropy measurement under deformation on cell size. Clinically relevant samples of cancer [50], immune and stem cells that exhibit phenotypic plasticity show wide cell size distributions (10-25 μm), which makes it challenging to measure cell biomechanical metrics in microchannels [52]. To illustrate the effect of cell size distributions on impedance metrics for measurement of deformation-induced cell anisotropy alterations over a wide range (1-3-fold), the study used electric field simulations to obtain impedance signals. This is simulated based on sets of coplanar electrodes that are patterned at the floor of the pre-deformation, deformation and recovery zones of a microfluidic hyperbolic extensional flow to create progressively higher levels of deformation along its length (FIG. 4, Panel A), with sufficient length available for single-cell correspondence to imaging cytometry. Since impedance signal trains show a typical bipolar signal shape under differential amplification, the study focused on the metrics of signal amplitude and width in the respective zones (FIG. 4, Panel B). It is noteworthy that the utilization of viscoelastic flows (2% poly-ethylene-oxide or PEO with 1× phosphate buffered saline or PBS) enables elasto-inertial particle focusing across the microchannel cross-sectional depth [53], thereby minimizing positional dependence for measurement by coplanar electrodes. This is apparent from the widely dispersed multiple data clusters of impedance phase vs. particle size in 1×PBS that become narrow single data clusters corresponding to 12 μm and 15 μm particles. Using electric field screening simulations (FIG. 4, Panel C) of model spherical particles with a unitary image-based anisotropy index or AI in the pre-deformation zone (i.e., A₁=B₁), a relatively higher anisotropy index at the end of the deformation zone (AI=A₂/B₂>1) and returning to unity in the recovery zone, the simulated impedance signal amplitude (M₁, M₂ in FIG. 4, Panel D(i)) and signal width (2σ levels in FIG. 4, Panel D(ii)) were plotted as a function of varying anisotropies (1-3-fold) and over wide cell size distributions (10-20 μm). While the metrics of signal amplitude ratio and width increase as expected with particle anisotropy, their strong dependence on particle size is apparent, making it challenging to attribute the alterations in their metrics to anisotropy ratios vs. to particle sizes. Hence, fitting methods were subsequently utilized on simulation data to identify functions of the respective impedance metrics that reduce the error from the wide cell size distributions and then optimize this approach using neural network-based signal templating on simulated and experimental data.

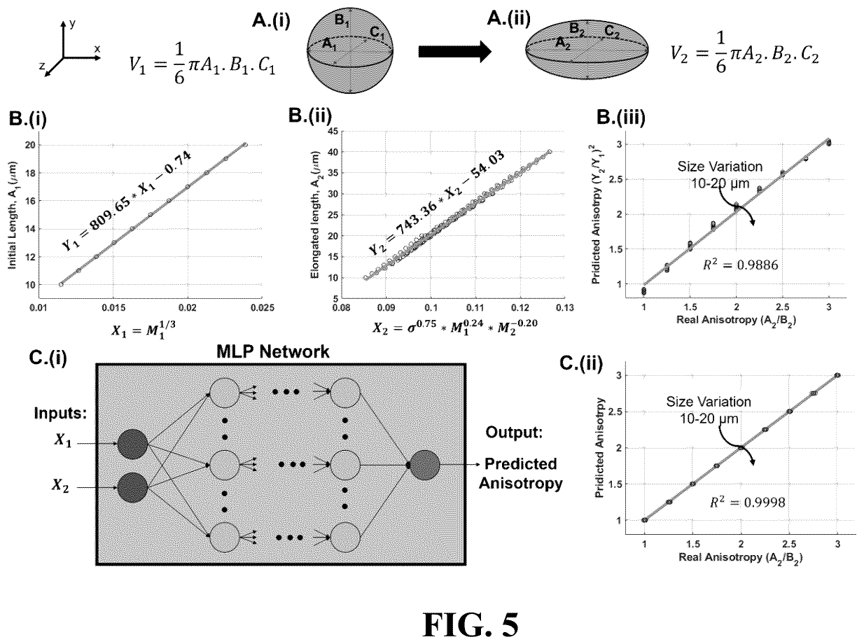

Electrical anisotropy metric for deformation under wide cell size distributions. The study sought to develop a composite metric for transducing deformed cell shape anisotropy over a wide range (1-3-fold), with minimal errors from the wide cell size distributions observed in typical biological samples. For particle dimensions of A, B, and C along the channel length (x-axis), width (y-axis), and depth (z-axis) that start out as spherical within the pre-deformation zone (FIG. 5, Panel A(i)) and become ellipsoidal in the deformation zone (FIG. 5, Panel A(ii)), it was assumed that its projected area in the xy plane (i.e., π/4 AB) and its volume do not change during deformation (i.e., volume conservation). This is justified based on the image cytometry results that show a linear plot of unity slope for the data clusters in the deformation zone (A₂B₂) vs. in the pre-deformation zone and vs. in the recovery zone. Plots of the ratio of A₁B₁ to A₂B₂, and that of A₃B₃ to A₂B₂ yield a linear data cluster of zero slope that is centered at unity. Hence, combining the volume conservation assumption (Eq. (1)) with observations on the ratio of the product of A and B in the respective deformation zones (Eq. (2)), it was possible to infer that all particle deformations occur only along the channel length and width, with minimal alterations along the depth (Eq. (3)). Recalling that A₁=B₁, the anisotropy index (AI that depends on particle length to width ratios in the deformation zone) can be rewritten solely in terms of particle length, per Eq. (4).

$${A}_{1} \cdot {B}_{1} \cdot {C}_{1} = {A}_{2} \cdot {B}_{2} \cdot {C}_{2} = {A}_{3} \cdot {B}_{3} \cdot {C}_{3} \qquad Eq . ( 1 )$$

$$\frac{{A}_{1} \cdot {B}_{1}}{{A}_{2} \cdot {B}_{2}} = 1 \& \frac{{A}_{3} \cdot {B}_{3}}{{A}_{2} \cdot {B}_{2}} = 1 \qquad Eq . ( 2 )$$

$$⇒ {C}_{1} = {C}_{2} = {C}_{3} \qquad Eq . ( 3 )$$

$$AI = \frac{{A}_{2}}{{B}_{2}} ⇒ AI = {( \frac{{A}_{2}}{{A}_{1}} )}^{2} \qquad Eq . ( 4 )$$

To compute a composite metric for the particle shape anisotropy under deformation, with minimal errors from particle size variations, the study started with computing a fitting function between the elongated particle length (A₂), using exponentials of impedance signal amplitudes (M₁, M₂) and width (2σ) to fit impedance signal simulations (FIG. 5, Panel B), and then generalize this approach using a multilayer perceptron (MLP) neural network that is optimized for fitting. From other work, it is known that the initial particle length in the pre-deformation zone (A₁) exhibits a cube-root dependence on impedance magnitude (i.e. M₁^{1/3}), per Eq. (5), to obtain a fitted linear plot in FIG. 5, Panel B(i). Using the logarithmic regression method to find the non-linear relationship between impedance signal parameters in the pre-deformation and deformation zones, a relationship between signal amplitudes (M₁ and M₂), width (2σ) and particle length (A₂) in the respective zones can be written per Eq. (6), which can also be computed as a fitted linear plot in FIG. 5, Panel B(ii) to reduce errors from size variations (FIG. 5, Panel B(iii)).

$${A}_{1} \sim {Y}_{1} = {m}_{1} {X}_{1} + {c}_{1} ; wherein : {X}_{1} = {M}_{1}^{1 / 3} \qquad Eq . ( 5 )$$

$${A}_{2} \sim {Y}_{2} = {m}_{2} {X}_{2} + {c}_{2} ; wherein : {X}_{2} = ( {σ}^{0.75} * {M}_{1}^{0.24} * {M}_{2}^{- 0.2} ) \qquad Eq . ( 6 )$$

A more generalized approach can be followed by using a multilayer perceptron (MLP) neural network that is optimized for fitting such functions (FIG. 5, Panel C(i)). Using inputs of the X-axes from the plots in FIGS. 5, Panel B(i) and 2, Panel B(ii), the output of predicted anisotropies is computed based on simulated and experimental data. In fact, the utilization of signal amplitude and width metrics is essential for obtaining higher R2 values than using signal amplitude metrics only. In this manner, the composite metric determined using the MLP network can predict the anisotropy over a wide range (1-3-fold), with minimal dependence on cell sizes (FIG. 5, Panel C(ii)). While the fitting method (FIG. 5, Panel B) is limited when the relationship between (Y₂/Y₁)² and the cell shape anisotropy deviates from a linear model, the MLP network (FIG. 5, Panel C) can learn the non-linear relationship between the inputs and output using multiple hidden layers, using a non-linear activation function, thereby achieving a higher R2 value, due to its inherent complexity and flexibility.

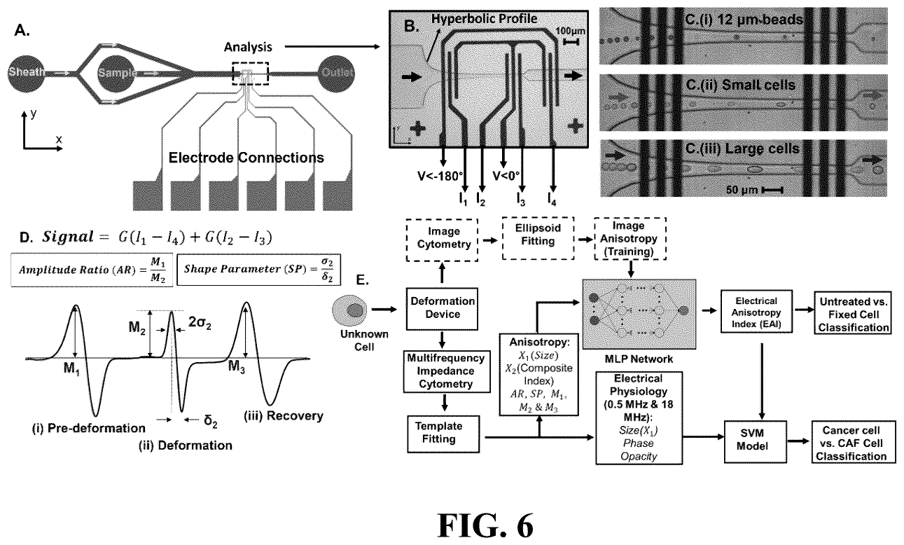

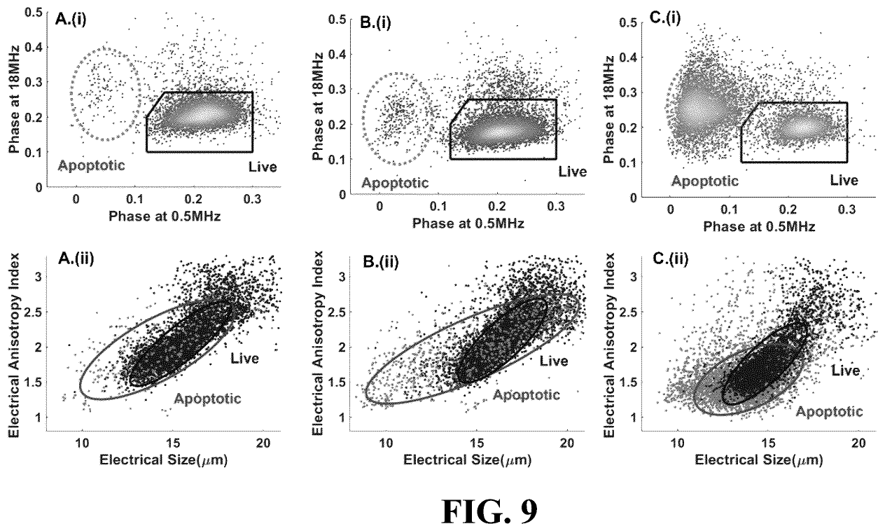

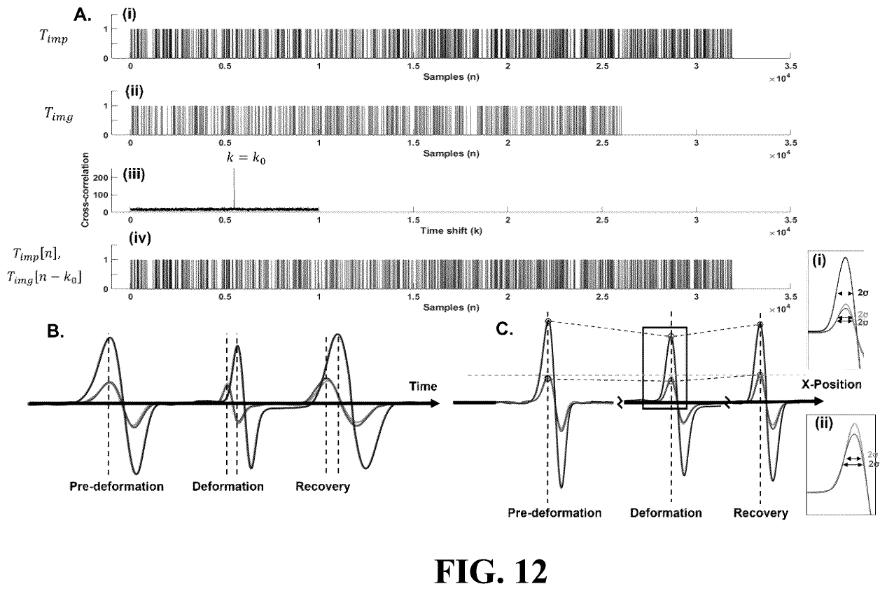

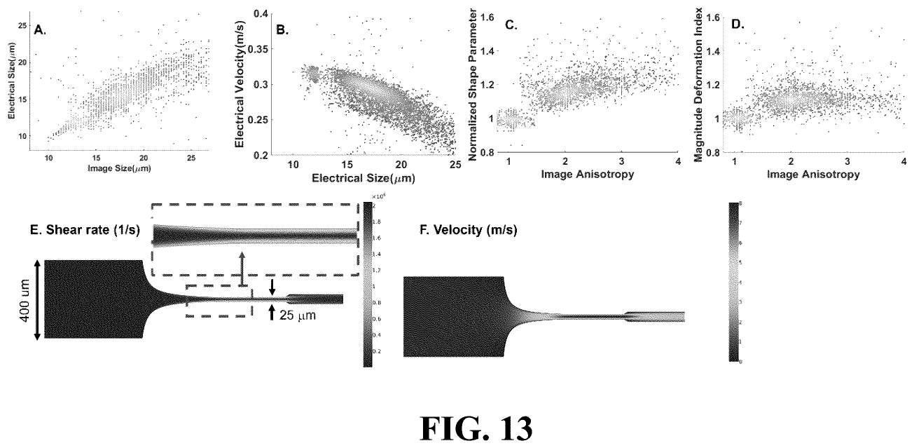

Electrical anisotropy index of deformability by coupling with image metrics. Using the MLP neural network, the impedance-based anisotropy determined from the input of composite metrics (X₁ from FIG. 5, Panel B(i) and X₂ from FIG. 5, Panel B(i)) is coupled with the image anisotropy index (AI of FIG. 4, Panel A computed by fitting an ellipse to calculate A and B in each zone) from cytometry data with single-cell correspondence between the respective metrics, to derive a net electrical anisotropy index (EAI) for deformability. This is implemented using a microfluidic chip (FIG. 6, Panels A-B) with sheath and sample flows that lead to a hyperbolic profile for measurement of cell shape anisotropy under viscoelastic extensional flow using single-cell impedance and image cytometry of corresponding cells. The analysis region under hyperbolic extensional flow (FIG. 6, Panel B) shows the voltage application and current measurement points in the pre-deformation, deformation, and recovery zones. Image acquisition occurs over the pre-deformation to the recovery zones (per dashed box in FIG. 4, Panel A), with cross-correlation of image and impedance signal trains used for data synchronization (FIG. 12, Panel A). Typical image cytometry results (FIG. 6, Panel C) are indicated as time-lapse measurements of non-deformable 12 μm polystyrene beads (green), equivalently sized small cancer cells (red) and larger sized (˜20 μm) cancer cells (blue) in the respective zones. The impedance signal measured at 0.5 MHz from currents: I₁, I₂, I₃ and I₄, is shown in FIG. 6, Panel D for particles in the pre-deformation, deformation, and recovery zones, alongside their respective signal metrics of amplitudes (M₁, M₂, M₃), signal widths (2σ₁, 2σ₂, 2σ₃) and transit times (δ₁, δ₂, δ₃). Since the cell electrical size is proportional to image size over the cell size distribution in the sample and the cell velocity determined from impedance signals decreases with cell size (FIG. 13, Panel B, per velocity profile simulations, the impedance signal trains can be aligned by velocity normalization to convert them from time domain (FIG. 12, Panel B) to position domain, along the length or X-axis. In this manner, signal templating can extract the respective signal metrics based on the amplitude ratios (AR=M₁/M₂) and shape parameters (SP=σ₂/δ₂) for neural network-based implementation after training with image metrics (including back to spherical shape in recovery zone), for computing the EAI to measure cell shape anisotropy (FIG. 6, Panel E) for deformability-based distinction (e.g., untreated vs. fixed cells). For image-based classification using the SVM model (e.g., cancer cells vs. CAFs), the metrics of single-cell size and anisotropy (A and B per FIG. 4, Panel A) were used. However, due to presence of some dead cells in typical cancer cell samples that broaden the deformability distributions (discussed later in FIG. 9), only live cells were gated in, using φZ metrics. For impedance-based classification, the neural network derived EAI was used for deformability and combined with electrical physiology from the impedance frequency response (size or

$$\sqrt[3]{{\vert Z \vert}_{05 MHz}} ;$$

Z_{0.5 MHz} & φZ_{18 MHz}; and magnitude opacity or |Z|_{18 MHz}/|Z|_{0.5 MHz}) for distinction based on cell viability and interior structure.

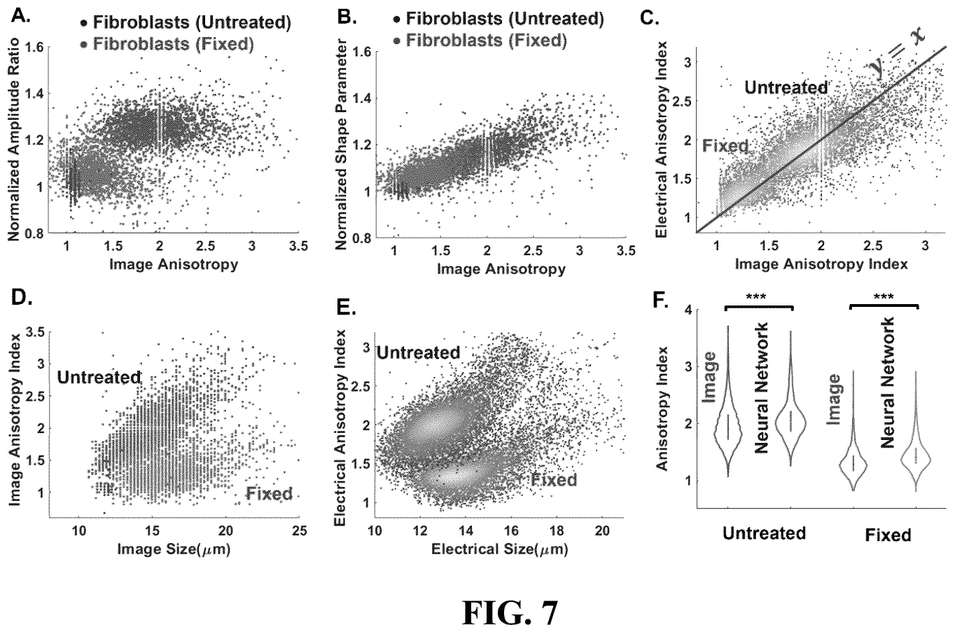

Validation of deformed electrical anisotropy index vs. image metrics. The net electrical anisotropy index (EAI) under hyperbolic extensional flow deformation obtained from the neural network is validated against image-based anisotropy metrics using cancer associated fibroblasts (CAFs) obtained from a metastatic patient-derived tumor (T608)⁵⁵, measured in untreated and fixed states. It is apparent from FIG. 7, Panel A that the metric of impedance signal amplitude ratio distinguishes untreated vs. fixed fibroblasts, but the signal plateaus off at higher image anisotropy levels, whereas the impedance signal shape metric rises linearly with image anisotropy over the entire measured range (FIG. 7, Panel B). The neural network-based electrical anisotropy index (EAI) after training with image metrics is able to obtain near-equivalent cell anisotropy levels, as apparent from the unity slope of the comparison plot in FIG. 7, Panel C (R²=0.9). Per the image cytometry results (FIG. 7, Panel D), fibroblasts shows a broad size range (˜11-18 μm) and exhibit a broad range of cell shape anisotropies under hyperbolic extensional flow deformation (1-3-fold) in the untreated state, while fixed cells show only a mild increase in cell shape anisotropy. The cell shape anisotropy measured from the respective impedance signals after neural network templating to extract the composite metric shows a similar trend (FIG. 7, Panel E), as summarized in the violin plot of FIG. 7, Panel F. Impedance metrics are also able to measure cell anisotropy alterations from deformation to the recovery zones, based on similarity of their trends to image cytometry.

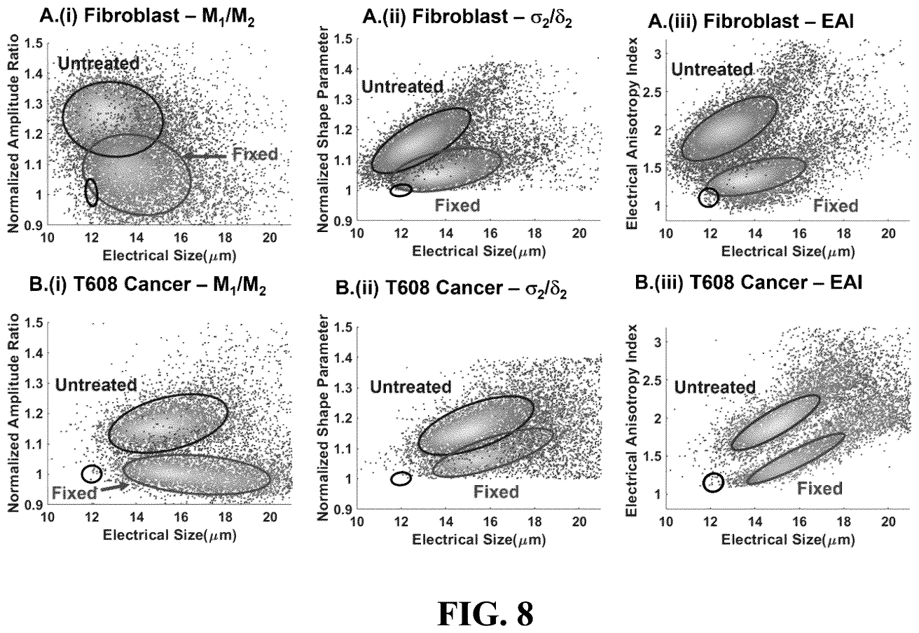

To illustrate merits of the respective deformability metrics based on the impedance amplitude ratio (M₁/M₂), shape parameter (σ₂/δ₂) and the neural network-derived EAI, the study compared data from CAFs (FIG. 8, Panel A) to cancer cells that exhibit even broader size distributions (12-21 μm in FIG. 8, Panel B). While the amplitude ratio metric does not exhibit the expected steady increase with cell size for fibroblasts (FIG. 8, Panel A(i)) and cancer cells (FIG. 8, Panel B(i)), as expected from simulations FIG. 4, Panel D(i), this trend is apparent for the shape parameter (FIG. 8, Panel A(ii)) and the EAI metrics (FIG. 8, Panel A(iii), as expected from the simulations (FIG. 4, Panel D(ii)), thereby improving distinction of the untreated vs. fixed cell populations for fibroblasts (FIG. 8, Panel A(ii)) and cancer cells (FIG. 8, Panel B(ii)). The respective cell populations exhibit a further improvement in distinction based on the neural network-derived EAI that shows a wider range of anisotropics, resembling the data from image metrics for fibroblasts (FIG. 8, Panel A(iii)) and cancer cells (FIG. 8, Panel B(iii)).

Combining deformability and electrical physiology metrics for cell distinction. Electrical physiology from the impedance frequency response (electrical size or

$$\sqrt[3]{{\vert Z \vert}_{05 MHz}} ;$$

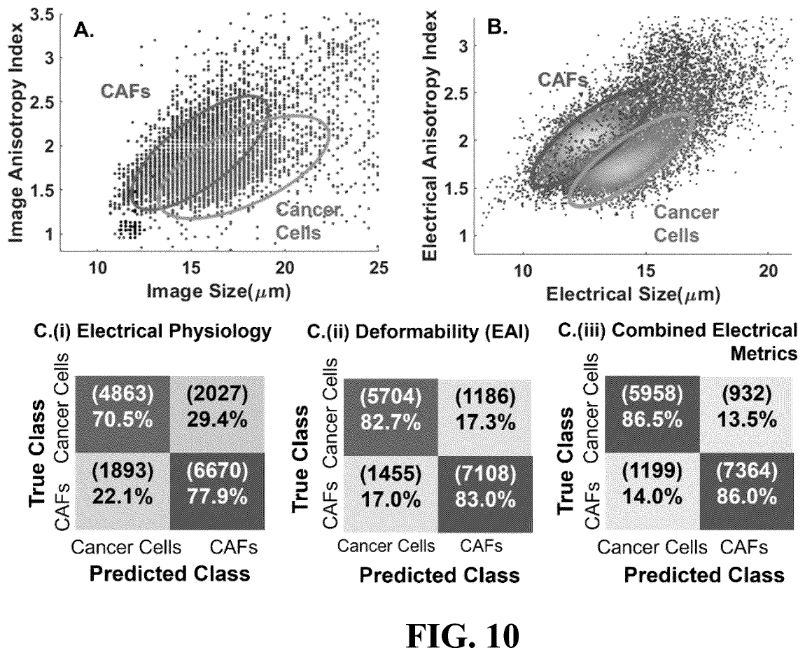

impedance phase or φZ_{0.5 MHz} & φZ_{18 MHz}; and magnitude opacity or |Z|_{18 MHz}/|Z|_{0.5 MHz}) can provide an orthogonal set of metrics for identifying cellular phenotype that is often not reflected within their deformability properties (e.g. EAI metric), thereby motivating the consideration of combination of these metrics for cell recognition using impedance cytometry. A prime example is cell viability, which is significant to detect for quantifying drug resistant subpopulations, since cultures of patient-derived cancer cells that are enlarged within xenograft models often exhibit a background of apoptotic cells in their untreated state, which further increases under drug-treatment. Work with pancreatic cancer cells has shown that the ratio of the impedance phase at low (φZ_{0.5 MHz}) to high frequency (φZ_{18 MHz}) can be used to quantify apoptotic cells [31], as validated by flow cytometry after staining for Annexin V, since these metrics are highly sensitive to alterations in dielectric polarization of the plasma membrane of apoptotic cells [56]. Using this metric, it was possible to infer that cell viability is not altered under viscoelastic extensional flows, since the number of non-viable cancer cells is unchanged between the pre-deformation, deformation and recovery regions. It is apparent that cancer cells in the untreated state include some apoptotic cells (FIG. 9, Panel A(i)), which substantially increase in their drug-treated state (FIG. 9, Panel B(i)) due to apoptotic cells released from their adherent culture (FIG. 9, Panel C(i)). Apoptotic cells, in general, show lower deformability (FIG. 9, Panels A(ii), B(ii) & C(ii)), but their wide size distribution broadens their cell deformability distribution. Hence, impedance phase metrics (φZ_{0.5 MHz} & φZ_{18 MHz}: per FIG. 9, Panels A(i), B(i) & C(i)) were used to gate in live cell events only, and exclude apoptotic events for SVM classification of cancer cells vs. CAFs based on image and impedance based metrics. For live cells, these impedance metrics also contain information on interior structure for distinction of pancreatic cancer cells vs. CAFs. At lower frequencies (0.5 MHz) wherein cell membrane induced field screening dominates the impedance response, CAFs exhibit lower electrical size and lower φZ in comparison to cancer cells, while CAFs exhibit higher magnitude opacity and φZ levels at higher frequencies (18 MHz), wherein electric fields pass through the cell interior. Using only live cells events, the image metric (FIG. 10, Panel A) and the EAI metric (FIG. 10, Panel B) can distinguish the higher deformability of CAFs vs. cancer cells. The SVM model classification results (FIG. 10, Panel C) with positive predictive values or PPV and negative predictive values or NPV show that the neural network-derived EAI metric performs better than the component impedance amplitude ratio and shape parameter metrics, and is comparable to the combined image metrics obtained after gating in live cells. The combined electrical metrics from the EAI and electrical physiology perform better than the EAI only, and the classification is on par with the combined image metrics used to train the neural network.

### Methods

Impedance signal simulations: The electric fields and currents were simulated by using COMSOL electric current module, using a rectangular channel design of 25 μm by 30 μm cross section, and three coplanar electrodes of 25 μm in width and 15 μm in spacing. A voltage signal of 3Vₚₚ at 0.5 MHz was applied to the middle electrode, while the voltage of the adjoining electrodes was maintained at ground level (0 V) for simulating the differential current. To simulate a deformable particle, a sphere was passed across the electrodes in the pre-deformed region, followed by the same measurement in the deformed region as an ellipse of same volume and diameter in the z-axis, but differing anisotropy in image plane (xy-plane). The generated signal was fitted to a bipolar Gaussian function to determine its peak amplitude and signal width in MATLAB (R2022a, MathWorks). Separately, the shear rate and velocity within the hyperbolic channel was modeled in COMSOL laminar flow module.

Device design and integration: The microfluidic device with a hyperbolic extensional flow profile (FIG. 6, Panels A-B) that constricts to 25 μm (>cell size) was fabricated by standard SU8 lithography (EVG 620) for PDMS micromolding and then aligned to gold electrodes that were patterned on a glass coverslip for bonding under an O₂ plasma (Tergeo Cleaner, PIE Scientific). A 3D printed holder was used to establish electrical contacts using a pogo pin assembly, with an open area to enable high speed imaging for image cytometry.

PDAC Cell Sample Preparation: PDAC tumor and CAFs samples from the anonymized patient, labeled MAD 08-608, were generated from remnant human tumor surgical pathology specimens in collaboration with the University of Virginia Biorepository and Tissue Research Facility. The protocol was approved through the University of Virginia Institutional Review Board (IRB) for Health Sciences Research (approval IRB-HSR number 13529), and as part of the protocol, informed written consent of each participant was obtained for utilization of the tissue samples in this research. The tumor was propagated orthotopically in the pancreata of immunocompromised mice, which was conducted in strict accordance with the Guide for the Care and Use of Laboratory Animals of the United States National Institutes of Health, per protocol 4078, approved by the Animal Care and Use Committee of the University of Virginia. The cells were transduced with firefly luciferase lentivirus (KeraFAST), selected using puromycin and maintained in RPMI 1640 with 10% FBS and 2 mM glutamine (complete medium), with fresh aliquots used for the reported experiments. For cell culture, cancer cells and CAFs were plated at an initial density of ˜500,000 cells per 6 well plate and maintained using a media containing Dulbecco's Modified Eagle Medium (DMEM, Thermo Fisher Scientific), 10% Fetal Bovine Serum (Thermo Fisher), and 1% penicillin streptomycin (Thermo Fisher). The respective samples of fixed cells were prepared by suspending cells in 4% methanol-free formaldehyde for 8 min, followed by addition of 0.127 M glycine for 5 min to terminate the fixation.

PDAC Cell Drug Treatment: PDAC T608 cancer cells in monoculture were exposed to 1 μg/mL of gemcitabine (University of Virginia clinical pharmacy) for 48 h in complete medium. This drug condition is known to drive the cells under monoculture towards apoptosis³¹. Untreated control samples were kept under the same culture conditions and period as treated samples, for comparative analysis. Cells were trypsinized and analyzed by flow cytometry after fluorescent staining, and by impedance cytometry. Cell culture media was aspirated and stored to recover floating cells. The remaining adherent cells were washed in 1×PBS (Thermo Fisher) and enzymatically detached from the plate using 0.05% trypsin in 1×PBS for 10 min at 37° C. The cells fractions were resuspended into a total volume of 5 mL DMEM with 10% FBS and 1% pen-strep (Thermo Fisher) and centrifuged at 300 g for 10 min. DMEM was then aspirated, and the cell pellet was resuspended in 1×PBS, 500 mM EDTA (Fisher Scientific), and 0.5% Bovine Serum Albumin (Sigma Aldrich) and filtered through a 100 μm cell strainer.

Measurement set-up for impedance and image cytometry: To measure cell deformation in the microfluidic device under hyperbolic extensional flow, cells (concentration of ˜1-2×10⁶/mL) with co-flowing polystyrene beads (12 μm at a concentration of ˜1.2×10⁵/mL) were suspended in 2% PEO solution and introduced via a syringe pump (neMESYS, Cetoni) into the sample inlet at a flow rate of 6 μL min⁻¹, accompanied by a sheath flow of 2% PEO solution at the same flow rate from the sheath inlet, per FIG. 6, Panel A. Single-cell impedance signals were measured at the pre-deformation, deformation, and recovery zones of the microfluidic channel using an impedance spectroscope (HF2IS, Zurich Instruments). In the deformation zone, the conventional differential measurement method was conducted by applying a voltage signal (at 0.5 MHz and 18 MHz, each with a magnitude of 3Vₚₚ) to the middle electrode and measuring the differential current from the side electrodes via a differential current amplifier (HF2TA, Zurich Instruments). Electrode wiring in the pre-deformation and recovery zones was adjusted to enable impedance measurement using fewer channels by using two voltage signals of equal magnitude and frequency, but with opposite phases (0 and) 180° that were applied to the side electrodes, with currents at the middle electrodes measured using the same differential current amplifier. The signals were recorded for subsequent processing.

Signal processing: The recorded impedance data were processed and analyzed utilizing MATLAB (R2022a, MathWorks). Initially, raw signals underwent filtering with a high pass filter to eliminate baseline and power line noise, along with a low pass filter for signal smoothing. Subsequently, a peak detection algorithm was implemented to identify events associated with cell passage through the electrodes. Each corresponding signal was then fitted to a bipolar Gaussian function to extract peak and signal width values across each zone (pre-deformation, deformation and recovery). Peak values were normalized against the mean peak value of 12 μm polystyrene beads, while signal width was normalized against particle transit time to determine the shape parameter that accounts for particle velocity. Following this, the shape parameter values were divided by the mean shape parameter of the 12 μm polystyrene beads. The amplitude and shape parameter values of the beads were scaled to unity. Typically, 6000-7200 events were detected over a 1-minute period in samples with 1-2×10⁶ cells/mL, giving a measurement throughput of ˜100-120 particles/s. Of these 6000-7200 events, ˜5% were discarded during signal processing because they were not well fitted by a bi-polar Gaussian (R-square<0.95), suggesting the occurrence of coincidences. The occurrence of coincidences depends on the expected number of particles in the sensing zone⁴⁴ (μ=cv, wherein c is the sample concentration and v is the sensing zone volume). Plots of coincidences as a function of the cell concentration are computed and measured, with the hyperbolic extensional flow spacing out coinciding events, which can be processed to improve their resolution [44].

Image processing: A Phantom S210 camera connected to the Eurosys frame grabber card was utilized to capture video images in bright field mode. The recording utilized a resolution of 1280 by 256 pixels, a frame rate of 4000 fps, and an exposure time of 10 μs. Subsequently, custom Python code was utilized to process the frames, involving the subtraction of each frame from the reference frame, followed by the application of a weighted average kernel filter to enhance image quality. An event detection algorithm was then applied to identify particles passing through the channel, alongside an edge detection algorithm to measure anisotropy, achieved by fitting ellipses around the particles. Synchronization of image events with the impedance signal trains was accomplished using the cross-correlation method to align impedance and image events.

Neural Network and Machine Learning Implementation: A Multilayer Perceptron (MLP) neural network, configured with 30 hidden layers was implemented in MATLAB to train the network using the impedance metrics of electrical size, amplitude values, and the composite index that includes signal widths. Supervised learning was utilized with image anisotropy data to predict the electrical anisotropy index. Initially, 70% of the dataset, comprising 7930 events corresponding untreated and fixed fibroblast and cancer cells, was allocated for training, while the remaining 30% was reserved for testing the network's performance. Subsequently, another data set containing impedance metrics was utilized to evaluate the network's performance. Following the MLP neural network training, a Support Vector Machine (SVM) was employed to classify fibroblast and cancer cells according to their impedance metrics and deformability indexes. The SVM classification model underwent training utilizing 70% of a dataset, randomly selected from approximately 8000 fibroblast cells and 7000 cancer cells, with the remaining portion reserved for testing model accuracy. Prediction accuracy was evaluated by comparing the percentage of true classes against the predicted classes in total events.

Statistical analysis: All data are presented as mean±standard deviation (SD). Outliers were removed by considering data points that were farther than ±3 SD from the mean. To compare differences between two groups, a two-sample t-test was performed using MATLAB. The test was two-sided, with an alpha value set at 0.05. P-values less than this threshold were considered statistically significant, with significance levels reported as *p≤0.05, ** p≤0.01, *** p≤0.001. Error bars between cell types indicate the standard deviation between sample triplicates, with shape anisotropy correlation of impedance to image cytometry computed based on R² values.

### Example #2: Multiparametric Single-Cell Biophysical Cytometry Under Tunable Viscoelastic Extensional Flows for Classification

A second study was conducted that evaluated and developed single-cell biophysical cytometry system under tunable viscoelastic extensional flows to modulate the geometry for cell deformation is utilized to correlate nuclear phenotypes (e.g., size, shape, Lamin A/C levels and 3D nuclear telomere organization) of clonally related lymphoma cells from the blood (Mac-1) and skin (Mac-2A and Mac-2B) to their deformability and cell migration characteristics, among others of cell characteristics.

Introduction. The mechanical, porosity and compositional characteristics of the tumor microenvironment cause systematic alterations in the biophysical properties of cancer cells [1′][2′], which can determine downstream cellular processes, such as their migration and survival [3′]. For cutaneous T cell lymphoma (CTCL) [4′], which is a debilitating incurable progressive disease, the skin microenvironment promotes rapid malignant CTCL expansion [5′], whereas their quiescent state in blood can improve the efficacy of therapies [5′]. Hence, creating the conditions to enhance confined migration of CTCL cells from skin to blood can likely improve the efficacy of current CTCL therapies [7′], especially Mogamulizumab and extracorporeal photopheresis. As the stiffest organelle in the cell, the nuclear size, shape, and envelope composition determines cell deformation for migration through pores in the microenvironment [8′][9′], while the viscous cytoplasmic components determine recovery as the cell relaxes between successive deformation events during migration [10′]. Mechanical regulators to modulate cellular properties for altering migration ability are emerging [11′] but need to account for the heterogeneity that arises from CTCL cells exhibiting diverse nuclear phenotypes, much like other lymphomas [12′]. Hence, single-cell tools to quantify the biophysical metrics of CTCL cells due to nuclear phenotypes are needed to optimize mechanical regulators of low heterogeneity for utilization with their expression level of skin homing and endothelial adhesion molecules to enhance CTCL migration to blood for improving the efficacy of therapies.

The measurement of cellular mechanical properties has conventionally been performed through micropipette aspiration [13′], atomic force microscopy [14′], parallel plate rheometry [15′] and optical [16′] or electrical stretching [17′] methods. In comparison, microfluidic deformability cytometry based on shear flow [18′], [19′] and extensional crossflow [20′], [21′] enables high throughput (˜500 cells/s), non-destructive and clog-free measurement at single-cell sensitivity for quantifying biomechanical heterogeneity to assist in classification [22′] and sorting [23′] of rare cell subpopulations. However, rather than cell deformation at a constant level under shear flow conditions only, or instantaneously at a single point in the channel under extensional crossflow, the utilization of viscoelastic flow^{24,25} within hyperbolic extensional channels [26′] enables the progressive modulation of cell deformation under shear and compression forces [27′]-[28′] through varying the channel geometry, flow rate and media viscosity [29′]-[30′]. In this manner, through measuring cell responses to different mechanical stimuli over time, a broader range of cell metrics can be used for phenotypic distinction based on the dynamics of single-cell deformation^{21,31}. While some reports distinguish cell type based on relative size of their nucleus, using deformability [25′] and impedance cytometry [32′], the distinction of cell types with diverse nuclear shapes and compositional variations is more challenging. Cell deformability measurements under alterations of nuclear structure using fluorescence methods are emerging [33′], but these require staining to identify nuclear envelope breakdown [34′] or radio frequency tagged emission under microfluidic shear flow [35′], which are challenging to implement at high cell velocities, highlighting the need for novel tools to distinguish cells of diverse nuclear phenotypes.

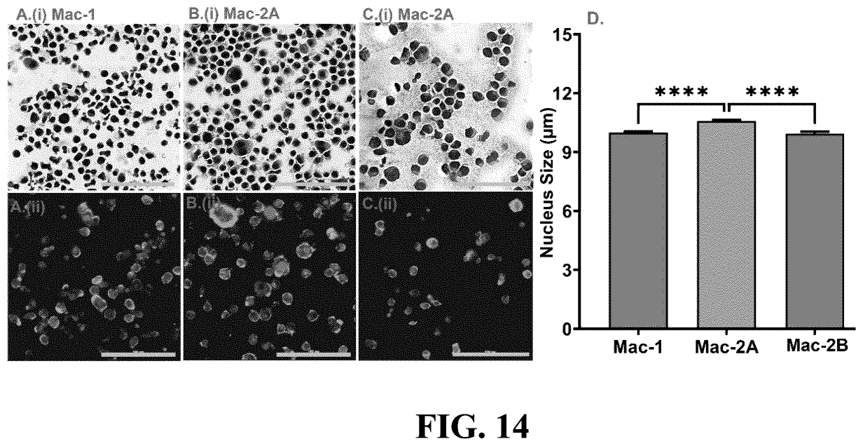

To advance platforms to measure cell deformation and recovery dynamics that can eventually be used to predict cell migration through confined spaces, the study presented a single-cell multimodal biophysical cytometry platform to distinguish CTCL cells based on differences in their nuclear phenotypes. A pneumatically actuated diaphragm is used to modulate their channel geometry for creating critical levels of deformation on a wider size range of cells by shear and compression under hyperbolic viscoelastic extensional flow, so that the coupling of cellular metrics from impedance, deformability and confined recovery measurements can be used to distinguish lymphoma cells that differ in their nuclear phenotypes. Measurements of differences in nuclear size (FIG. 14), nuclear shape, lamin A/C levels and telomere organization (FIG. 14) are performed on clonally related CTCL cells derived from the blood (Mac-1) and skin (Mac-2A and Mac-2B) [36′], which mimic the clinical disease conditions based on their resemblance to the malignant Sezary cells of CTCL (Mac-1) and the Reed-Sternberg cells of Hodgkin's disease [37′], [38′], [39′] (i.e., Mac-2A & Mac-2B). Using a pneumatically controlled diaphragm to modulate channel geometry, single-cell deformation under hyperbolic viscoelastic extensional flow is optimized to achieve shape anisotropies that enhance distinctions between the respective CTCL cell types (FIG. 16). This is applied in an integrated cytometry system to couple cellular metrics from impedance (FIG. 17), as well as deformation and recovery measurements (FIG. 18), to quantify the accuracy of CTCL cell type classification (FIG. 19). Principal component analysis and support vector machine (SVM) methods enable CTCL cell classification based on their nuclear shapes (Mac 1 versus Mac 2A and Mac 2B), and nuclear composition (Mac 2A versus Mac 2B). In this manner, the interplay of cellular biophysical characteristics correlated to nuclear phenotypes can be coupled with cellular expression level of the skin homing and endothelial adhesion molecules to identify modulators that enhance CTCL migration from skin to blood to improve the efficacy of CTCL therapies.

### Results

Nuclear size, organization and compositional variations of lymphoma cells: To quantify the nuclear size and shape heterogeneity of CTCL cells from blood (Mac-1) and from skin (Mac-2A & Mac-2B), staining was used to image nuclear features (FIG. 14, Panel A(i)-C(i)) and lymphoma-specific CD30 proteins to delineate cell contours for counting their numbers (FIG. 14, Panel A(ii)-C(ii)). Based on the nuclear features measured by the DAPI channel for the indicated cell numbers, Mac-2A cells on average show larger nuclear sizes than Mac-1 cells (FIG. 14, Panel D), while those of Mac-2A and Mac-2B show a greater shape diversity than Mac-1 cells (FIG. 14, Panels A(ii)-C(ii)), as quantified subsequently.

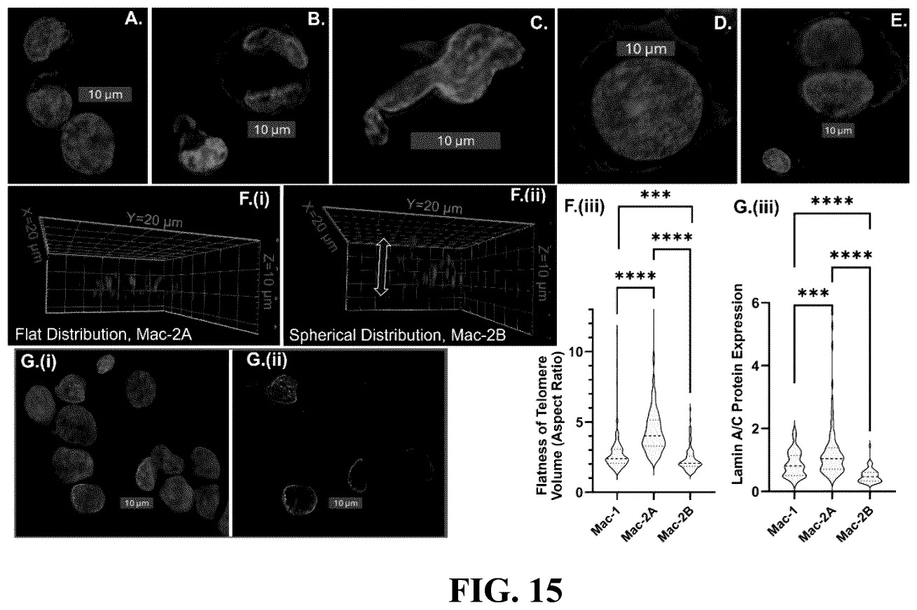

Fluorescence microscopy to characterize the frequency of different nuclear shapes (100 cells of each CTCL cell type) shows that ˜99% of Mac-1 cells exhibit mononucleated lymphocyte-sized cells (FIG. 15, Panel A), while these form only 90% of the shapes for Mac-2A and Mac-2B cells. The remaining cells (1% for Mac-1 and ˜10% for Mac-2A and Mac-2B) exhibit a wide variety of phenotypes, including lymphocyte sized multi-nuclearity (FIG. 15, Panel B), protruding nuclei (FIG. 15, Panel C), giant mono-nuclear (FIG. 15, Panel D), and giant multi-nuclear shapes (FIG. 15, Panel E). The representative 3D image of telomeres (red) obtained using quantitative fluorescent in situ hybridization (Q-FISH) shows that Mac-2A cells exhibit a flat telomere organization (FIG. 15, Panel F (i)), while Mac-2B cells exhibit a more spherical distribution (FIG. 15, Panel F (ii)). The nuclear aspect ratio plot from ˜100 cells of each type is used to quantify the 3D telomere spatial positioning (FIG. 15, Panel F (iii)). This indicates that Mac-2A telomeres show the highest nuclear aspect ratios due to their flatter 3D organization in comparison to the lower nuclear aspect ratios of Mac-1 and Mac-2B telomeres that exhibit spherical 3D distribution. Based on images of Mac-1 cells with the nuclear DNA DAPI stain in blue (FIG. 15, Panel G (i)) and immunostaining for nuclear lamin A/C protein expression in green (FIG. 15, Panel G (ii)), the lamin A/C protein level per cell is quantified based on 100 cells analyzed for each Mac-cell type. The plot (FIG. 15, Panel G (iii)) shows that Mac-2A cells exhibit the highest lamin A/C expression, with Mac-2B cells showing lower nuclear lamin A/C expression than Mac-2A cells and Mac-1 cells. These differences in nuclear shape diversity, 3D telomere organization and lamin A/C expression likely affect cellular mechanical characteristics⁴⁰, as studied subsequently and elaborated within the Discussion section.

Multimodal biophysical cytometry device under tunable viscoelastic extensional flows: For single-cell biophysical cytometry to enable classification of CTCL cell types, a microfluidic device (30 μm depth) with cells suspended in viscoelastic media (2% of w/w 0.6 MDa poly-ethylene-oxide or PEO within 1× phosphate buffered saline or PBS, with a net viscosity of 90-110 mPa·s) are directed towards a hyperbolic extensional flow (FIG. 16, Panel A(i)) for cell deformation, followed by confined recovery of deformed cells within an inverse hyperbolic channel. Cellular metrics are measured for corresponding cells using impedance cytometry in the pre-deformation region, while imaging cytometry is used in the pre-deformation, deformation and recovery regions (FIG. 16, Panel A(ii)). The constricted region of the hyperbolic channel includes a pneumatically controlled diaphragm made of poly-di-methyl-siloxane (PDMS) that can be pressurized per FIG. 16, Panels B(i)-(ii) to modulate the constriction width from 25 μm down to ˜13 μm under air pressures in the 0-30 psi range. To ensure mechanical integrity of the diaphragm under pressurization, simulations were used (FIG. 20) for selecting the diaphragm length as 200 μm to avoid midplane deformation and a wall thickness of 15 μm to achieve the required channel geometry (˜13 μm constriction at 30 psi) for cell deformation without clogging (cell size distribution of 9-13 μm per FIG. 22) and bubble formation, while the 30 μm channel depth ensured elasto-inertial cell focusing across channel depth (confirmed in FIG. 21, Panel C). In this manner, under diaphragm pressurization from 0 to 30 psi, cells focused at the center of the hyperbolic channel are subject to a progressively higher deformation due to increasing shear rate onwards from the channel edge towards the interior that leads to higher cell velocities, per the flow simulations in FIG. 16, Panel C(i). The shear field (FIG. 21, Panel A) and resultant velocity simulations across the channel depth (FIG. 16, Panel C(ii)) show that while the diaphragm causes some spatial non-uniformity across the depth, this is restricted to within a few microns at the top and bottom of the 30 μm channel depth. Hence, cells focused at the center of depth channel (confirmed in FIG. 21, Panel C), do not experience position-dependent deformation under diaphragm actuation. In this manner, CTCL cells (9-13 μm size range per FIG. 22) can progressively deform and recover at high throughput (100 cells/s) under pressurized hyperbolic viscoelastic flow, with the 30 μm depth channels enabling cell reorientation as needed to prevent clogging. Using a heterogeneous sample with equal proportions of Mac cells in FIG. 16, Panel D(i), it is apparent that diaphragm pressurization enables a greater proportion of the heterogeneous cell sample to be deformed to higher levels, with FIG. 22 showing that a greater proportion of small cells (<average size of 11 μm) and total cells (small and large) reach anisotropy index (AI) levels≥2 with increasing diaphragm pressure. This can enable cell type distinction to a better resolution and with lower measurement error, whereas higher flow rates and viscosities would likely be needed to cause the similar deformability levels⁴¹ over greater lengths of the extensional flow, which can potentially cause cell destruction. At 20 psi, the respective Mac cell types exhibit similar AI levels (FIG. 16, Panel D(ii)), especially within the middle 50% range for Mac-1 (Median=2.52) and Mac-2A cells (Median=2.12). However, at 30 psi (FIG. 16, Panel D(iii)), the AI levels become more distinguishable, with the first quartile for Mac-1 cells (3.01) exceeding the third quartile for Mac-2A cells (2.62), indicating that 75% of the data between these two groups are fully separated. Additionally, the distinction between Mac-2A and Mac-2B cells becomes more pronounced, with the difference in their medians increasing from 0.41 to 0.54 at 20 psi vs. 30 psi.

CTCL cell type distinction on impedance, deformation and recovery metrics: The single-cell multimodal biophysical cytometry device per FIG. 16, Panel A(ii) is utilized at 30 psi diaphragm pressurization to quantify the cellular biophysical metrics from impedance, deformability and recovery measurements for distinction of CTCL cells that chiefly differ on nuclear phenotypes (per FIG. 14-FIG. 15). Simulations of single-cell impedance spectra using electrodes in the channel and a multi-shell dielectric model for the cell with increasing nucleus to cell size (FIG. 17, Panel A(i) per the cell parameters in Table 2) indicate that the enlarged nuclear content, as modeled by conductivity and permittivity at the cell interior, leads to high frequency impedance magnitude or |Z| alterations that lower the impedance magnitude opacity at 18 MHz or |Z_{18 MHz}=|/| Z_{0.5 MHz}| per FIG. 17, Panel A(ii), while increasing normalized impedance phase (φZ_{18 MHz}=) levels in the same frequency range (FIG. 17, Panel A(iii)). Impedance measurements on the respective CTCL cell types show that while there are minimal differences in electrical size distributions of the cells

$$\sqrt[3]{{\vert Z \vert}_{05 MHz}} ;$$

(FIG. 17, Panel B(i)) and in impedance opacity at 2 MHz or | Z_{2 MHz}|/|Z_{0.5 MHz}| (FIG. 17, Panel B(ii)), the impedance opacity at 18 MHz or |Z_{18 MHz}|/|Z_{0.5 MHz}| is lowered for Mac-2A and Mac-2B cell types versus Mac-1 cell types, as expected with increasing nucleus to cell size from the simulations (FIG. 17, Panel A(ii)). Scatter plots of impedance phase at high frequency (φZ_{18 MHz}=) vs. low frequency (φZ_{0.5 MHz}) show a gradual increase in the number of events at higher phase levels for Mac-2A (FIG. 17, Panel C(ii)) and Mac-2B cells (FIG. 17, Panel C(iii)) of larger nuclear to cell size versus Mac-1 cells (FIG. 17, Panel C(i)). Hence, these measured impedance metrics (|Z_{18 MHz}|/|Z_{0.5 MHz}| and φZ_{18 MHz}VS. φZ_{0.5 MHz}) correspond with those obtained from simulations for increasing nucleus to cell size and compare with observations of relatively larger nuclear sizes of Mac-2A and Mac-2B cell types vs. Mac-1 cell types (FIG. 14, Panel D) and their more diverse nuclear shapes (10% with the multinuclear shapes in FIG. 15, Panels B-E for Mac-2A and Mac-2B cell types vs. 1% for Mac-1).

TABLE 2
Multi-shell model fitting parameters for CTCL cells

| | CTCL |
|---|---|
| Parameters | cells |
| Cell radius (r_{cell}) [m] | 6 × 10⁻⁶ |
| Membrane thickness (dₘₑₘ) [m] | 7 × 10⁻⁹ |
| Nucleus radius (r_{nuc}) [m] | 2.3-4.2 × 10⁻⁶ |
| Nuclear envelope thickness (dₙₑₙᵥ) [m] | 40 × 10⁻⁹ |
| Membrane conductivity (σₘₑₘ) [S m⁻¹] | 1 × 10⁻⁶ |
| Membrane permittivity (εₘₑₘ) [1] | 10 |
| Interior conductivity (σᵢₙₜ) [S m⁻¹] | 0.5 |
| Interior permittivity (εᵢₙₜ) [1] | 60 |
| Nuclear envelope conductivity (σₙₑₙᵥ) [S m⁻¹] | 1 × 10⁻³ |
| Nuclear envelope permittivity (εₙₑₙᵥ) | 20 |
| Nucleoplasm conductivity (σ_{nuc}) [S m⁻¹] | 2.4 |
| Nucleoplasm permittivity (ε_{nuc}) [1] | 70 |
| Nucleus to Cell Volume Ratio (N/C) [%] | 10-60 |
| Medium conductivity (σ_{medium}) [S m⁻¹] | 1.6 |
| Medium permittivity (ε_{medium}) [1] | 80 |

Square brackets denote units; 1 indicates dimensionless parameter.

The cell shape anisotropy metrics within the indicated regions of interest (R1-R8 per FIG. 18, Panel A) for the pre-deformation (R1), progressive deformation (R2-R3) up to its highest level (R4), and confined recovery (R5-R7) up to near-complete recovery (R8) at the end of the hyperbolic region are quantified by high-speed imaging, with single-cell correspondence of the impedance and imaging cytometry data. Representative images (FIG. 18, Panel B) show that the undeformed Mac-1, Mac-2A, and Mac-2B cells of spherical shape in the R1 region deform to highly elliptical shapes in the R4 region. The respective shape anisotropy index levels at R4 in FIG. 18, Panel D (quantified based on ˜1000 events) indicate highly deformable Mac-1 cells and relatively stiffer Mac-2A cells, with Mac-2B cells exhibiting deformability levels between Mac-1 and Mac-2A cell types. The lower deformability of Mac-2A cells is correlated to their lower migration rate in comparison to similar-sized Mac-1 cells through transwell plates with 8 μm pores (FIG. 27), wherein after 1 hour of culture for 2×10⁴ cells of each cell type seeded on the top plate, 6168 Mac-1 cells migrated to the bottom layer, while only about 227 Mac-2A cells migrated. Interestingly, while the relatively stiffer Mac-2A cells begin to recover to circular-like shapes in the R6 region within the inverse hyperbolic channel, the more deformable Mac-1 and Mac-2B cells exhibit a characteristic bullet shape at the early stage of recovery. While the bullet and the spherical shapes can exhibit similar shape anisotropies (˜1), they can be distinguished by the axis eccentricity metric (FIG. 23), whereas the anisotropy index for ellipsoid shapes far exceeds 1. However, the camera resolution (0.53 μm/pixel) limits ability to measure axis eccentricity at the magnification for the chosen field of view (including pre-deformation, deformation and confined recovery regions), so the bullet shape is quantified by the circularity metric (FIG. 18, Panel C), which is greater for Mac-1 and Mac-2B cells than Mac-2A cells (spherical cells show zero circularity). This bullet cell shape, which is only observed under confined recovery in the inverse hyperbolic channel but not under immediate recovery within the large-width channel (FIG. 24), likely occurs due to viscous energy storage within the more deformable Mac-1 and Mac-2B cells that leads to uneven recovery between their leading and trailing cell edges under confined hyperbolic viscoelastic flow, whereas the relatively stiffer Mac-2A cells maintain their elliptical shape in the R5-R8 region through until complete recovery. Based on measured shape anisotropics over the different regions (FIG. 18, Panel D), the deformable Mac-1 and Mac-2B cells exhibit slow recovery towards circular levels within the R5-R6 region due to their bullet shapes, whereas the stiffer Mac-2B cells recover to elliptical shapes in the R5-R6 region and near-spherical shapes in the R8 region, with fully spherical shapes further down from the R8 region. Hence, Mac-2A cells can likely be distinguished against Mac-1 cells based on their lower deformability levels, which is consistent with their relatively larger nuclear sizes (per FIG. 14) and more diverse nuclear shapes than Mac-1 cells (per FIG. 15, Panels A-E). On the other hand, Mac-2B cells exhibit intermediate deformability levels despite their diverse nuclear shapes resembling Mac-2A cells (per FIG. 15, Panels A-E), which could be attributed to their resemblances to Mac-1 cells, in terms of their 3D telomere organization (FIG. 15, Panel F (iii)) and nuclear lamin A/C levels (FIG. 15, Panel G (iii)). Finally, the stiffer Mac-2A cells show more spherical-like circularity levels during recovery than the more deformable Mac-1 and Mac-2B cell types, which show the characteristic bullet shape in the recovery region.

Based on data from ˜1000 events on corresponding cells with impedance, deformability and recovery data, the accuracy for classification of the respective Mac cell types is quantified based on the SVM model with a Gaussian kernel function. The model 70% percent of the data was used for training, and then the accuracy was calculated based on the remaining 30% of the data set. The confusion matrix shows that the accuracies are only 71.4% with the sole utilization of impedance metrics (FIG. 19, Panel A) and only 75.6% with utilization of metrics from impedance and the highest deformation levels (FIG. 19, Panel B). Classification based solely on impedance metrics indicates weak distinction between Mac 2A and Mac 2B, with false negative rates of 32.3% for Mac 2A and 14.5% for Mac 2B (FIG. 19, Panel A). Incorporating the highest deformation level reduces these false negatives while improving the true positive rates for Mac 1 and Mac 2B (FIG. 19, Panel B). On the other hand, using the metrics from impedance, deformation and recovery, classification accuracy levels of 84.8% can be reached (FIG. 19, Panel C). In fact, adding recovery metrics increases the true positive rates to over 82% for all classes and significantly reduces false negatives for Mac 2A and Mac 2B (FIG. 19, Panel C) highlighting the substantial value of recovery metrics towards improving classification. Principal Component Analysis (PCA) is used to transform the correlated variables into a set of uncorrelated principal components for reducing the dimensionality and enabling identification of the most significant variations among the respective cell types. By visualizing the first three principal components (PCI to PC3) that capture the variances, the high-dimensional dataset was represented in a lower-dimensional space while retaining the most critical information that is significant for distinguishing the cell types. A 3D scatter plot of the first three principal components (FIG. 19, Panel D) illustrates the clustering of Mac-1, Mac-2A, and Mac-2B cells in this transformed space, while boxplots for each of the three principal components examine the distribution and separation of cell types across these dimensions (FIG. 26). The positioning of each cell type relative to the principal axes suggests inherent and independent differences in their impedance and deformability metrics. The score plot, scree plot and cumulative scree plot are shown in FIG. 25 to explain the PCA results. The score plot reveals how different features contribute to the formation of the principal components. Among the impedance features, the magnitude opacity at 18 MHz plays an important role. In terms of deformation metrics, the anisotropy index across all regions but particularly at the maximum deformation at region R4 (between the diaphragms) is a dominant contributor. Furthermore, the score plot highlights the significance of recovery-related features, particularly those at region R6, especially to distinguish Mac-2A versus Mac-2B. Furthermore, the scree plot shows that the first three principal components explain a significant proportion of the total variance (ranging from ˜15% to ˜37% each), indicating that most of the important variation in the dataset is captured within these components. Without wishing to be bound by theory, this may indicate that the high-dimensional data can be effectively represented in a lower-dimensional space without substantial loss of information (FIG. 19, Panel D).

### DISCUSSION

Recent studies of matched skin and blood cells from CTCL patients suggest that the skin microenvironment promotes rapid tumor cell expansion [5′], as opposed to the quiescent state observed in the blood⁶. This highlights the need for mechanical regulators that modulate cellular biophysical properties to enhance CTCL migration from skin to blood to enhance the efficacy of therapies, especially Mogamulizumab and extracorporeal photopheresis that depend on access to tumor cells in the blood [7′]. Using appropriate cell lines to mimic the clinical disease, such as Mac-1 cells derived from a patient at early time points from blood that exhibits less aggressive behavior, and Mac-2A and Mac-2B cells derived from the same patient at later disease stages that clinically formed aggressive skin tumors without access to the blood [42′], the study measured single-cell biophysical metrics of these model human CTCL lines derived from skin tumors (Mac-2A & Mac 2B) and blood circulating cells (Mac-1). In this manner, the study sought to develop tools for optimizing mechanical regulators to increase intravascular localization of CTCL cells, despite heterogeneity of their nuclear phenotypes, which influences cell migration. Using a tunable diaphragm to set the channel geometry for deformation of a wide cell size distribution without clogging, the results show that Mac-2A cells of larger nuclear sizes and more diverse nuclear shapes versus Mac-1 cells exhibit lower deformability levels, which is correlated to their lower migration rate through transwell plates with 8 μm pores in comparison to similar-sized Mac-1 cells. The larger nuclear sizes for Mac-2A versus Mac-1 cells cause a characteristic reduction in their impedance magnitude opacity and a rise in their impedance phase metrics at high frequency (18 MHz) per FIG. 17, as verified by multishell dielectric model simulations. On the other hand, Mac-2B cells exhibit an intermediate deformability level between Mac-1 (high deformability) and Mac-2A cells (low deformability), despite their larger nuclear size and 10% of their cells showing multinuclear shapes as observed in Mac-2A cells. The higher deformability for Mac-2B versus Mac-2A cells is chiefly attributed to their nuclear lamin A/C protein levels, since chromosomes attach to lamin A/C via their telomeres, with lower lamin A/C levels stimulating chromosome and telomere movement^{43,44}. Hence, the lower levels of nuclear lamin A/C for Mac-2B versus those of Mac-2A can explain the spherical distribution in telomere organization observed for Mac-2B versus the flat distribution for Mac-2A (FIG. 15, Panel F), as well as the enhanced deformability of Mac-2B vs. Mac-2A cells (FIG. 18, Panel C in the R4 region) and their higher viscous energy storage during deformation, which delays the post-deformation relaxation of Mac-2B vs. Mac-2A cells in the recovery region (FIG. 18, Panel D in the R6-R8 region). Hence, agents or drugs that degrade nuclear lamin A/C to enable a 3D spherical telomere organization can increase CTCL cell deformability as apparent with Mac-2B vs. Mac-2A cells, thereby likely enhancing their migration from skin to blood to improve therapy efficacy. Interestingly under confined recovery conditions within the inverse hyperbolic channel geometry, stiffer Mac-2A cells show higher circularity than more deformable Mac-1 and Mac-2B cell types, which exhibit bullet shapes that was attributed to uneven recovery between their leading and trailing cell edges under confined viscoelastic flow. Using cellular metrics with corresponding impedance, deformation and recovery data, classification accuracies of 84.8% can be obtained between the respective cell types using the support vector machine model based on >1000 events per cell type. In this manner, the interplay of cellular biophysical characteristics can eventually be coupled with their expression of endothelial adhesion molecules to identify modulators that enhance cell migration to the blood to improve the efficacy of CTCL therapies.

### Methods

Device design and integration: The microfluidic device with a hyperbolic extensional flow profile (FIG. 16, Panels A-B) that constricts to 25 μm (>cell size) was fabricated by standard SU8 lithography (EVG 620) for PDMS micromolding. The patterned SU8 layer includes an air flow channel leading from an air inlet to the PDMS diaphragm that adjoins the constricted region of the hyperbolic extensional flow, per FIG. 16, Panel A(ii). A PDMS formulation with 12:1 of base to curing agent ratio was selected to achieve increased elasticity and lower modulus, for enabling greater diaphragm deformation sensitivity under pneumatic actuation, while also allowing for facile bonding and mechanical stability during device operation. The released PDMS layer is then aligned to gold electrodes that were patterned on a glass coverslip for bonding under an O₂ plasma (Tergeo Cleaner, PIE Scientific). A 3D printed holder was used to establish electrical contacts using a pogo pin assembly, with an open area to enable high speed imaging for image cytometry.

Simulation of shear rate, velocity and impedance signals under hyperbolic extensional flow: Flow behavior inside the microchannel was simulated using the Laminar Flow module in COMSOL Multiphysics. A flow rate of 12 μL/min was applied at the inlet, with the outlet set to atmospheric pressure. The fluid was modeled as a 2% (w/w) of 0.6 MDa PEO solution based on the measured viscosity. Velocity profiles were used to compute local shear rates and extensional rates within the channel, providing insight into the mechanical stresses acting on cells. The electric fields and currents under cell-induced field screening were simulated by using COMSOL electric current module, based on a rectangular channel design of 25 μm by 30 μm cross section and three coplanar electrodes of 15 μm width and 15 μm spacing. A voltage signal of 3 Vₚₚ at 3 different frequencies (0.5-18 MHz) was applied simultaneously to the middle electrode and the current of other electrodes are measured differentially, while their voltage was kept at the ground level. To simulate a particle, a sphere was passed across the electrodes in the measurement region. The generated signal was fitted to a bipolar Gaussian function to determine its peak amplitude and signal width in MATLAB (R2022a, MathWorks).

Cell lines and culture: The reported Mac cell types were from the same patient who formally consented to the research at Beth Israel Deaconess Medical Center, per their Institutional Review Board protocols. Mac-1 cells were derived from a patient at early time points from blood that exhibits less aggressive behavior, and Mac-2A and Mac-2B cells were derived from the same patient at later disease stages that clinically formed aggressive skin tumors were stored per standard procedures⁴². The respective cells were cultured in RPMI 1640 Medium (Gibco, 11875093) with 10% FBS at 37° C. in 5% CO₂-95% air atmosphere. For transwell culture, cells were loaded in 8 μm PET membrane transwell inserts (Corning, 353097).

Immunostaining for nuclear size distinctions: For nucleus immunostaining used for the results in FIG. 14, the respective cells were cytospun at 1,000 rpm for 5 minutes, followed by fixation in cold acetone (−20° C.) for 10 seconds. The slides were then immersed in Giemsa stain (Sigma, 48900) for 10 minutes and rinsed with distilled water. Images were captured at 20× magnification using the Cytation 5 imager. For stainbing the cell contours, live cells were collected and washed with autoMACS Running Buffer (Miltenyi Biotec, 130-091-221). Cells were incubated with anti-CD30 antibody at a 1:200 dilution in autoMACS Running Buffer for 30 minutes. After a single wash, cells were incubated with donkey anti-goat Alexa Fluor 488 secondary antibody (Life Technologies, A11055). Following a final wash, images were acquired using the Cytation 5 imager. Hoechst 33,342 (735969, 1:500, Thermo Fisher) was used to stain the nuclei. Nuclei size were measured by Gen5 software. The statistical analysis was performed by using GraphPad Prism 10.0 software (GraphPad Software, La Jolla, CA, USA).

Transwell migration assay: To quantify the migration rate through 8 μm pores of a transwell plate, cells were first stained with Hoechst for 15 minutes. Equal numbers of Mac-1 and Mac-2A cells were then seeded into the transwell inserts. After a 1-hour incubation, the inserts were removed, and montage images of each well were automatically captured at 10× magnification using a Cytation 5 image reader. The number of cells was quantified in FIG. 27 using the DAPI channel with Gen5 software (BioTek Instruments, Winooski, VT, USA).

Sample preparation for fluorescence microscopy: For the fluorescence microscopy to determine of nuclear shapes per FIG. 15, the respective cells were spread onto poly-L-lysine (SIGMA, p8920, St. Louis, MO, USA) coated slides (O. Kindler GmBH, Ziegelhofstraße 214, 79110 Freiburg, Germany). Slides were fixed in 3.7% formaldehyde/1× phosphate buffered saline (PBS) for 10 min at room temperature. Slides were then washed in 1×PBS, shaking at room temperature, 3 times×5 min. Slides were then dehydrated in series of 70, 90, 100% ethanol in H₂O, for 3 min each, and then kept frozen at −20° C. until experiments. Before the start of experiments, the slides were taken from the freezer and rehydrated in decreasing EtOH concentrations from 100% EtOH to 50% EtOH/H₂O.

Antibodies: The antibodies used for the experiments were: 1) Primary Anti-Lamin A/C antibody (rabbit polyclonal, ab26300, Abcam Ltd., Cambridge, UK); 2) Secondary goat Anti-rabbit antibody conjugated with the Alexa 488 fluorophore (A-11008, Molecular Probes, Waltham, MA, USA); 3) Primary CD30 Antibody (Ber-H2) (Mouse Monoclonal, MA5-13219, Thermo Fisher Scientific, Waltham, MA, USA); 4) Secondary sheep Anti-mouse antibody conjugated with the Cy3 fluorophore (Polyclonal, AC111C, Merck & Co., Kenilworth, New Jersey, United States).

Co-immunostaining for lamin A/C and CD 30 imaging: Slides were first incubated in 4% Bovine Serum Albumin (BSA)/4× saline-sodium citrate (SSC) blocking solution for 5 minutes at 37° C. A dilution of 1:100 for the primary antibodies and 1:500 for the secondary antibodies in 4% BSA/4×SSC blocking solution was used. Slides were incubated with both primary antibodies overnight at 37° C. in humidified atmosphere and washed three times in 1×PBS, 5 min each. Incubation with secondary antibodies was performed for 24 hours at 37° C. in humidified atmosphere and then washed three times in 1× PBS for 5 min each. DNA of the nuclei was counterstained with 1 μg/mL 4′,6-diamidino-2-phenylindole (DAPI) for 5 min. Slides incubated without primary antibodies (4% BSA/4×SSC blocking solution only) were processed in parallel as negative control. A drop of mounting medium Vectashield (Vector Laboratories Inc, Burlingame, CA, USA) was added to prevent photo bleaching before imaging.

Immunostaining for lamin A/C and Telo-Q-FISH: The immunostaining and Telo-Q-FISH protocol used here was adapted from a previously described protocol⁴⁵. Q-FISH was performed by applying Cy3-Labeled peptide nucleic acid (PNA)-telomere probe (Dako, Glostrup, Denmark) in the dark, followed by a cycle of denaturation for 3 min at 80° C. followed by hybridization for 2 h at 30° C. using the Hybrite™ (Vysis/Abbott, Abbott Laboratories. Abbott Park, Illinois, USA). The slides were then washed in 70% formamide/10 mM 2 times, 15 minutes each and then washed in 0.1×SSC at 55° C. for 5 minutes. Two more washes in 2×SSC/0.05% Tween 20 were performed for 5 minutes each. Slides were then incubated in 4% BSA/4×SSC blocking solution for 5 minutes at 37° C. before immunostaining. A dilution of 1:100 for the primary Anti-amin A/C antibody (rabbit polyclonal, ab26300, Abcam Ltd., Cambridge) and Secondary goat Anti-rabbit antibody conjugated with the Alexa 488 fluorophore (Molecular Probes, Waltham, MA, USA) was used. Slides were incubated with primary antibody overnight at 37° C. in 4% BSA/4×SSC humidified atmosphere. Slides were washed three times in 1×PBS, 5 min each. Incubation with secondary antibody was performed for 1 hour at 37° C. in humidified atmosphere, then slides were washed three times in 1×PBS, 5 min each. DNA of the nuclei was counterstained with 1 μg/mL DAPI for 5 min. Slides incubated without primary lamin A/C antibody (4% BSA/4×SSC blocking solution only) and no telomere probe were processed in parallel as negative control. A drop of mounting medium Vectashield (Vector Laboratories Inc, Burlingame, CA, USA) was added to prevent photo bleaching before imaging.

3D Fluorescence image acquisition: 3D image acquisition was performed on 100 cells of each cell line, per experiment. The 3D imaging was performed using ZEISS Axio Imager.Z2 (Carl Zeiss, Toronto, ON, Canada) with a cooled AxioCam FITC, Cy3 and DAPI filters in combination with a Planapo 63×/1.4 oil objective lens (Carl Zeiss, Toronto, ON, Canada). Light microscopy images have an optical resolution at 102 nm in x-y directions and 200 nm in z, accordingly, 60 z-stacks at 200 nm step-size were imaged for every fluorophore. A FITC filter was used to visualize Lamin A/C stain with a 300 ms exposure time. In “Co Immunostaining for lamin A/C and CD30” experiments, CD30 stain was also visualized with FITC filter and 300 ms exposure time. A Cy3 filter was used to visualize telomere probe with 800 ms exposure time. In “Co Immunostaining for lamin A/C and CD30” experiments, lamin A/C staining was also visualized with Cy3 filter using 500 ms exposure time per image. A DAPI filter was used to visualize the DNA with 8 ms exposure time in all experiments. Images were obtained using Zen Blue 3.1 (Carl Zeiss, Toronto, ON, Canada), deconvolved using the constrained iterative algorithm with Theoretical Point Spread Function and Clip Normalization (46).

Quantitative analysis of lamin A/C and CD 30 expression: Lamin A/C expression was analyzed on ZEN Blue Version 3.1 Software (Carl Zeiss, Jena, Germany). Lamin A/C structure appeared as a ring at nuclear periphery of cells; a single representative z-stack, wherein the Lamin A/C ring was widest, which was selected for each cell. For Lamin A/C quantification, analysis was done according to prior methods⁴⁷. Briefly, the “draw spline contour” tool was used to define two areas in the selected z-stack, the external 26 area and the internal area. The external area was defined as the part of the image where lamin A/C structure was visible (represented in red, FIG. 28). The internal area is the portion of the image with the nucleus but absent of Lamin A/C structure (represented in blue, FIG. 28). The external Lamin A/C intensity (Iₑ) was the total signal intensity within defined external area, while the internal total Lamin A/C intensity (Iᵢ) was the total signal intensity within the internal area. An intensity ratio (Iₑ/Iᵢ) was calculated to normalize the signal with cell area. For quantifying CD30 expression, the “draw spline contour” tool was used to draw a zone enclosing the visible CD30; the signal sum was divided by area to generate a final number.

Analysis of Telomere Distribution: Deconvolved images were converted into TIFF files and exported for 3D analysis using the Telo View software [48′] (version 2.0, Telo Genomics, Toronto, ON, Canada). A data point for telomere spatial distribution using the ellipsoid dimensions a/c ratio, was generated for each nucleus (FIG. 29).

Measurement set-up for impedance and image cytometry: To measure cell deformation in the microfluidic device under hyperbolic extensional flow [49′], cells were suspended in a 2% (w/w) PEO solution along with co-flowing 12 μm polystyrene beads (at a concentration of ˜1.2×10⁵ beads/mL). This mixture was injected into the sample inlet using a syringe pump (neMESYS, Cetoni) at a flow rate of 6 μL/min. Simultaneously, a sheath flow of the same 2% (w/w) PEO solution was delivered at an equal flow rate through the sheath inlet, as illustrated in FIG. 16, Panel A. High-speed imaging was performed using a Phantom S210 camera connected to a Eurosys frame grabber card to capture bright-field video images. Recordings were performed at a resolution of 1280×256 pixels (corresponding to a field of view of 680×135 μm), with a frame rate of 4000 fps and an exposure time of 10 μs. Single-cell impedance measurements were taken upstream of the deformation region using an impedance spectroscope (HF2IS, Zurich Instruments). A standard differential measurement setup was used: a 3 Vₚₚ voltage signal at 0.5, 2, and 18 MHz was applied to the central electrode, while differential current signals were collected from the side electrodes using a current to voltage amplifier (HF2TA, Zurich Instruments). These signals were then sent to the impedance spectroscope for digitization and analysis of the channel impedance variation.

Impedance signal processing: Impedance data, recorded at a sampling rate of 115 kSps, were processed and analyzed using MATLAB (R2022a, Math Works). Raw signals at each frequency were first filtered using a high-pass filter to remove baseline drift and power line interference, followed by a low-pass filter for smoothing. A peak detection algorithm was then applied to identify events corresponding to cell passage through the electrode region. Each detected signal was subsequently fitted with a bipolar Gaussian function to verify single-cell events, defined by a fit with an R-squared value exceeding 0.95. The amplitude and phase of each event were subsequently normalized to the mean peak value of 12 μm polystyrene beads [50′] [51′]. (see FIG. 30).

Image processing: Custom Python code was used to process the recorded frames. Each frame was subtracted from a reference frame generated by averaging 1000 randomly selected frames. A weighted average kernel filter was then applied to enhance image quality and reduce noise. To improve processing speed, a 128×64 pixel window was defined around the particle to restrict computations to a smaller region of interest. The processed image was then converted to binary format using a predefined threshold, and cell edges were extracted using standard edge detection algorithms. The anisotropy index was calculated as the ratio of cell length to width. Circularity was determined by measuring both the perimeter and area of the cell, based on the detected edges. The extracted morphological data were converted to MATLAB-compatible format for integration with the corresponding impedance data. Synchronization between imaging and impedance events was achieved using a cross-correlation approach, allowing accurate temporal alignment of the two data streams.

Classification based on Machine Learning Implementation: A Support Vector Machine (SVM) classifier with a Gaussian kernel was implemented in MATLAB to differentiate between Mac 1, Mac 2A, and Mac 2B cell types [52′][53′]. Initially, classification was based solely on features obtained from impedance cytometry. Later, additional parameters related to cell deformability and recovery were included to improve the model's accuracy. For training, 70% of the dataset, approximately 1000 events per cell type in total, was used, while the remaining 30% was allocated for validation and testing. Furthermore, Principal Component Analysis (PCA) was applied to convert potentially correlated input features into a new set of uncorrelated principal components. This dimensionality reduction technique facilitated the identification of the most critical variations between cell types and improved both data interpretability visualization.

Statistical Analysis: All data are presented as mean±standard deviation (SD). For the cell nuclei size data in FIG. 14, Tukey's multiple comparison test was used, with a significance threshold set at α=0.05. For the data reported in FIG. 15 on nuclear aspect ratio (telomere volume flatness) and lamin A/C expression, the Kruskal-Wallis test (a nonparametric alternative to one-way ANOVA) was used to evaluate differences among each cell type. For pairwise multiple comparisons, the Wilcoxon rank-sum test (Mann-Whitney U test) was performed between the respective cell type groups. All tests were two-tailed, and statistical significance was set at α=0.05, with p≤0.01 (**), p≤0.001 (***) and p≤0.0001 (****). Data distributions are visualized using box plots or violin plots, where the central line indicates the median, the box spans the first and third quartiles, and the whiskers extend to the minimum and maximum values within the +3 SD range.

Data Analysis for Impedance Cytometry: Processed signal data was stored in the form of impedance magnitude and phase. For data analysis, phase and magnitude data were calculated by a peak detection algorithm with a custom code written in MATLAB. The analysis of experimental data starts by plotting the phase (φZ_{18 MHz}) versus the magnitude (|Z|_{18 MHz}) in a scatter plot (FIG. 20, Panel A). In the example, the two populations (beads and cells) are clearly identifiable, so that the bead population can be gated. Then the impedance phase and magnitude were normalized against the impedance response of the beads by dividing the impedance data by the mean impedance of beads. Post-normalization, the beads would have a mean magnitude of 1 and a mean phase of 0 (FIG. 20, Panel B). Then in the normalized scatter plot of phase (φZ_{18 MHz}) versus the magnitude (|Z|_{18 MHz}), the cell population were gated from reference beads and the normalized impedance for gated CTCL cell types was analyzed at each frequency (0.5, 2 and 18 MHz). Polystyrene beads are usually added to samples as a reference and they can be used for the normalization of magnitude and phase of the impedance signal, thereby allowing direct comparison between different populations and/or experiments.

Multi-shell dielectric modeling: For the case where a particle is suspended in a dielectric medium, dielectric spectroscopy can be used to measure the dielectric properties of the suspension [1′]-[2′]. The mixture of particle and medium can be approximated to that of a single dispersion using Maxwell's mixture theory (MMT) [3′]. MMT can be used to combine the dielectric properties of all parts into an overall complex permittivity of the mixture (\tilde{ε}ₘᵢₓ):

$${\tilde{ε}}_{mix} = {\tilde{ε}}_{medium} ( 1 + 3 φ {\tilde{f}}_{CM , mix} ) \qquad ( Eq . 7 )$$

In Equation 7, φ is the volume fraction of the particle in the medium. In practical terms, \tilde{ε}ₘᵢₓ describes the change in the medium permittivity, due to the presence of a particle of a given volume and can only be used if the volume fraction is small, i.e., φ<<1.

For the case of a cell in suspending medium, MMT-based, multi-shell models can be used to retrieve the dielectric properties of the cell [3′]-[6′]. While cells have an intricate internal structure surrounded by a membrane, a simplified approximation can be used based on multi-shell models, wherein a cell is described as a series of n concentric shells with defined dielectric properties (1—membrane, 2—cell interior, 3—nuclear envelope, and 4—nucleoplasm). In the model, there were multiple dispersions, corresponding to each of the existing interfaces (i.e. medium-membrane, membrane-interior, interior-nuclear envelope and nuclear envelope-nucleoplasm). For a multi-shell model, the Clausius-Mossotti factor of the cell in the mixture is given per Equation 8.

$${\tilde{f}}_{CM , mix} = \frac{{\tilde{ε}}_{cell} - {\tilde{ε}}_{medium}}{{\tilde{ε}}_{cell} = 2 {\tilde{ε}}_{medium}} \qquad ( Eq . 8 )$$

The complex permittivity of the cell, \tilde{ε}_{cell}, is an aggregation of the complex permittivities of all the n shells modelled and represents the final dispersion corresponding to medium and cell membrane.

The complex permittivity of any dispersion can be calculated per Equations 9 and 10.

$${\tilde{ε}}_{n , n + 1} = {\tilde{ε}}_{n} \frac{{γ}_{n - 1 , n}^{3} + 2 ( \frac{{\tilde{ε}}_{n + 1} - {\tilde{ε}}_{n}}{{\tilde{ε}}_{n + 1} + 2 {\tilde{ε}}_{n}} )}{{γ}_{n - 1 , n}^{3} - ( \frac{{\tilde{ε}}_{n + 1} - {\tilde{ε}}_{n}}{{\tilde{ε}}_{n + 1} + 2 {\tilde{ε}}_{n}} )} \qquad ( Eq . 9 )$$

$${γ}_{n - 1 , n} = \frac{{r}_{n - 1}}{{r}_{n}} \qquad ( Eq . 10 )$$

The complex permittivity of each specific shell can in turn be calculated using:

$${\tilde{ε}}_{n} = {ε}_{o} {ε}_{n} - i \frac{{σ}_{n}}{ω} \qquad ( Eq . 11 )$$

In Equation 11, εₙ and σₙ can be ranges of permittivities and conductivities (refer to Table 1 for a full list of tested parameters), respectively, being tested with the model for each n shell; while ε₀ is the constant vacuum permittivity (8.85×10⁻¹² F m⁻¹) and ω is the angular frequency along the frequency spectrum measured.

TABLE 1
Nucleus size data in FIG. 14 - Tukey's Multiple Comparisons Test.
(i) Test Parameters

| | Tukey's multiple |
|---|---|
| Test | comparisons test |
| Alpha | 0.05 |

(ii) Statistical Summary

| | Mean | Mean | |
|---|---|---|---|
| Comparison | Group 1 | Group 2 | Mean Diff. |
| Mac-1 vs. Mac-2A | 9.99330 | 10.590139 | −0.59683652 |
| Mac-1 vs. Mac-2B | 9.99330 | 9.9336735 | 0.059629071 |
| Mac-2A vs. Mac-2B | 10.590139 | 9.9336735 | 0.65646560 |

| 95% CI of Diff. | SE of Diff. | DF | Adjusted P | Significance |
|---|---|---|---|---|
| −0.79550707 to −0.39816598 | 0.084702966 | 1948 | <0.0001 | **** |
| 0.21302740 to 0.33228554 | 0.11624678 | 1948 | 0.8650 | ns |
| 0.38055245 to 0.93237874 | 0.11763526 | 1948 | <0.0001 | **** |

With the calculation of the complex permittivity of each shell, it is then possible to arrive at the complex permittivity of the mixture (\tilde{ε}ₘᵢₓ) of the suspended cell and medium. With that value, the impedance of the said mixture (Žₘᵢₓ) can also be calculated using:

$${\tilde{Z}}_{mix} = \frac{1}{j ω {\tilde{ε}}_{mix} \frac{A}{d}} \qquad ( Eq . 11 )$$

In Equation 11, A is the electrode area and d the distance between pairs of electrodes defining the volume comprised by the suspended cell and medium.

Given the frequency-dependence of \tilde{Z}ₘᵢₓ, relaxation curves for the impedance magnitude and phase can be calculated using Equations 7 and 8. Using the estimated impedance magnitude and phase relaxation curves, it is possible to generate estimated values for different electrical physiology metrics. The electrical diameter can be estimated by using the estimated impedance magnitude curve and calculating

$$\sqrt[3]{{\vert Z \vert}_{frequency}}$$

for each point along the frequency spectrum tested, thus generating an electrical diameter estimation along frequency. The PZ contrast can be estimated by first obtaining the estimated impedance phase value at 0.5 MHz from the impedance phase curve. A ratio is then calculated between each point along the frequency spectrum and the estimated phase value at 0.5 MHz, thereby generating an φZ contrast response along frequency.

While the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the disclosure (and claims), including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive.

For example, the exemplary method and system using impedance phase and/or amplitude contrast may be used in conjunction with other contrast quantification available in the art, including image analysis-based quantification. Similarly, the exemplary method and system may be used with label-free as well as labeled samples in labeled separation and cytometry (e.g., verification, etc.). Similarly, the exemplary method and system may be used with low-throughput systems.

Indeed, the exemplary method and system may be used in combination with, and not limited to, system and method described in:

U.S. Utility patent application Ser. No. 18/691,779, entitled “ACOUSTIC TRAPPING MICROCHANNEL RESONANCE DETECTION AND CONTROL”, filed Mar. 13, 2024; International Patent Application Serial No. PCT/US2022/076372, entitled “ACOUSTIC TRAPPING MICROCHANNEL RESONANCE DETECTION AND CONTROL”, filed Sep. 13, 2022; Publication No. WO2023039607, Mar. 16, 2023; U.S. Utility patent application Ser. No. 18/837,107, entitled “BUFFER EXCHANGE OF BIOLOGICAL SAMPLES IN-LINE WITH SEPARATION AND MEASUREMENT OPERATIONS”, filed Aug. 8, 2024; International Patent Application Serial No. PCT/US2023/062399, entitled “BUFFER EXCHANGE OF BIOLOGICAL SAMPLES IN-LINE WITH SEPARATION AND MEASUREMENT OPERATIONS”, filed Feb. 10, 2023; Publication No. WO2023154874, Aug. 17, 2023; U.S. Utility patent application Ser. No. 17/750,880, entitled “Amplifier System and Controls for Dielectrophoretic Tracking in Microfluidic Devices”, filed May 23, 2022; Publication No. US/2023-0022460 al, Jan. 26, 2023; U.S. Utility patent application Ser. No. 15/515,528, entitled “Amplifier System and Controls for Dielectrophoretic Tracking in Microfluidic Devices”, filed Mar. 29, 2017; U.S. Pat. No. 11,339,417, issued May 24, 2022; Publication No. US-2017-0218424-A1, Aug. 3, 2017; International Patent Application Serial No. PCT/US2015/055021, entitled “IDENTIFICATION AND MONITORING OF CELLS BY DIELECTROPHORETIC TRACKING OF ELECTROPHYSIOLOGY AND PHENOTYPE”, filed Oct. 9, 2015; Publication No. WO2016057974, Apr. 14, 2016; International Patent Application Serial No. PCT/US2023/067113, entitled “DETECTING APOPTOTIC BODIES BY IMPEDANCE CYTOMETRY AS AN INDICATOR OF DRUG SENSITIVITY”, filed May 17, 2023; Publication No. WO2023244893, Dec. 21, 2023; U.S. Utility patent application Ser. No. 17/425,414, entitled “METHOD AND SYSTEM FOR IMPEDANCE-BASED QUANTIFICATION AND MICROFLUIDIC CONTROL”, filed Jul. 23, 2021; U.S. Pat. No. 12,031,896, issued Jul. 9, 2024; Publication No. US 2022-0091014 A1, Mar. 24, 2022; International Patent Application Serial No. PCT/US2020/014899, entitled “METHOD AND SYSTEM FOR IMPEDANCE-BASED QUANTIFICATION AND MICROFLUIDIC CONTROL”, filed Jan. 24, 2020; Publication No. WO 2020/154566, Jul. 30, 2020; U.S. Utility patent application Ser. No. 18/642,197, entitled “MULTIPLEXED ON-CHIP IMPEDANCE CYTOMETRY SYSTEM AND METHOD”, filed Apr. 22, 2024; U.S. Utility patent application Ser. No. 17/280,480, entitled “MULTIPLEXED ON-CHIP IMPEDANCE CYTOMETRY SYSTEM AND METHOD”, filed Mar. 26, 2021; U.S. Pat. No. 11,965,810, issued Apr. 23, 2024; Publication No. US 2022/0034780 A1, Feb. 3, 2022; International Patent Application Serial No. PCT/US2019/053242, entitled “MULTIPLEXED ON-CHIP IMPEDANCE CYTOMETRY SYSTEM AND METHOD”, filed Sep. 26, 2019; Publication No. WO 2020/069185, Apr. 2, 2020; U.S. Utility patent application Ser. No. 17/451,256, entitled “PERFUSABLE HYDROGEL MICROCHANNEL SHELL AND METHODS THEREOF”, filed Oct. 18, 2021; Publication No. US 2022-0118446 A1, Apr. 21, 2022; U.S. Utility patent application Ser. No. 17/445,972, entitled “SYSTEMS FOR ISOLATING AND TRANSPLANTING PANCREATIC ISLETS”, filed Aug. 26, 2021; U.S. Pat. No. 11,590,501, issued Feb. 28, 2023; Publication No. US 2022-0048030 A1, Feb. 17, 2022; U.S. Utility patent application Ser. No. 16/095,097, entitled “SYSTEMS FOR ISOLATING AND TRANSPLANTING PANCREATIC ISLETS”, filed Oct. 19, 2018; Publication No. US-2020-0353469-A1, Nov. 12, 2020; International Patent Application Serial No. PCT/US2017/028607, entitled “SYSTEMS FOR ISOLATING AND TRANSPLANTING PANCREATIC ISLETS”, filed Apr. 20, 2017; Publication No. WO 2017/184854, Oct. 26, 2017; U.S. Utility patent application Ser. No. 18/252,908, entitled “AUTOMATED CLASSIFICATION OF BIOLOGICAL SUBPOPULATIONS USING IMPEDANCE PARAMETERS”, filed May 15, 2023; Publication No. 20230417694, Dec. 28, 2023; International Patent Application Serial No. PCT/US2021/072441, entitled “AUTOMATED CLASSIFICATION OF BIOLOGICAL SUBPOPULATIONS USING IMPEDANCE PARAMETERS”, filed Nov. 16, 2021; Publication No. WO 2022/104393, May 19, 2022; U.S. Utility patent application Ser. No. 18/730,700, entitled “MODIFIED CELLS AS MULTIMODAL STANDARDS FOR CYTOMETRY AND SEPARATION”, filed Jul. 19, 2024; International Patent Application Serial No. PCT/US2023/061103, entitled “MODIFIED CELLS AS MULTIMODAL STANDARDS FOR CYTOMETRY AND SEPARATION”, filed Jan. 23, 2023; Publication No. WO2023141633, Jul. 27, 2023; U.S. Utility patent application Ser. No. 18/006,236, entitled “BACTERIAL SPORE GERMINATION ASSAY OF MICROBIOTA DISRUPTION”, filed Jan. 20, 2023; Publication No. 2023-0287473 A1, Sep. 14, 2023; International Patent Application Serial No. PCT/US2021/070922, entitled “BACTERIAL SPORE GERMINATION ASSAY OF MICROBIOTA DISRUPTION”, filed Jul. 21, 2021; Publication No. WO 2022/020849, Jan. 27, 2022, each of which is incorporated by reference.

Unless clearly stated otherwise, when any number or range is described herein, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

In addition, an aspect of an embodiment provides, but not limited thereto, a circuit (that may be implemented as a system, method and computer readable medium) for quantifying the level and frequency response of electrical field penetration for optimizing particle manipulation in microfluidic devices.

In addition, an aspect of an embodiment provides, but not limited thereto, an impedance-based assessment (implemented by a system, method and computer readable medium) of fidelity of microstructure device geometry for optimizing microfluidic electrokinetic manipulation.

In addition, an aspect of an embodiment provides, but not limited thereto, a quality control check (implemented by a system, method and computer readable medium) that confirms the voltage and frequency conditions experienced inside a microfluidic device to match those set on the controller.

Moreover, it should be appreciated that any of the components or modules referred to with regards to any of the present invention embodiments discussed herein, may be integrally or separately formed with one another. Further, redundant functions or structures of the components or modules may be implemented. Moreover, the various components may be communicated locally and/or remotely with any user or machine/system/computer/processor. Moreover, the various components may be in communication via wireless and/or hardwire or other desirable and available communication means, systems and hardware. Moreover, various components and modules may be substituted with other modules or components that provide similar functions.

It should be appreciated that the device and related components discussed herein may take on all shapes along the entire continual geometric spectrum of manipulation of x, y and z planes to provide and meet the environmental, anatomical, and structural demands and operational requirements. Moreover, locations and alignments of the various components may vary as desired or required.

It should be appreciated that various sizes, dimensions, contours, rigidity, shapes, flexibility and materials of any of the components or portions of components in the various embodiments discussed throughout may be varied and utilized as desired or required.

It should be appreciated that while some dimensions are provided on the aforementioned figures, the device may constitute various sizes, dimensions, contours, rigidity, shapes, flexibility and materials as it pertains to the components or portions of components of the device, and therefore may be varied and utilized as desired or required.

Although example embodiments of the present disclosure are explained in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

### CONCLUSION

In some aspects, the disclosed technology relates to impedance-based quantification and microfluidic control. Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

As discussed herein, a “subject” (or “patient”) may be any applicable human, animal, or other organism, living or dead, or other biological or molecular structure or chemical environment, and may relate to particular components of the subject, for instance specific organs, tissues, or fluids of a subject, may be in a particular location of the subject, referred to herein as an “area of interest” or a “region of interest.”

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device non-functional. Likewise, any step described with reference to a particular method or process may be integrated, incorporated, or otherwise combined with other methods or processes described herein unless specifically stated otherwise or if it should render the embodiment method nonfunctional. Furthermore, multiple embodiment devices or embodiment methods may be combined, incorporated, or otherwise integrated into one another to construct or develop further embodiments of the invention described herein.

It should be appreciated that any of the components or modules referred to with regards to any of the present invention embodiments discussed herein, may be integrally or separately formed with one another. Further, redundant functions or structures of the components or modules may be implemented. Moreover, the various components may be communicated locally and/or remotely with any user/operator/customer/client or machine/system/computer/processor. Moreover, the various components may be in communication via wireless and/or hardwire or other desirable and available communication means, systems and hardware. Moreover, various components and modules may be substituted with other modules or components that provide similar functions.

It should be appreciated that the device and related components discussed herein may take on all shapes along the entire continual geometric spectrum of manipulation of x, y and z planes to provide and meet the environmental, anatomical, and structural demands and operational requirements. Moreover, locations and alignments of the various components may vary as desired or required.

It should be appreciated that various sizes, dimensions, contours, rigidity, shapes, flexibility and materials of any of the components or portions of components in the various embodiments discussed throughout may be varied and utilized as desired or required.

It should be appreciated that while some dimensions are provided on the aforementioned figures, the device may constitute various sizes, dimensions, contours, rigidity, shapes, flexibility and materials as it pertains to the components or portions of components of the device, and therefore may be varied and utilized as desired or required.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, or method steps, even if the other such compounds, material, particles, or method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

It should be appreciated that as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to human (e.g. rat, dog, pig, monkey), etc. It should be appreciated that the subject may be any applicable human patient, for example.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

Additional descriptions of aspects of the present disclosure will now be provided with reference to the accompanying drawings. The drawings form a part hereof and show, by way of illustration, specific embodiments or examples.

The following patents, applications and publications as listed below and throughout this document are hereby incorporated by reference in their entirety herein.

### REFERENCES

### Example 1 References

[1] Perkins, T. J.; Swain, P. S., Strategies for cellular decision-making. Molecular systems biology 2009, 5 (1).
[2] Satija, R.; Shalek, A. K., Heterogeneity in immune responses: from populations to single cells. Trends in immunology 2014, 35 (5), 219-229.
[3] Klepárník, K.; Foret, F., Recent advances in the development of single cell analysis—A review. Analytica chimica acta 2013, 800, 12-21.
[4] Kling, J., Beyond counting tumor cells. Nature biotechnology 2012, 30 (7), 578-581.
[5] Lee, K. C.; Guck, J.; Goda, K.; Tsia, K. K., Toward deep biophysical cytometry: prospects and challenges. Trends in Biotechnology 2021, 39 (12), 1249-1262.
[6] Runel, G., Lopez-Ramirez, N., Chlasta, J. and Masse, I., Biomechanical properties of cancer cells. Cells 2021, 10 (4), 887.
[7] Shieh, A. C., Biomechanical forces shape the tumor microenvironment. Annals of biomedical engineering 2011, 39, 1379-1389.
[8] Maurer, M.; Lammerding, J., The driving force: nuclear mechanotransduction in cellular function, fate, and disease. Annual review of biomedical engineering 2019, 21, 443-468.
[9] Kim, J.; Han, S.; Lei, A.; Miyano, M.; Bloom, J.; Srivastava, V.; Stampfer, M. R.; Gartner, Z. J.; LaBarge, M. A.; Sohn, L. L., Characterizing cellular mechanical phenotypes with mechano-node-pore sensing. Microsystems & nanoengineering 2018, 4 (1), 1-12.
[10] Friedman, A. A.; Letai, A.; Fisher, D. E.; Flaherty, K. T., Precision medicine for cancer with next-generation functional diagnostics. Nature Reviews Cancer 2015, 15 (12), 747-756.
[11] Rahib, L.; Smith, B. D.; Aizenberg, R.; Rosenzweig, A. B.; Fleshman, J. M.; Matrisian, L. M., Projecting cancer incidence and deaths to 2030: the unexpected burden of thyroid, liver, and pancreas cancers in the United States. Cancer research 2014, 74 (11), 2913-2921.
[12] Jemal, A.; Siegel, R.; Ward, E.; Hao, Y.; Xu, J.; Thun, M. J., Cancer statistics, 2009. CA: a cancer journal for clinicians 2009, 59 (4), 225-249.
[13] Chronopoulos, A.; Lieberthal, T. J.; del Río Hernández, A. E., Pancreatic cancer: a mechanobiology approach. Convergent Science Physical Oncology 2017, 3 (1), 013001.
[14] Otto, O.; Rosendahl, P.; Mietke, A.; Golfier, S.; Herold, C.; Klaue, D.; Girardo, S.; Pagliara, S.; Ekpenyong, A.; Jacobi, A., Real-time deformability cytometry: on-the-fly cell mechanical phenotyping. Nature methods 2015, 12 (3), 199-202.
[15] Armistead, F. J.; De Pablo, J. G.; Gadêlha, H.; Peyman, S. A.; Evans, S. D., Cells under stress: an inertial-shear microfluidic determination of cell behavior. Biophysical Journal 2019, 116 (6), 1127-1135.
[16] Dannhauser, D.; Maremonti, M. I.; Panzetta, V.; Rossi, D.; Netti, P. A.; Causa, F., Mechanical phenotyping of breast cell lines by in-flow deformation-dependent dynamics under tuneable compressive forces. Lab on a Chip 2020, 20 (24), 4611-4622.
[17] Wu, P.-H.; Aroush, D. R.-B.; Asnacios, A.; Chen, W.-C.; Dokukin, M. E.; Doss, B. L.; Durand-Smet, P.; Ekpenyong, A.; Guck, J.; Guz, N. V., A comparison of methods to assess cell mechanical properties. Nature methods 2018, 15 (7), 491-498.
[18] Hao, Y.; Cheng, S.; Tanaka, Y.; Hosokawa, Y.; Yalikun, Y.; Li, M., Mechanical properties of single cells: Measurement methods and applications. Biotechnology Advances 2020, 45, 107648.
[19] Urbanska, M.; Muñoz, H. E.; Shaw Bagnall, J.; Otto, O.; Manalis, S. R.; Di Carlo, D.; Guck, J., A comparison of microfluidic methods for high-throughput cell deformability measurements. Nature methods 2020, 17 (6), 587-593.
[20] Han, Y.; Gu, Y.; Zhang, A. C.; Lo, Y.-H., Imaging technologies for flow cytometry. Lab on a Chip 2016, 16 (24), 4639-4647.
[21] Hua, H.; Zou, S.; Ma, Z.; Guo, W.; Fong, C. Y.; Khoo, B. L., A deformability-based biochip for precise label-free stratification of metastatic subtypes using deep learning. Microsystems & Nanoengineering 2023, 9 (1), 120.
[22] Nitta, N.; Sugimura, T.; Isozaki, A.; Mikami, H.; Hiraki, K.; Sakuma, S.; Iino, T.; Arai, F.; Endo, T.; Fujiwaki, Y., Intelligent image-activated cell sorting. Cell 2018, 175 (1), 266-276. e13.
[23] Cheung, K. C.; Di Berardino, M.; Schade-Kampmann, G.; Hebeisen, M.; Pierzchalski, A.; Bocsi, J.; Mittag, A.; Tárnok, A., Microfluidic impedance-based flow cytometry. Cytometry Part A 2010, 77 (7), 648-666.
[24] Sun, T.; Morgan, H., Single-cell microfluidic impedance cytometry: a review. Microfluidics and Nanofluidics 2010, 8 (4), 423-443.
[25] Honrado, C.; Bisegna, P.; Swami, N. S.; Caselli, F., Single-cell microfluidic impedance cytometry: from raw signals to cell phenotypes using data analytics. Lab on a Chip 2020.
[26] Petchakup, C.; Tay, H. M.; Li, K. H. H.; Hou, H. W., Integrated inertial-impedance cytometry for rapid label-free leukocyte isolation and profiling of neutrophil extracellular traps (NETs). Lab on a Chip 2019, 19 (10), 1736-1746.
[27] Salahi, A.; Rane, A.; Xiao, L.; Honrado, C.; Li, X.; Jin, L.; Swami, N. S., Single-cell assessment of the modulation of macrophage activation by ex vivo intervertebral discs using impedance cytometry. Biosensors and Bioelectronics 2022, 210, 114346.
[28] Spencer, D.; Morgan, H., High-speed single-cell dielectric spectroscopy. ACS sensors 2020, 5 (2), 423-430.
[29] Salahi, A.; Honrado, C.; Rane, A.; Caselli, F.; Swami, N. S., Modified Red Blood Cells as Multimodal Standards for Benchmarking Single-Cell Cytometry and Separation Based on Electrical Physiology. Analytical Chemistry 2022, 94 (6), 2865-2872.
[30] Sui, J.; Foflonker, F.; Bhattacharya, D.; Javanmard, M., Electrical impedance as an indicator of microalgal cell health. Scientific reports 2020, 10 (1), 1251.
[31] Honrado, C.; Salahi, A.; Adair, S. J.; Moore, J. H.; Bauer, T. W.; Swami, N. S., Automated biophysical classification of apoptotic pancreatic cancer cell subpopulations by using machine learning approaches with impedance cytometry. Lab on a Chip 2022, 22 (19), 3708-3720.
[32] De Ninno, A.; Reale, R.; Giovinazzo, A.; Bertani, F. R.; Businaro, L.; Bisegna, P.; Matteucci, C.; Caselli, F., High-throughput label-free characterization of viable, necrotic and apoptotic human lymphoma cells in a coplanar-electrode microfluidic impedance chip. Biosensors and Bioelectronics 2020, 150, 111887.
[33] Honrado, C.; Michel, N.; Moore, J. H.; Salahi, A.; Porterfield, V.; McConnell, M. J.; Swami, N. S., Label-free quantification of cell cycle synchronicity of human neural progenitor cells based on electrophysiology phenotypes. ACS sensors 2020, 6 (1), 156-165.
[34] Salahi, A.; Honrado, C.; Moore, J.; Adair, S.; Bauer, T. W.; Swami, N. S., Supervised learning on impedance cytometry data for label-free biophysical distinction of pancreatic cancer cells versus their associated fibroblasts under gemcitabine treatment. Biosensors and Bioelectronics 2023, 231, 115262.
[35] Zhou, Y.; Yang, D.; Zhou, Y.; Khoo, B. L.; Han, J.; Ai, Y., Characterizing deformability and electrical impedance of cancer cells in a microfluidic device. Analytical chemistry 2018, 90 (1), 912-919.
[36] Ren, X.; Ghassemi, P.; Strobl, J. S.; Agah, M., Biophysical phenotyping of cells via impedance spectroscopy in parallel cyclic deformability channels. Biomicrofluidics 2019, 13 (4).
[37] Petchakup, C.; Yang, H.; Gong, L.; He, L.; Tay, H. M.; Dalan, R.; Chung, A. J.; Li, K. H. H.; Hou, H. W., Microfluidic Impedance-Deformability Cytometry for Label-Free Single Neutrophil Mechanophenotyping. Small 2022, 18 (18), 2104822.
[38] Caselli, F.; Bisegna, P., A simple and robust event-detection algorithm for single-cell impedance cytometry. IEEE Transactions on Biomedical Engineering 2015, 63 (2), 415-422.
[39] Honrado, C.; McGrath, J. S.; Reale, R.; Bisegna, P.; Swami, N. S.; Caselli, F., A neural network approach for real-time particle/cell characterization in microfluidic impedance cytometry. Analytical and bioanalytical chemistry 2020, 412, 3835-3845.
[40] Caselli, F.; Reale, R.; De Ninno, A.; Spencer, D.; Morgan, H.; Bisegna, P., Deciphering impedance cytometry signals with neural networks. Lab on a Chip 2022, 22 (9), 1714-1722.
[41] Lee, S. S.; Yim, Y.; Ahn, K. H.; Lee, S. J., Extensional flow-based assessment of red blood cell deformability using hyperbolic converging microchannel. Biomedical microdevices 2009, 11, 1021-1027.
[42] Oliveira, M. S. N.; Alves, M. A.; Pinho, F. T.; Mckinley, G. H., Viscous flow through microfabricated hyperbolic contractions. Experiments in fluids 2007, 43, 437-451.
[43] Reale, R.; De Ninno, A.; Nepi, T.; Bisegna, P.; Caselli, F., Extensional-flow impedance cytometer for contactless and optics-free erythrocyte deformability analysis. IEEE Transactions on Biomedical Engineering 2022, 70 (2), 565-572.
[44] Caselli, F.; De Ninno, A.; Reale, R.; Businaro, L.; Bisegna, P., A Bayesian approach for coincidence resolution in microfluidic impedance cytometry. IEEE Transactions on Biomedical Engineering 2020, 68 (1), 340-349.
[45] Feng, Y.; Zhu, J.; Chai, H.; He, W.; Huang, L.; Wang, W., Impedance-Based Multimodal Electrical-Mechanical Intrinsic Flow Cytometry. Small 2023, 19 (45), 2303416.
[46] Feng, Y.; Cheng, Z.; Chai, H.; He, W.; Huang, L.; Wang, W., Neural network-enhanced real-time impedance flow cytometry for single-cell intrinsic characterization. Lab on a Chip 2022, 22 (2), 240-249.
[47] Richards, K. E.; Zeleniak, A. E.; Fishel, M. L.; Wu, J.; Littlepage, L. E.; Hill, R., Cancer-associated fibroblast exosomes regulate survival and proliferation of pancreatic cancer cells. Oncogene 2017, 36 (13), 1770-1778.
[48] Liao, Z.; Tan, Z. W.; Zhu, P.; Tan, N. S., Cancer-associated fibroblasts in tumor microenvironment—Accomplices in tumor malignancy. Cellular immunology 2019, 343, 103729.
[49] Zhu, J.; Pan, S.; Chai, H.; Zhao, P.; Feng, Y.; Cheng, Z.; Zhang, S.; Wang, W., Microfluidic Impedance Cytometry Enabled One-Step Sample Preparation for Efficient Single-Cell Mass Spectrometry. Small 2024, 2310700.
[50] Rane, A.; Jarmoshti, J.; Siddique, A.-B.; Adair, S.; Torres-Castro, K.; Honrado, C.; Bauer, T. W.; Swami, N. S., Dielectrophoretic enrichment of live chemo-resistant circulating-like pancreatic cancer cells from media of drug-treated adherent cultures of solid tumors. Lab on a Chip 2024, 24 (3), 561-571.
[51] Torres-Castro, K.; Jarmoshti, J.; Xiao, L.; Rane, A.; Salahi, A.; Jin, L.; Li, X.; Caselli, F.; Honrado, C.; Swami, N. S., Multichannel Impedance Cytometry Downstream of Cell Separation by Deterministic Lateral Displacement to Quantify Macrophage Enrichment in Heterogeneous Samples. Advanced Materials Technologies 2023, 8 (8), 2201463.
[52] Liang, M.; Tang, Q.; Zhong, J.; Ai, Y., Machine learning empowered multi-stress level electromechanical phenotyping for high-dimensional single cell analysis. Biosensors and Bioelectronics 2023, 225, 115086.
[53] Raoufi, M. A.; Mashhadian, A.; Niazmand, H.; Asadnia, M.; Razmjou, A.; Warkiani, M. E., Experimental and numerical study of elasto-inertial focusing in straight channels. Biomicrofluidics 2019, 13 (3).
[54] Gawad, S.; Schild, L.; Renaud, P., Micromachined impedance spectroscopy flow cytometer for cell analysis and particle sizing. Lab on a Chip 2001, 1 (1), 76-82.
[55] McGrath, J.; Honrado, C.; Moore, J.; Adair, S.; Varhue, W.; Salahi, A.; Farmehini, V.; Goudreau, B.; Nagdas, S.; Blais, E., Electrophysiology-based stratification of pancreatic tumorigenicity by label-free single-cell impedance cytometry. Analytica chimica acta 2020, 1101, 90-98.
[56] Rane, A.; Jarmoshti, J.; Siddique, A.-B.; Adair, S.; Torres-Castro, K.; Honrado, C.; Bauer, T. W.; Swami, N. S., Dielectrophoretic enrichment of live chemo-resistant circulating-like pancreatic cancer cells from media of drug-treated adherent cultures of solid tumors. Lab on a Chip 2024, 24, 561-571.
[57] Piergiovanni, M., Galli, V., Holzner, G., Stavrakis, S., DeMello, A., Dubini, G., Deformation of leukaemia cell lines in hyperbolic microchannels: investigating the role of shear and extensional components. Lab Chip 2020, 20 (14), 2539-2548.
[58] Cervantes, J., Garcia-Lamont, F., Rodríguez-Mazahua, L., & Lopez, A. A comprehensive survey on support vector machine classification: Applications, challenges and trends. Neurocomputing 2020, 408, 189-215.

### Example 2 References

[1′] Pickup, M. W.; Mouw, J. K.; Weaver, V. M. The Extracellular Matrix Modulates the Hallmarks of Cancer. EMBO Rep 2014, 15 (12), 1243-1253.
[2′] Runel Lopez-Ramirez N. Chlasta J. and Masse I., G. Biomechanical Properties of Cancer Cells. Cells 2021, 10 (4), 887.
[3′] Roberts, A. B.; Zhang, J.; Raj Singh, V.; Nikolić, M.; Moeendarbary, E.; Kamm, R. D.; So, P. T. C.; Scarcelli, G. Tumor Cell Nuclei Soften during Transendothelial Migration. J Biomech 2021, 121, 110400.
[4′] Dummer, R.; Vermeer, M. H.; Scarisbrick, J. J.; Kim, Y. H.; Stonesifer, C.; Tensen, C. P.; Geskin, L. J.; Quaglino, P.; Ramelyte, E. Cutaneous T Cell Lymphoma. Nat Rev Dis Primers 2021, 7 (1), 61.
[5′] Kalliara, E.; Belfrage, E.; Gullberg, U.; Drott, K.; Ek, S. Spatially Guided and Single Cell Tools to Map the Microenvironment in Cutaneous T-Cell Lymphoma. Cancers (Basel) 2023, 15 (8), 2362.
[6′] Herrera, A.; Cheng, A.; Mimitou, E. P.; Seffens, A.; George, D.; Bar-Natan, M.; Heguy, A.; Ruggles, K. V.; Scher, J. U.; Hymes, K.; Latkowski, J.-A.; Ødum, N.; Kadin, M. E.; Ouyang, Z.; Geskin, L. J.; Smibert, P.; Buus, T. B.; Koralov, S. B. Multimodal Single-Cell Analysis of Cutaneous T-Cell Lymphoma Reveals Distinct Subclonal Tissue-Dependent Signatures. Blood 2021, 138 (16), 1456-1464.
[7′] Dummer, R.; Vermeer, M. H.; Scarisbrick, J. J.; Kim, Y. H.; Stonesifer, C.; Tensen, C. P.; Geskin, L. J.; Quaglino, P.; Ramelyte, E. Cutaneous T Cell Lymphoma. Nat Rev Dis Primers 2021, 7 (1), 61.
[8′] Friedl, P.; Wolf, K.; Lammerding, J. Nuclear Mechanics during Cell Migration. Curr Opin Cell Biol 2011, 23 (1), 55-64.
[9′] Davidson, P. M.; Denais, C.; Bakshi, M. C.; Lammerding, J. Nuclear Deformability Constitutes a Rate-Limiting Step During Cell Migration in 3-D Environments. Cell Mol Bioeng 2014, 7 (3), 293-306.
[10′] Gasser, E.; Su, E.; Vaidžiulytė, K.; Abbade, N.; Cognart, H.; Manneville, J.-B.; Viovy, J.-L.; Piel, M.; Pierga, J.-Y.; Terao, K.; Villard, C. Deformation under Flow and Morphological Recovery of Cancer Cells. Lab Chip 2024, 24 (16), 3930-3944.
[11′] SenGupta, S.; Parent, C. A.; Bear, J. E. The Principles of Directed Cell Migration. Nat Rev Mol Cell Biol 2021, 22 (8), 529-547.
[12′] Swerdlow, S. H.; Campo, E.; Pileri, S. A.; Harris, N. L.; Stein, H.; Siebert, R.; Advani, R.; Ghielmini, M.; Salles, G. A.; Zelenetz, A. D.; Jaffe, E. S. The 2016 Revision of the World Health Organization Classification of Lymphoid Neoplasms. Blood 2016, 127 (20), 2375-2390.
[13′] Reynolds, N. H.; Ronan, W.; Dowling, E. P.; Owens, P.; McMeeking, R. M.; McGarry, J. P. On the Role of the Actin Cytoskeleton and Nucleus in the Biomechanical Response of Spread Cells. Biomaterials 2014, 35 (13), 4015-4025.
[14′] Wang, X.; Liu, H.; Zhu, M.; Cao, C.; Xu, Z.; Tsatskis, Y.; Lau, K.; Kuok, C.; Filleter, T.; McNeill, H.; Simmons, C. A.; Hopyan, S.; Sun, Y. Mechanical Stability of the Cell Nucleus-Roles Played by the Cytoskeleton in Nuclear Deformation and Strain Recovery. J Cell Sci 2018, 131 (13).
[15′] Thoumine, O.; Ott, A.; Cardoso, O.; Meister, J.-J. Microplates: A New Tool for Manipulation and Mechanical Perturbation of Individual Cells. J Biochem Biophys Methods 1999, 39 (1-2), 47-62.
[16′] Guck, J.; Ananthakrishnan, R.; Mahmood, H.; Moon, T. J.; Cunningham, C. C.; Käs, J. The Optical Stretcher: A Novel Laser Tool to Micromanipulate Cells. Biophys J 2001, 81 (2), 767-784.
[17′] Guido, I.; Jaeger, M. S.; Duschl, C. Dielectrophoretic Stretching of Cells Allows for Characterization of Their Mechanical Properties. European Biophysics Journal 2011, 40 (3), 281-288.
[18′] Urbanska, M.; Muñoz, H. E.; Shaw Bagnall, J.; Otto, O.; Manalis, S. R.; Di Carlo, D.; Guck, J. A Comparison of Microfluidic Methods for High-Throughput Cell Deformability Measurements. Nat Methods 2020, 17 (6), 587-593.
[19′] Otto, O.; Rosendahl, P.; Mietke, A.; Golfier, S.; Herold, C.; Klaue, D.; Girardo, S.; Pagliara, S.; Ekpenyong, A.; Jacobi, A.; Wobus, M.; Töpfner, N.; Keyser, U. F.; Mansfeld, J.; Fischer-Friedrich, E.; Guck, J. Real-Time Deformability Cytometry: On-the-Fly Cell Mechanical Phenotyping. Nat Methods 2015, 12 (3), 199-202.
[20′] Gossett, D. R.; Tse, H. T. K.; Lee, S. A.; Ying, Y.; Lindgren, A. G.; Yang, O. O.; Rao, J.; Clark, A. T.; Di Carlo, D. Hydrodynamic Stretching of Single Cells for Large Population Mechanical Phenotyping. Proc Natl Acad Sci USA 2012, 109 (20), 7630-7635.
[21′] Guillou, L.; Dahl, J. B.; Lin, J.-M. G.; Barakat, A. I.; Husson, J.; Muller, S. J.; Kumar, S. Measuring Cell Viscoelastic Properties Using a Microfluidic Extensional Flow Device. Biophys J 2016, 111 (9), 2039-2050.
[22′] Lee, K. C. M.; Guck, J.; Goda, K.; Tsia, K. K. Toward Deep Biophysical Cytometry: Prospects and Challenges. Trends Biotechnol 2021, 39 (12), 1249-1262.
[23′] Nawaz, A. A.; Soteriou, D.; Xu, C. K.; Goswami, R.; Herbig, M.; Guck, J.; Girardo, S. Image-Based Cell Sorting Using Focused Travelling Surface Acoustic Waves. Lab Chip 2023, 23 (2), 372-387.
[24′] Asghari, M.; Ivetich, S. D.; Aslan, M. K.; Aramesh, M.; Melkonyan, O.; Meng, Y.; Xu, R.; Colombo, M.; Weiss, T.; Balabanov, S.; Stavrakis, S.; deMello, A. J. Real-Time Viscoelastic Deformability Cytometry: High-Throughput Mechanical Phenotyping of Liquid and Solid Biopsies. Sci Adv 2024, 10 (49).
[25′] Petchakup, C.; Yang, H.; Gong, L.; He, L.; Tay, H. M.; Dalan, R.; Chung, A. J.; Li, K. H. H.; Hou, H. W. Microfluidic Impedance-Deformability Cytometry for Label-Free Single Neutrophil Mechanophenotyping. Small 2022, 18 (18).
[26′] Lee, S. S.; Yim, Y.; Ahn, K. H.; Lee, S. J. Extensional Flow-Based Assessment of Red Blood Cell Deformability Using Hyperbolic Converging Microchannel. Biomed Microdevices 2009, 11 (5), 1021-1027.
[27′] Reale, R.; De Ninno, A.; Nepi, T.; Bisegna, P.; Caselli, F. Extensional-Flow Impedance Cytometer for Contactless and Optics-Free Erythrocyte Deformability Analysis. IEEE Trans Biomed Eng 2022.
[28′] Dannhauser, D.; Maremonti, M. I.; Panzetta, V.; Rossi, D.; Netti, P. A.; Causa, F. Mechanical Phenotyping of Breast Cell Lines by In-Flow Deformation-Dependent Dynamics under Tuneable Compressive Forces. Lab Chip 2020, 20 (24), 4611-4622.
[29′] Piergiovanni, M.; Galli, V.; Holzner, G.; Stavrakis, S.; DeMello, A.; Dubini, G. Deformation of Leukaemia Cell Lines in Hyperbolic Microchannels: Investigating the Role of Shear and Extensional Components. Lab Chip 2020, 20 (14), 2539-2548.
[30′] Reichel, F.; Goswami, R.; Girardo, S.; Guck, J. High-Throughput Viscoelastic

Characterization of Cells in Hyperbolic Microchannels. Lab Chip 2024, 24 (9), 2440-2453.
[31′] Maremonti, M. I.; Dannhauser, D.; Panzetta, V.; Netti, P. A.; Causa, F. Cell Deformability Heterogeneity Recognition by Unsupervised Machine Learning from In-Flow Motion Parameters. Lab Chip 2022, 22 (24), 4871-4881.
[32′] Honrado, C.; Michel, N.; Moore, J. H.; Salahi, A.; Porterfield, V.; McConnell, M. J.; Swami, N. S. Label-Free Quantification of Cell Cycle Synchronicity of Human Neural Progenitor Cells Based on Electrophysiology Phenotypes. ACS Sens 2021, 6 (1), 156-165.
[33′] Rosendahl, P.; Plak, K.; Jacobi, A.; Kraeter, M.; Toepfner, N.; Otto, O.; Herold, C.; Winzi, M.; Herbig, M.; Ge, Y.; Girardo, S.; Wagner, K.; Baum, B.; Guck, J. Real-Time Fluorescence and Deformability Cytometry. Nat Methods 2018, 15 (5), 355-358.
[34′] Nawaz, A. A.; Urbanska, M.; Herbig, M.; Nötzel, M.; Kräter, M.; Rosendahl, P.; Herold, C.; Toepfner, N.; Kubánková, M.; Goswami, R.; Abuhattum, S.; Reichel, F.; Müller, P.; Taubenberger, A.; Girardo, S.; Jacobi, A.; Guck, J. Intelligent Image-Based Deformation-Assisted Cell Sorting with Molecular Specificity. Nat Methods 2020, 17 (6), 595-599.
[35′] Muñoz, H. E.; Lin, J.; Yeh, B. G.; Biswas, T.; Di Carlo, D. Fluorescence Imaging Deformability Cytometry: Integrating Nuclear Structure with Mechanical Phenotyping. Med-X 2023, 1 (1), 10.
[36′] Andrique, L.; Poglio, S.; Prochazkova-Carlotti, M.; Kadin, M. E.; Giese, A.; Idrissi, Y.; Beylot-Barry, M.; Merlio, J.-P.; Chevret, E. Intrahepatic Xenograft of Cutaneous T-Cell Lymphoma Cell Lines. Am J Pathol 2016, 186 (7), 1775-1785.
[37′] Davis, T. H.; Morton, C. C.; Miller-Cassman, R.; Balk, S. P.; Kadin, M. E. Hodgkin's Disease, Lymphomatoid Papulosis, and Cutaneous T-Cell Lymphoma Derived from a Common T-Cell Clone. New England Journal of Medicine 1992, 326 (17), 1115-1122.
[38′] Swift, J.; Ivanovska, I. L.; Buxboim, A.; Harada, T.; Dingal, P. C. D. P.; Pinter, J.; Pajerowski, J. D.; Spinler, K. R.; Shin, J.-W.; Tewari, M.; Rehfeldt, F.; Speicher, D. W.; Discher, D. E. Nuclear Lamin-A Scales with Tissue Stiffness and Enhances Matrix-Directed Differentiation. Science (1979) 2013, 341 (6149).
[39′] Buxboim, A.; Swift, J.; Irianto, J.; Spinler, K. R.; Dingal, P. C. D. P.; Athirasala, A.; Kao, Y.-R. C.; Cho, S.; Harada, T.; Shin, J.-W.; Discher, D. E. Matrix Elasticity Regulates Lamin-A,C Phosphorylation and Turnover with Feedback to Actomyosin. Current Biology 2014, 24 (16), 1909-1917.
[40′] Makhija, E.; Jokhun, D. S.; Shivashankar, G. V. Nuclear Deformability and Telomere Dynamics Are Regulated by Cell Geometric Constraints. Proceedings of the National Academy of Sciences 2016, 113 (1).
[41′] Wang, J.; Chen, J.; Tang, W.; Zhu, S. Comprehensive Analysis of Shear Deformation Cytometry Based on Numerical Simulation Method. Biosensors (Basel) 2025, 15 (6).
[42′] Kadin, M. E.; Cavaille-Coll, M. W.; Gertz, R.; Massagué, J.; Cheifetz, S.; George, D. Loss of Receptors for Transforming Growth Factor Beta in Human T-Cell Malignancies. Proceedings of the National Academy of Sciences 1994, 91 (13), 6002-6006.
[43′] Bronstein, I.; Israel, Y.; Kepten, E.; Mai, S.; Shav-Tal, Y.; Barkai, E.; Garini, Y. Transient Anomalous Diffusion of Telomeres in the Nucleus of Mammalian Cells. Phys Rev Lett 2009, 103 (1), 018102.
[44′] Wood, A. M.; Rendtlew Danielsen, J. M.; Lucas, C. A.; Rice, E. L.; Scalzo, D.; Shimi, T.; Goldman, R. D.; Smith, E. D.; Le Beau, M. M.; Kosak, S. T. TRF2 and Lamin A/C Interact to Facilitate the Functional Organization of Chromosome Ends. Nat Commun 2014, 5, 5467.
[45′] Knecht, H.; Mai, S. The Use of 3D Telomere FISH for the Characterization of the Nuclear Architecture in EBV-Positive Hodgkin's Lymphoma. Methods Mol Biol 2017, 1532, 93-104.
[46′] Schaefer, L. H.; Schuster, D.; Herz, H. Generalized Approach for Accelerated Maximum Likelihood Based Image Restoration Applied to Three-dimensional Fluorescence Microscopy. J Microsc 2001, 204 (2), 99-107.
[47′] Contu, F.; Rangel-Pozzo, A.; Trokajlo, P.; Wark, L.; Klewes, L.; Johnson, N. A.; Petrogiannis-Haliotis, T.; Gartner, J. G.; Garini, Y.; Vanni, R.; Knecht, H.; Mai, S. Distinct 3D Structural Patterns of Lamin A/C Expression in Hodgkin and Reed-Sternberg Cells. Cancers (Basel) 2018, 10 (9), 286.
[48′] Vermolen, B. J.; Garini, Y.; Mai, S.; Mougey, V.; Fest, T.; Chuang, T. C.-Y.; Chuang, A. Y.-C.; Wark, L.; Young, I. T. Characterizing the Three-dimensional Organization of Telomeres. Cytometry Part A 2005, 67A (2), 144-150.
[49′] Jarmoshti, J.; Siddique, A.; Rane, A.; Mirhosseini, S.; Adair, S. J.; Bauer, T. W.; Caselli, F.; Swami, N. S. Neural Network-Enabled Multiparametric Impedance Signal Templating for High Throughput Single-Cell Deformability Cytometry Under Viscoelastic Extensional Flows. Small 2025, 21 (5).
[50′] Honrado, C.; Bisegna, P.; Swami, N. S.; Caselli, F. Single-Cell Microfluidic Impedance Cytometry: From Raw Signals to Cell Phenotypes Using Data Analytics. Lab Chip 2021, 21 (1), 22-54.
[51′] Salahi, A.; Honrado, C.; Rane, A.; Caselli, F.; Swami, N. S. Modified Red Blood Cells as Multimodal Standards for Benchmarking Single-Cell Cytometry and Separation Based on Electrical Physiology. Anal Chem 2022, 94 (6), 2865-2872.
[52′] Honrado, C.; Salahi, A.; Adair, S. J.; Moore, J. H.; Bauer, T. W.; Swami, N. S. Automated Biophysical Classification of Apoptotic Pancreatic Cancer Cell Subpopulations by Using Machine Learning Approaches with Impedance Cytometry. Lab Chip 2022, 22 (19), 3708-3720.
[53′] Salahi, A.; Honrado, C.; Moore, J.; Adair, S.; Bauer, T. W.; Swami, N. S. Supervised Learning on Impedance Cytometry Data for Label-Free Biophysical Distinction of Pancreatic Cancer Cells versus Their Associated Fibroblasts under Gemcitabine Treatment. Biosens Bioelectron 2023, 231, 115262.

1. A system comprising:
a microfluidic device comprising:
a microfluidic channel defining a flow path and configured to receive a sample comprising a heterogeneous population of biological particles, wherein the microfluidic channel includes a contoured constriction region larger than particle size that is configured to induce viscoelastic extensional flow for deformation and relaxation of the biological particles flowing therethrough, and
an impedance sensing unit comprising one or more sets of electrodes disposed along the flow path of the microfluidic channel, wherein the one or more sets of electrodes is configured to interrogate single-particle impedance characteristics corresponding to a biophysical features of the biological particle, including their size, velocity, shape anisotropy and dielectric properties along the flow path of the microfluidic channel to provide impedance signal data; and
a processor, and memory operatively coupled to the processor and having instructions stored thereon, wherein execution of the instructions by the processor causes the processor to:
obtain the impedance signal data acquired from the impedance sensing unit; and
classify the biological particles into cell or particle subpopulations via a trained machine learning (ML) model, wherein the trained ML model is trained using a training data set comprising a sequence of images, or associated data, of a set of biological particles flowing in viscoelastic extensional flow along a flow path of a microfluidic channel through a contoured constriction region and corresponding impedance signal data.

2. The system of claim 1, wherein the microfluidic channel comprises a compliant material operatively coupled to an external actuator, wherein the microfluidic channel is configured to deform in response to a force generated by the external actuator.

3. The system of claim 2, wherein the external actuator comprises a diaphragm.

4. The system of claim 1, wherein the contoured constriction region of the microfluidic channel defines a substantially hyperbolic curve.

5. The system of claim 1, wherein the flow path of the microfluidic channel further includes a pre-constriction region and a recovery region proximal to and in fluid communication with the contoured constriction region.

6. The system of claim 5, wherein the impedance sensing unit comprises a first set of electrodes disposed about the pre-constriction region, a second set of electrodes disposed about the contoured region, and a third set of electrodes disposed about the recovery region.

7. The system of claim 1, wherein the microfluidic channel further comprises a sorting region, wherein the processor is configured to determine, based on a classification of the biological particles, a control signal to selectively direct the biological particles towards a respective bin.

8. The system of claim 1, wherein the biological particles comprise cells.

9. The system of claim 8, wherein the processor, via the trained ML model, is configured to classify the cells into cell or marker subpopulations based on epithelial and mesenchymal states.

10. The system of claim 8, wherein the processor, via the trained ML model, is configured to classify the cells into cell or marker subpopulations based on fixed and untreated states.

11. The system of claim 1, wherein the trained ML model comprises a multilayer perceptron neural network (MLPNN) configured for real-time operation.

12. The system of claim 11, wherein the MLPNN is configured to determine an estimated value for an electrical anisotropy index of the biological particle based on normalization against co-flowing microgel beads of known stiffness.

13. The system of claim 12, wherein the trained ML model further comprises a Support Vector Machine (SVM) configured to classify the biological particles into cell or particle subpopulations based on the estimated value of the electrical anisotropy index from the MLPNN.

14. The system of claim 8, wherein the sequence of images, or associated data, comprises one or more morphological parameters derived from segmented optical images is used as training data for the deformation and relaxation of biological particles within the microfluidic channel.

15. The system of claim 14, wherein the one or more morphological parameters comprise one or more of cell size, centroid eccentricity, circularity, and/or anisotropic index.

16. The system of claim 1, wherein the impedance signal data comprises one or more of electrical size, transit time, amplitude values for impedance magnitude and phase at specific frequencies, or a composite metric.

17. The system of claim 1, wherein the impedance sensing unit is coupled to a local controller that provides the impedance signal data to a cloud infrastructure comprising the processor and memory.

18. The system of claim 1, wherein the impedance sensing unit is coupled to a local controller that comprises the processor and memory.

19. A method of characterizing and/or manipulating biological particles, the method comprising:
receiving a sample comprising a heterogeneous population of biological particles in a microfluidic device,
flowing the biological particles through a microfluidic channel of the microfluidic device having a contoured constriction region larger than particle size to cause viscoelastic extensional flow for deformation and relaxation of the biological particle,
measuring impedance signal data of the biological particle at one or more locations along the microfluidic channel;
classifying the biological particles into cell or particle subpopulations via a trained machine learning (ML) model, wherein the trained ML model is trained using a training data set comprising a sequence of images, or associated data, of a set of biological particles flowing in viscoelastic extensional flow along a flow path of the microfluidic channel through the contoured constriction region and corresponding impedance signal data.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A microfluidic device comprising:
a microfluidic channel defining a flow path and configured to receive a sample comprising a heterogeneous population of biological particles, wherein the microfluidic channel includes a contoured constriction region larger than particle size that is configured to induce viscoelastic extensional flow for deformation and relaxation of the biological particles flowing therethrough, and
an impedance sensing unit comprising one or more sets of electrodes disposed along the flow path of the microfluidic channel, wherein the one or more sets of electrodes is configured to interrogate impedance characteristics corresponding to a biophysical features of the biological particle along the flow path of the microfluidic channel to provide impedance signal data on particle size, velocity, shape and dielectric properties;
wherein the microfluidic channel comprises a compliant material operatively coupled to an external actuator, wherein the microfluidic channel is configured to deform in response to a force generated by the external actuator.
